(19) United States
(12) Patent Application Publication
(10) Pub. No.: US 2026/0231857 A1
(43) Pub. Date: Aug. 13, 2026

(54) GRASS TRIMMER

(71) Applicant: Nanjing Chervon Industry Co., Ltd., Nanjing (CN)

(72) Inventors: Jianpeng Guo, Nanjing (CN); Toshinari Yamaoka, Nanjing (CN); Fangjie Nie, Nanjing (CN); Qi Zhang, Nanjing (CN); Zongjing Li, Nanjing (CN); Fei Wang, Nanjing (CN); Lanxi Xu, Nanjing (CN); Maohui Li, Nanjing (CN)

(21) Appl. No.: 19/637,116

(22) Filed: Apr. 2, 2026

Related U.S. Application Data
(63) Continuation-in-part of application No. 19/456,764, filed on Jan. 22, 2026.
Application No. 19/456,764 is a continuation of application No. 17/859,454, filed on Jul. 7, 2022, now Pat. No. 12,557,730.
Application No. 17/859,454 is a continuation-in-part of application No. 17/061,584, filed on Oct. 2, 2020, now Pat. No. 11,419,262.
Application No. 17/061,584 is a continuation of application No. 16/363,609, filed on Mar. 25, 2019, now Pat. No. 10,849,268.
Application No. 16/363,609 is a continuation of application No. 15/839,257, filed on Dec. 12, 2017, now Pat. No. 10,264,725.
Application No. 15/839,257 is a continuation of application No. PCT/CN2016/110351, filed on Dec. 16, 2016.
(63) Continuation-in-part of application No. 19/577,571, filed on Mar. 25, 2026.
Application No. 19/577,571 is a continuation of application No. 18/078,961, filed on Dec. 11, 2022, now Pat. No. 12,622,350.
Application No. 18/078,961 is a continuation-in-part of application No. 17/402,976, filed on Aug. 16, 2021, now Pat. No. 11,910,743.
Application No. 17/402,976 is a continuation of application No. 17/066,502, filed on Oct. 9, 2020, now Pat. No. 11,503,759.
Application No. 17/066,502 is a continuation of application No. 16/781,147, filed on Feb. 4, 2020, now Pat. No. 10,856,466.
Application No. 16/781,147 is a continuation of application No. PCT/CN2018/096413, filed on Jul. 20, 2018.

(30) Foreign Application Priority Data
Jan. 22, 2016 (CN) 201610044465.6
Aug. 1, 2016 (CN) 201610626524.0
Oct. 7, 2016 (CN) 201610875071.5
Aug. 7, 2017 (CN) 201720979716.X
Aug. 7, 2017 (CN) 201720979787.X
May 13, 2022 (CN) 202210517129.4
May 13, 2022 (CN) 202210517136.4

(51) Int. Cl. A01D 34/416

(52) U.S. Cl. CPC A01D 34/4163; A01D 34/4166; A01D 34/4165

(57) ABSTRACT

A grass trimmer includes a trimming head, a driving device for driving the trimming head to rotate so as to cut vegetation and an operating device for a user to operate so as to control the driving device. The trimming head includes a spool and a line holding element, the spool is used to wind a trimming line, and the line holding element is formed with a line holding structure. The driving device includes a motor. The grass trimmer has an auto-winding mode. In the auto-winding mode, the motor drives at least one of the spool and the line holding element to make the spool and the line holding element rotate relatively so that the trimming line is wound on the spool automatically.

### RELATED APPLICATION INFORMATION

This application is a continuation-in part of U.S. application Ser. No. 19/456,764, filed Jan. 22, 2026, which application is a continuation of U.S. application Ser. No. 17/859,454, filed Jul. 7, 2022, which is a continuation-in part of U.S. application Ser. No. 17/061,584, filed Oct. 2, 2020, which is a continuation of U.S. application Ser. No. 16/363,609, filed Mar. 25, 2019, which is a continuation of U.S. patent application Ser. No. 15/839,257, filed Dec. 12, 2017, which claims the benefit of International Application Number PCT/CN2016/110351, filed on Dec. 16, 2016, through which this application also claims the benefit of Chinese Patent Application No. 201610044465.6, filed on Jan. 22, 2016, Chinese Patent application number 201610626524.0, filed on Aug. 1, 2016, and Chinese Patent application number 201610875071.5, filed on Oct. 7, 2016, each of which is incorporated herein by reference in its entirety.

This application is also a continuation-in part of U.S. application Ser. No. 19/577,571, filed Mar. 25, 2026, which application is a continuation of U.S. application Ser. No. 18/078,961, filed Dec. 11, 2022, which application is a continuation-in-part of U.S. application Ser. No. 17/402,976, filed Aug. 16, 2021, now U.S. Pat. No. 11,910,743, which application is a continuation of U.S. application Ser. No. 17/066,502, filed Oct. 9, 2020, now U.S. Pat. No. 11,503,759, which application is a continuation of U.S. application Ser. No. 16/781,147, filed Feb. 4, 2020, now U.S. Pat. No. 10,856,466, which application claims the benefit of International Application Number PCT/CN2018/096413, filed on Jul. 20, 2018, through which this application claims the benefit of Chinese Patent Application No. 201720979787.X, filed on Aug. 7, 2017, and Chinese Patent Application No. 201720979716.X, filed on Aug. 7, 2017.

The present application also claims the benefit of Chinese Patent Application No. 202210517136.4, filed on May 13, 2022, and Chinese Patent Application No. 202210517129.4, filed on May 13, 2022.

Each of the above publications from which priority is claimed is incorporated herein by reference in its entirety

### FIELD OF THE DISCLOSURE

The present disclosure relates generally to grass trimmers and, more particularly, to a grass trimmer having an auto-winding mode, an operating method thereof and a control method thereof.

### BACKGROUND OF THE DISCLOSURE

Grass trimmers are a kind of gardening tools, which are used to trim the lawn. The grass trimmer includes a trimming head. The trimming head rotates at high speed to drive a trimming line mounted thereon to rotate so as to realize the cutting function.

The trimming head includes a spool allowing the trimming line to wind thereon. During the cutting operation, the trimming line is worn away gradually due to wear. After operating for a period, it is needed to change a new trimming line and wind the new trimming line around the spool. For the currently known trimming line, a user needs to rotate the spool manually to wind the trimming line around the spool. The winding operation is inconvenient and the winding speed is slow.

The statements in this section merely provide background information related to the present disclosure and may not constitute prior art.

### SUMMARY

In one aspect of the disclosure, a grass trimmer is provided. The grass trimmer includes a trimming head, a driving device for driving the trimming head to rotate so as to cut vegetation and an operating device for a user to operate so as to control the driving device. The trimming head includes a spool and a line holding element, the spool is used to wind a trimming line, and the line holding element is formed with a line holding structure allowing the trimming line to pass or bypass. The driving device includes a motor, the grass trimmer has an auto-winding mode, in the auto-winding mode, the motor drives at least one of the spool and the line holding element to make the spool and the line holding element rotate relatively so that the trimming line is wound on the spool automatically.

In another aspect of the disclosure, an operating method for winding a trimming line of a grass trimmer is disclosed. The operating method includes:
providing the grass trimmer, the grass trimmer including a spool allowing the trimming line to be wound thereon, a line holding element being formed with a line holding structure, and a motor being capable of driving at least one of the spool and the line holding element;
associating the trimming line with the line holding element and inserting the trimming line in the spool; and
starting the motor to make the spool and the line holding element rotate relatively.

In another aspect of the disclosure, an operating method for winding a trimming line of a grass trimmer is disclosed. The operating method includes:
associating the trimming line with a line holding element disposed on the grass trimmer and inserting the trimming line in a spool disposed on the grass trimmer; and
starting a motor to make the spool and the line holding element rotate relatively.

In another aspect of the disclosure, a control method for winding a trimming line of a grass trimmer is disclosed. The grass trimmer includes a spool allowing the trimming line to be wound thereon, a line holding element being formed with a line holding structure for holding the trimming line and a motor being capable of driving at least one of the spool and the line holding element to make the spool and the line holding element rotate relatively. The control method includes supplying power to the motor to make the spool and the line holding element rotate relatively.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1A is a schematic view of an exemplary grass trimmer.

FIG. 1B a schematic view showing the structure of a part of the grass trimmer in FIG. 1A.

FIG. 1C is an exploded view of the structure in FIG. 1B.

FIG. 1D is a schematic view showing the transmission of a spool and a head housing in FIG. 1B.

FIG. 2A is an exploded view of an exemplary trimming head and an exemplary damping device.

FIG. 2B is a section view of the trimming head and the damping device in FIG. 2A.

FIG. 3A is also a schematic view of an exemplary trimming head and an exemplary damping device.

FIG. 3B is a schematic view showing the transmission of a spool and a head housing in FIG. 3A.

FIG. 4A is also a schematic view of an exemplary grass trimmer.

FIG. 4B is a schematic view showing the structure of a part of the grass trimmer in FIG. 4A.

FIG. 4C is a section view of the structure in FIG. 4B.

FIG. 4D is an exploded view of the structure in FIG. 4B.

FIG. 4E is another exploded view of the structure in FIG. 4B.

FIG. 4F is a section view of an upper cover in FIG. 4E.

FIG. 4G is a section view of a spool in FIG. 4E.

FIG. 4H is a schematic view showing the inserting method of a trimming head in FIG. 4A.

FIG. 4I is a schematic view of an operating device in FIG. 4A.

FIG. 4J is another schematic view of the operating device in FIG. 4A, wherein a first operating element and a second operating element are in a first preset operating state and a second preset operating state respectively.

FIG. 4K is a schematic view of an operating device.

FIG. 4L is a schematic view showing a second operating element of the operating device in FIG. 4K, wherein the second operating element is in a second position.

FIG. 4M is a schematic view of a line breaking device.

FIG. 5A is also a schematic view of an exemplary grass trimmer.

FIG. 5B is a schematic view of a trimming head and a first housing of the grass trimmer in FIG. 5A.

FIG. 5C is a schematic view of the trimming head and the first housing in FIG. 5B, wherein the trimming head and the first housing are separated.

FIG. 5D is an exploded view of the structure in FIG. 5B.

FIG. 5E is another exploded view of the structure in FIG. 5B.

FIG. 5F is a plane view of the structure in FIG. 5B.

FIG. 5G is a sectional view of the structure cut along line A-A in FIG. 5F.

FIG. 5H is a schematic view of a spool and a positioning element in FIG. 5D.

FIG. 5I is a schematic view of a lower cover in FIG. 5D.

FIG. 5J is a schematic view of the trimming head in FIG. 5F, wherein the trimming head is moved upwardly relative to the first housing.

FIG. 5K is a sectional view of the structure cut along line B-B in FIG. 5J.

FIG. 5L is a schematic view of a damping device in FIG. 5A.

FIG. 5M is a schematic view of the first housing and a driving shaft in FIG. 5C.

FIG. 5N is a sectional view of the structure cut along line C-C in FIG. 5M.

FIG. 5O is an exploded view of the damping device in FIG. 5A.

FIG. 5P is a plane view of the damping device in FIG. 5A, wherein a stopping element of the damping device is at a stopping position.

FIG. 5Q is a sectional view of the structure cut along line D-D in FIG. 5P.

FIG. 6A is a schematic view of a trimming head, a motor and a damping device.

FIG. 7A is a schematic view of an electric magnet and a trimming head.

FIG. 7B is a schematic view of a head housing in FIG. 7A, wherein the head housing is moved relative to a spool.

FIG. 8A is a schematic view of a head housing, wherein the head housing can be pulled by a rope.

FIG. 8B is a schematic view of the head housing in FIG. 8a, wherein the head housing is moved relative to a spool.

FIG. 8C is another schematic view of a head housing, wherein the head housing can be pulled by a rope.

FIG. 8D is a schematic view of the head housing in FIG. 8C, wherein the head housing is moved relative to a spool.

FIG. 9A is a circuit block diagram of a grass trimmer using a brushless motor.

FIG. 9B is a schematic view of a driving circuit in FIG. 9A.

FIG. 9C is a circuit block diagram of a grass trimmer using a brush motor.

FIG. 10A is a schematic view of the second operating element disposed on a connecting rod assembly.

FIG. 10B is a schematic view of the second operating element disposed on the first housing.

FIG. 10C is a schematic view of the second operating element disposed on a guard.

FIG. 11A is a schematic view of a grass trimmer having a line holding element.

FIG. 11B is a schematic view of a head housing and a spool of the grass trimmer in FIG. 11A, wherein the head housing and the spool are separated.

FIG. 11C is a plane view of the structure in FIG. 11A.

FIG. 11D is a schematic view of an exemplary line holding element.

FIG. 12A is a schematic view of a trimming head and a line holding element acted as an attachment.

FIG. 12B is a schematic view of the line holding element in FIG. 12A, wherein the line holding element is in a working state.

FIG. 12C is a schematic view of a line frame element, wherein the line frame element is driven by a motor.

FIG. 13A is a schematic view of an energy storing device, a motor and a trimming head.

FIG. 13B is an enlarged view of a part of the structure in FIG. 13A.

FIG. 14A is a flow diagram showing a control method for controlling winding of a grass trimmer.

FIG. 14B is another flow diagram showing a control method for winding of a grass trimmer.

FIG. 14C is a flow diagram showing an operating method for winding of a grass trimmer.

FIG. 15A is also a schematic view of an exemplary grass trimmer.

FIG. 15B is a cross-sectional view of the grass trimmer in FIG. 15A.

FIG. 15C is an enlarged view of a front end portion of the grass trimmer in FIG. 15B.

FIG. 15D is an enlarged view of a rear end portion of the grass trimmer in FIG. 15B.

FIG. 15E is an exploded view of a front end portion of the grass trimmer in FIG. 15A.

FIG. 15F is another exploded view of the front end portion of the grass trimmer in FIG. 15A.

FIG. 16 is a schematic view illustrating a grass trimmer.

FIG. 17 is a partial structural view illustrating a grass trimmer.

FIG. 18 is a schematic view illustrating a first housing of the grass trimmer in FIG. 17.

FIG. 19 is a schematic view illustrating a working housing in FIG. 16.

FIG. 20 is an exploded view illustrating partial structures in FIG. 19.

FIG. 21 is a cross-sectional view illustrating a grass trimming head and a motor in FIG. 16.

FIG. 22 is an exploded view illustrating the grass trimming head and the motor in FIG. 16.

FIG. 23 is an exploded view illustrating the grass trimming head in FIG. 22.

FIG. 24 is an exploded view illustrating the grass trimming head, the motor, and a grass trimming mechanism in FIG. 19.

FIG. 25 is an exploded view illustrating another perspective of the grass trimming head, the motor, and the grass trimming mechanism in FIG. 19.

FIG. 26A is a cross-sectional view illustrating a connecting pipe in FIG. 16.

FIG. 26B is a schematic view illustrating the connecting pipe in FIG. 26A adding an embedded member.

FIG. 27 is a schematic view illustrating a knocking cap of the grass trimming head in FIG. 21.

FIG. 28 is a schematic view illustrating an upper housing of the grass trimming head in FIG. 24.

FIG. 29 is a schematic view illustrating a spool of the grass trimming head in FIG. 24.

FIG. 30 is a schematic view illustrating another perspective of the spool in FIG. 29.

FIG. 31 is an exploded view illustrating the spool in FIG. 29.

FIG. 32 is an exploded view illustrating another perspective of the spool in FIG. 29.

FIG. 33 is a schematic view illustrating of the spool and the eyelet member of the grass trimming head in FIG. 24.

FIG. 34 is schematic view illustrating an outlet string passage of the spool in FIG. 33

FIG. 35A is a schematic view illustrating the eyelet member of the grass trimming head in FIG. 24.

FIG. 35B is a schematic view illustrating another perspective of the eyelet member in FIG. 35A.

FIG. 35C is a cross-sectional view illustrating the eyelet member in FIG. 35A.

FIG. 36A is a schematic view illustrating a first engaging tooth and a first matching tooth of the grass trimming head in FIG. 23 sliding with respect to each other.

FIG. 36B is a schematic view illustrating a first positioning surface and a second positioning surface in FIG. 36A being in contact.

FIG. 37 is a schematic view illustrating a grass trimming head including a spool formed with a bump.

FIG. 38 is a schematic view illustrating the spool and a lower housing in FIG. 37.

FIG. 39 is a schematic view illustrating a housing being formed with a bump.

FIG. 40 is a schematic view illustrating another spool.

FIG. 41 is an exploded view illustrating the spool in FIG. 40.

FIG. 42 is a schematic view illustrating another spool.

FIG. 43 is an exploded view illustrating the spool in FIG. 42.

FIG. 44 is an exploded view illustrating another perspective of the spool in FIG. 42.

FIG. 45 is a schematic view illustrating another grass trimming head.

FIG. 46 is an exploded view of another perspective of the grass trimming head in FIG. 45.

FIG. 47 is a schematic view illustrating the spool of the grass trimming head in FIG. 45.

FIG. 48 is a schematic view illustrating another grass trimming head.

FIG. 49 is an exploded view illustrating the grass trimming head in FIG. 48.

FIG. 50 is a schematic view illustrating a first magnetic member and a second magnetic member of the grass trimming head in FIG. 48.

FIG. 51 is a schematic view illustrating another perspective the first magnetic member and the second magnetic member of the grass trimming head in FIG. 48.

FIG. 52 is a schematic view illustrating another grass trimming head.

FIG. 53 is an exploded view illustrating the grass trimming head in FIG. 52.

FIG. 54 is a schematic view illustrating a grass trimming head and a friction member.

FIG. 55 is an exploded view illustrating the grass trimming head in FIG. 54.

FIG. 56 is a schematic view illustrating a grass trimming head and a stopping member.

FIG. 57 is an exploded view illustrating another perspective of the stopping member of the grass trimming head in FIG. 56.

FIG. 58 is a schematic view illustrating of a motor and a grass trimming head.

FIG. 59 is a schematic view illustrating another grass trimmer.

FIG. 60 is a partial structural schematic view illustrating the grass trimmer in FIG. 59.

FIG. 61 is a schematic view illustrating another perspective of the partial grass trimmer in FIG. 60.

FIG. 62 is an exploded view of the partial grass trimmer in FIG. 60.

FIG. 63 is an exploded view of another perspective of the partial grass trimmer in FIG. 60.

FIG. 64 is a schematic view illustrating another grass trimmer.

FIG. 65 is a partial structural schematic view illustrating the grass trimmer in FIG. 64.

FIG. 66 is a schematic view illustrating a function switching member in FIG. 65 being at a second position.

FIG. 67 is a schematic view illustrating the function switching member in FIG. 65 being at a first position.

FIG. 68 is the structure view of a long-rod type power tool according to an example.

FIG. 69 is a perspective view of the long-rod type power tool in FIG. 68 with a power source device removed.

FIG. 70 is a sectional view of the long-rod type power tool in FIG. 69.

FIG. 71 is an enlarged view of the partial area in FIG. 70.

FIG. 72 is an enlarged view of another partial area in FIG. 70.

FIG. 73 is a sectional view of a connecting rod assembly of the long-rod type power tool in FIG. 69.

FIG. 74 is a structural view of a power tool according to an example.

FIG. 75 is an exploded view of a long-rod type power tool according to an example.

FIG. 76 is a perspective view of a power tool of an example.

FIG. 77 is a perspective view of a power tool of an example.

FIG. 78 is a perspective view of a power tool according to an example.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

The following description of the preferred embodiments is merely exemplary in nature and is in no way intended to limit the scope of the invention hereinafter claimed, its application, or uses.

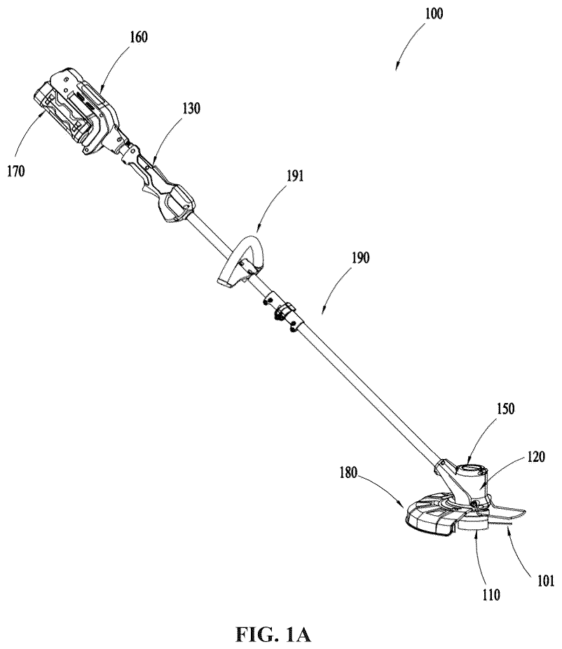

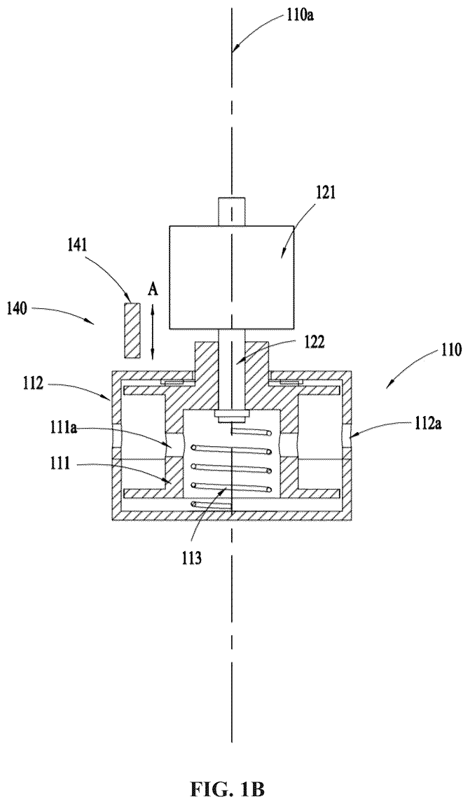

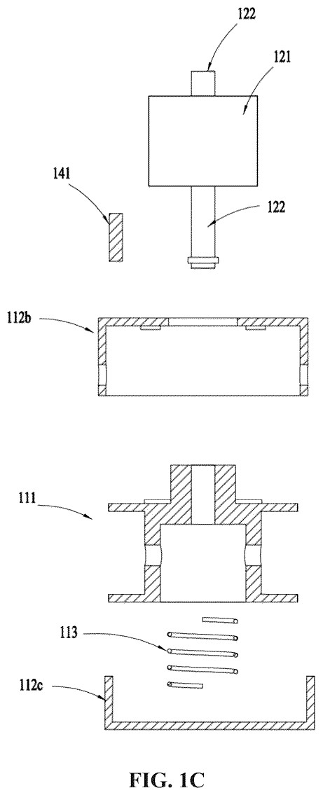

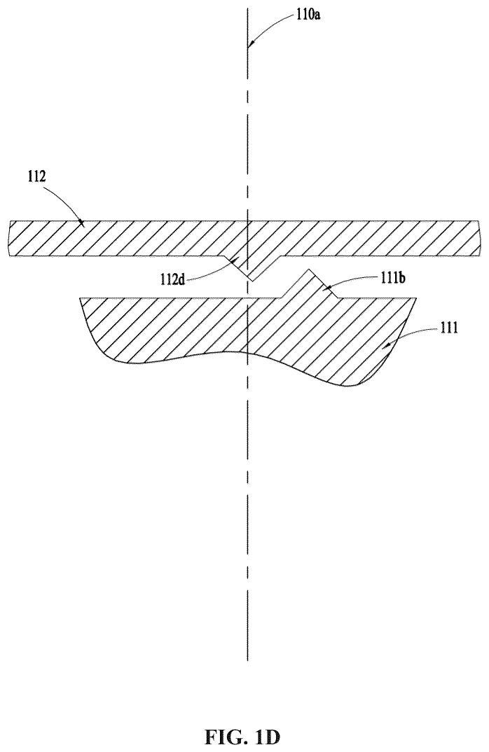

Referring to FIGS. 1A-1C, a grass trimmer 100 includes a trimming head 110, a driving device 120 and an operating device 130.

The trimming head 110 is configured to mount and accommodate a trimming line 101. The trimming line 101 is partially accommodated in the trimming head 110. The trimming line 101 has a part extending out of the trimming head 110 which is used to cut vegetation when the trimming head 110 is rotated.

The driving device 120 is able to drive the trimming head 110 to rotate about an axis 110a so as to cut vegetation. The operating device 130 is used for a user to control the grass trimmer 100.

Specifically, the driving device 120 includes a motor 121 and a driving shaft 122. The driving shaft 122 is connected with the trimming head 110 so as to drive the trimming head 110 to rotate.

The grass trimmer 100 further includes a first housing 150, a second housing 160 and a battery pack 170. The first housing 150 is configured to mount and accommodate the motor 121. The battery pack 170 acting as a power source at least can supply power to the grass trimmer 100. The second housing 160 is configured to engage with the battery pack 170 detachably.

A circuit board is accommodated in the second housing 160, which is connected with the motor 121 electrically so that the battery pack 170 can supply power to the motor 121 and control the motor 121. The first housing 150 and the second housing 160 are connected with each other through a connecting rod assembly 190. The operating device 130 is fixedly mounted on the connecting rod assembly 190. The grass trimmer 100 further includes an auxiliary handle 191 for the user to grip which is fixedly mounted on the connecting rod assembly 190.

The trimmer head 110 includes a spool 111 and a head housing 112. The spool 111 is accommodated in the head housing 112 for winding the trimming line 101. The spool 111 is formed with an inner aperture 111a. The head housing 112 is formed with an outer aperture 112a. As an example, the head housing 112 includes an upper cover 112b and a lower cover 112c, so that the head housing 112 is easy to assemble with the spool 111 and it is easy for the user to open the head housing 112 to check the inside of the head housing 112.

The trimmer head 110 includes a spring 113 which can apply a force between the head housing 112 and the spool 111. The force applied by the spring 113 makes the spool 111 depart from the lower cover 112c.

When it is needed to mount a new trimming line 101, the inner aperture 111a and the outer aperture 112a are aligned, and then the trimming line 101 is passed through the outer aperture 112a and entered into the inner aperture 111a. At this moment, as long as the spool 111 is moved relative to the head housing 112, the trimming line 101 can be wound on the spool 111 under the limiting action of the outer aperture 112a. The driving shaft 122 is connected with the head housing 112, which can drive the spool 111 to rotate about the axis 110a directly.

The spool 111 is connected rotatably with the head housing 112, which can rotate relative to the head housing 112. Meanwhile, the head housing 112 is able to move relative to the spool 111 in a direction parallel to the axis 110a.

As shown in FIG. 1D, the spool 111 is provided with a first circumferential structure 111b, and the head housing 112 is provided with a second circumferential structure 112d. Under the action of the spring 113, the spool 111 can move upward so that the first circumferential structure 111b is engaged with the second circumferential structure 112d. Thus, the spool 111 can be rotated synchronously with the head housing 112. It is noted that, the first circumferential structure 111b and the second circumferential structure 112d have a transmitting surface therebetween which is obliquely inclined with the axis 110a.

When the first circumferential structure 111b and the second circumferential structure 112d are engaged with each other, the user can start the motor 121 to make the grass trimmer 100 be in a cutting mode. At this moment, if the trimming line 101 wound on the spool 111 is sufficiently long, a part of the trimming line 101 exposed out of the head housing 112 can cut the vegetation in a whipping action.

Referring to FIGS. 1B-1C, the grass trimmer 100 further includes a damping device 140. Specifically, the damping device 140 includes a friction element 141. The friction element 141 is connected slidably with the first housing 150 and can move along a direction A. When the friction element 141 is moved to contact with the head housing 112, the head housing 112 tends to rotate relative to the spool 111. As the friction increases, a component force in the direction of the axis 110a is acted on the head housing 112 due to the inclined transmitting surface between the first circumferential structure 111b and the second circumferential structure 112d. The component force can overcome the spring force of the spring 113 sufficiently to make the head housing 112 move upward, so that the first circumferential structure 111b is disengaged with the second circumferential structure 112d. Thus, the spool 111 can rotate relative to the head housing 112, and the grass trimmer 100 is in an auto-winding mode. In the auto-winding mode, the spool 111 driven by the motor 121 can rotate relative to the head housing 112 under the action of the friction element 141 so as to realize an auto-winding function.

However, when the spool 111 is wound with enough trimming line 101 and the part of the trimming line 101 exposed out of the head housing is not long enough to cut the vegetation, the spool 111 can rotate relative to the head housing 112 so as to feed the trimming line 101 automatically for cutting purposes.

In this embodiment, the function of the friction element 141 is to produce damping on the head housing 112 so as to slow down the head housing 112. Thus, the relative rotation is occurred between the head housing 112 and the spool 111. The user can operate the friction element 141 directly or indirectly to switch the grass trimmer 100 between the cutting mode and the auto-winding mode. However, the user can operate the friction element 141 in a status corresponding to the desired mode firstly, and then start the motor 121.

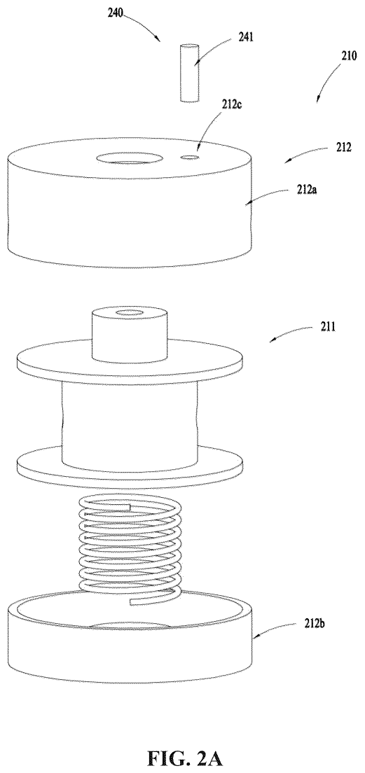

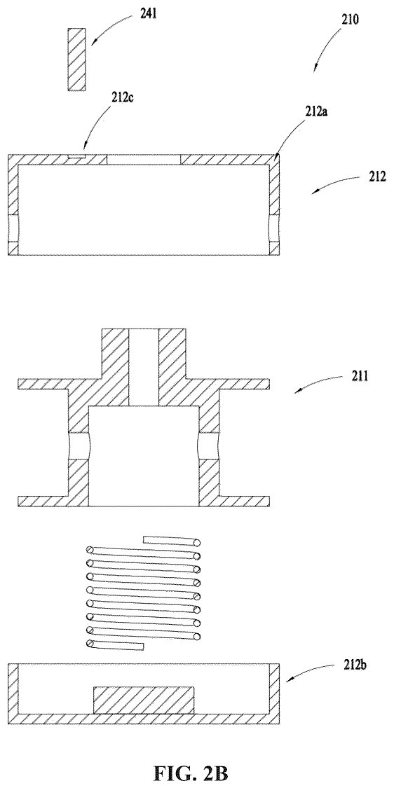

Referring to FIGS. 2A-2B, a trimming head 210 which is similar to the trimming head 110 includes a spool 211 and a head housing 212. The spool 211 and the head housing 212 are similar to the spool 111 and the head housing 112 in FIGS. 1-3. The head housing 212 includes an upper cover 212a and a lower cover 212b.

A difference between this example and the prior example is that a damping device 240 in FIGS. 2A-2B includes a stop pin 241 for stopping the head housing 212 rotating wherein the head housing 212 is formed with a stop recess 212c for engaging with the stop pin 241. Specifically, the stop recess 212c is disposed on the upper cover 212a. In the auto-winding mode, the stop pin 241 is inserted in the stop recess 212c so that the head housing 212 is stopped from rotating relative the grass trimmer. As the principle described above, the relative rotation between the spool 211 and the head housing 212 can realize the function of auto-winding.

The function of the stop pin 241 is also to damp the rotation of the head housing 212. The difference is that, the damping function of the friction element 141 is to slow down, and the damping function of the stop pin 241 is to limit the movement. Here, slowing down and limiting movement are both defined as damping. Both the friction element 141 and the stop pin 241 can be considered as a kind of the damping device.

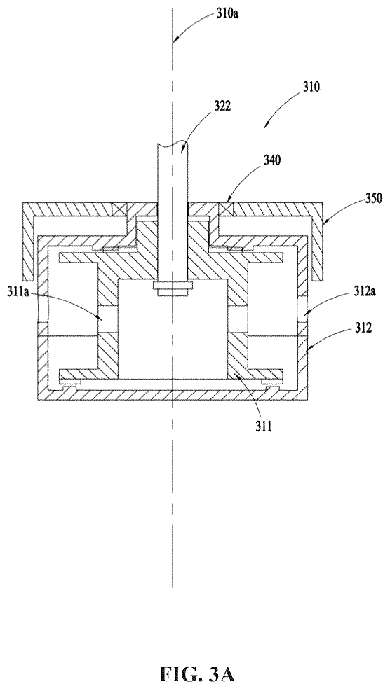

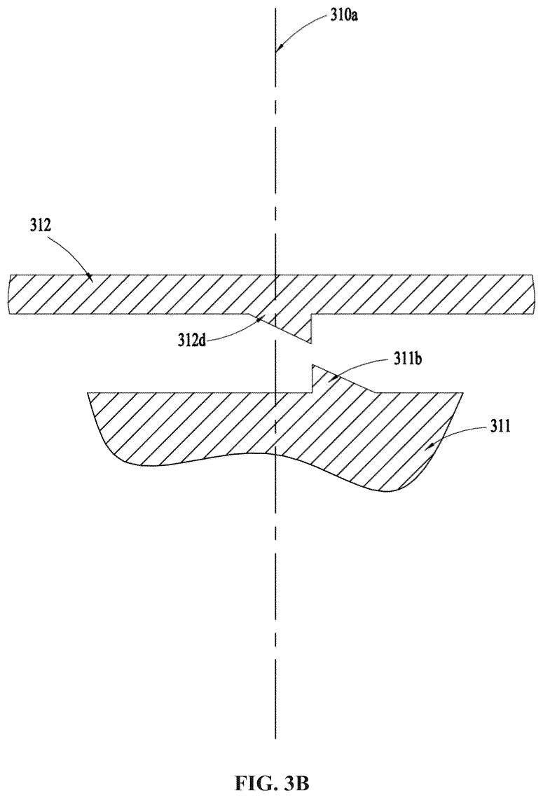

Referring to FIGS. 3A-3B, a trimming head 310 can be driven to rotate about an axis 310a. Specifically, the trimming head 310 includes a spool 311 and a head housing 312. The head housing 312 is formed with an outer aperture 312a allowing a trimming line to pass through. The spool 311 is formed with an inner aperture 311a.

In this example, a one-way bearing 340 and a supporting element 350 are provided. The one-way bearing 340 allows two elements or two parts connected therewith to be able to rotate relatively in one direction, but does not allow them to rotate relatively in another direction. The supporting element 350 is connected rotatably with a part of the trimming head 310 and can support the trimming head 310 rotatably. The supporting element 350 may be a first housing for accommodating a motor or a component connected with the first housing fixedly, for example a trimming guard.

More specifically, the one-way bearing 340 is disposed between the supporting element 350 and the head housing 312, so that the supporting element 350 is able to rotate unidirectionally relative to the head housing 312. Taking the supporting element 350 as a reference, the head housing 312 can rotate in one direction and cannot rotate in another direction.

A driving shaft 322 is connected fixedly with the spool 311, so that the spool 311 can rotate relative to the supporting element 350 in two directions. Taking the supporting element 350 as a reference, the spool 311 can rotate forwardly and reversely.

Similar to the foregoing examples, the spool 311 is provided with a first circumferential structure 311a, and the head housing 312 is provided with a second circumferential structure 312a which is able to engage with the first circumferential structure 311a. The difference is that at least one of the transmitting surfaces of the first circumferential structure 311a and the second circumferential structure 312a is substantially parallel to the axis 310a. Thus, when the first circumferential structure 311a and the second circumferential structure 312a are rotated in a direction, they cannot disengage with each other.

Based on the arrangement described above, when the motor is rotated in a forward direction, the spool 311 is driven by the driving shaft 322 to rotate forwardly. At this moment, the torque is transmitted through the transmitting surfaces of the first circumferential structure 311a and the second circumferential structure 312a which are substantially parallel to the axis 310a. Meanwhile, the one-way bearing 340 allows the head housing 312 to be able to rotate forwardly relative to the supporting element 350, i.e. the grass trimmer. So, the spool 311 is rotated synchronously with the head housing 312, and the grass trimmer performs the cutting mode. When the motor is rotated in a reverse direction, the spool 311 is driven by the driving shaft 322 to rotate reversely. The head housing 312 is stopped from rotating reversely by the one-way bearing 340, so that a relative rotation is created between the spool 311 and the head housing 312. At this moment, the first circumferential structure 311a and the second circumferential structure 312a are disengaged with each other because their contacting surfaces are inclined surfaces. The first circumferential structure 311a and the second circumferential structure 312a cannot stop the relative rotation between the spool 311 and the head housing 312 thoroughly, so the relative rotation is created continuously and the grass trimmer performs the auto-winding mode.

The function of the one-way bearing 340 is similar to the stop pin 241 which is to stop the head housing 312 from rotating. So, the one-way bearing 340 can be considered as a kind of the damping device. The difference in the examples is that the friction element 141 and the stop pin 241 are needed to be operated or activated whereas the one-way bearing 340 can realize the damping function in response to a change in the driving direction of the motor. Thereby, the mechanical structure for activating the auto-winding mode is simplified. The auto-winding mode and the cutting mode can be switched therebetween by means of controlling the forward and revers rotation of the motor.

In short, the trimming head 310 is driven by the motor around the rotate axis 310a, and has the cutting mode, the auto-winding mode, and a release mode shifted therebetween by use of first and second circumferential structures 311a, 312a and/or the one-way bearing 340.

Specifically, when the grass trimmer works in the cutting mode, the motor rotates in the first direction, and drives the spool 311 to rotate along with the head housing 312 by engagement or coupling between the first and second circumferential structures 311a, 312a.

When the grass trimmer is shifted to be at the release mode, the motor rotates in the first direction to drive the rotation of the trimming head or spool 311. During the rotation of the trimming head or spool 311, the spool 311 and the head housing 312 may be decoupled from each other to generate a relative rotation therebetween, thereby releasing the trimming line from the spool 311.

When the grass trimmer is shifted to be at the auto-winding mode, the motor rotates in the second direction opposite to the first direction, and drives the spool 311 to rotate relative to the head housing 312 by the disengagement of the first and second circumferential structures 311a, 312a in the opposite second direction. Further, by providing the one-way bearing 340, the head housing or the wire holding member 312 is fixed to the motor case through the damper or one-way bearing device 340, and the head housing or the wire holding member 312 cannot be rotated, so that the spool 311 and the wire holding member 312 can maintain a relative rotation relationship therebetween, thereby automatically winding at least a part of the trimming line around the spool 311, which is being driven by the motor.

In an example auto-winding method for a grass trimmer, with the grass trimmer including a motor configured for driving a spool, the method comprises the steps of:
a) providing a trimming head with the spool included within a head housing, the head housing having a first housing side and a second housing side;
b) inserting a trimming line, through the head housing from a first housing side, to enable the trimming line to be coupled to the spool; and
c) driving the spool to rotate relative to the head housing, thereby automatically winding at least a part of the trimming line around the spool.

Thus, a product of the auto-winding method for a grass trimmer can be achieved.

In a second example, a product of another auto-winding method for a grass trimmer can be also employed to automatically wind at least a part of the trimming line onto or around the spool.

The auto-winding method for the grass trimmer of this example comprises the steps of:
a) providing a trimming head with a spool to which a trimmer line can be coupled;
b) providing a motor configured for driving the spool; and
c) activating the motor to drive the spool to enable at least a part of the trimming line to be wound around the spool.

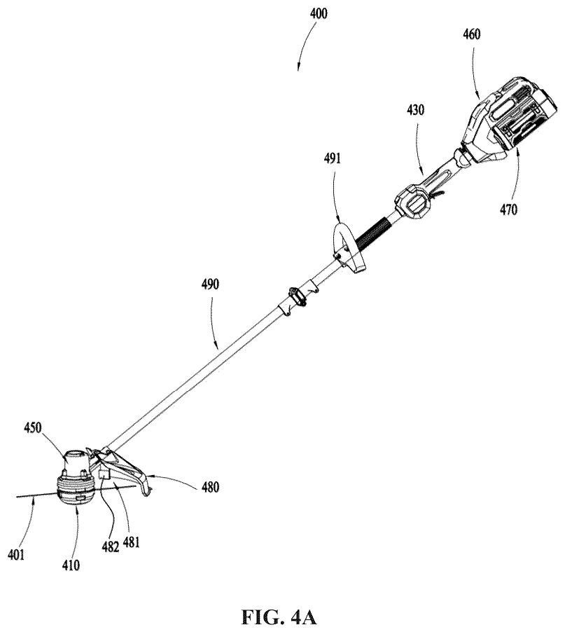

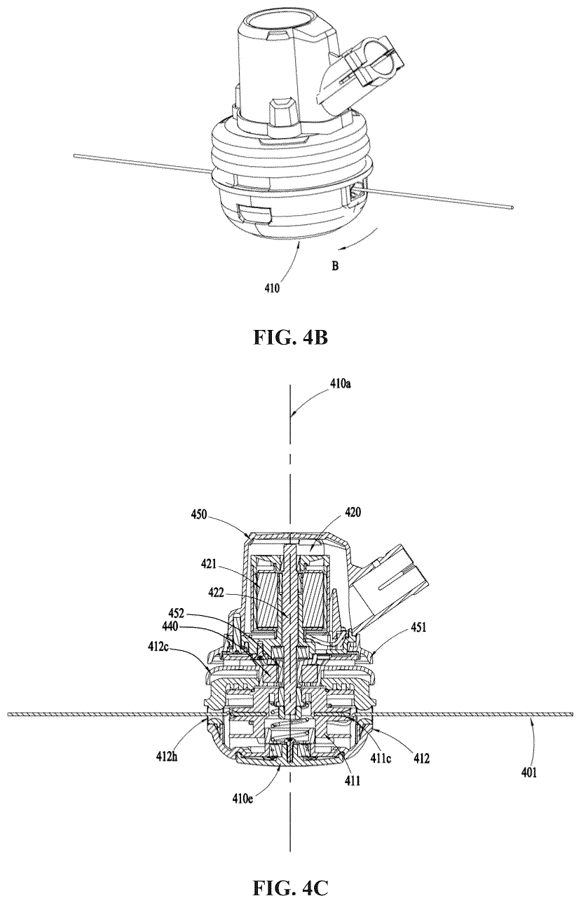

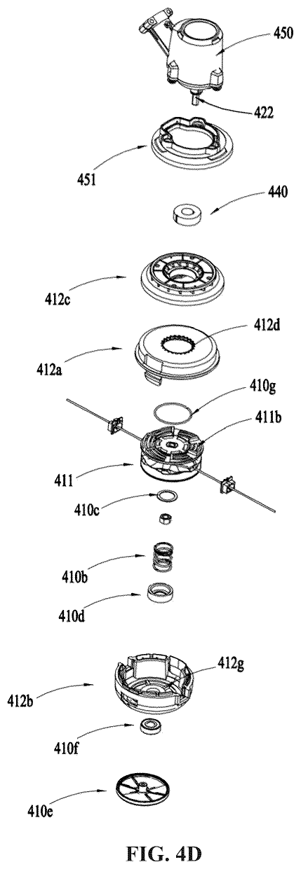

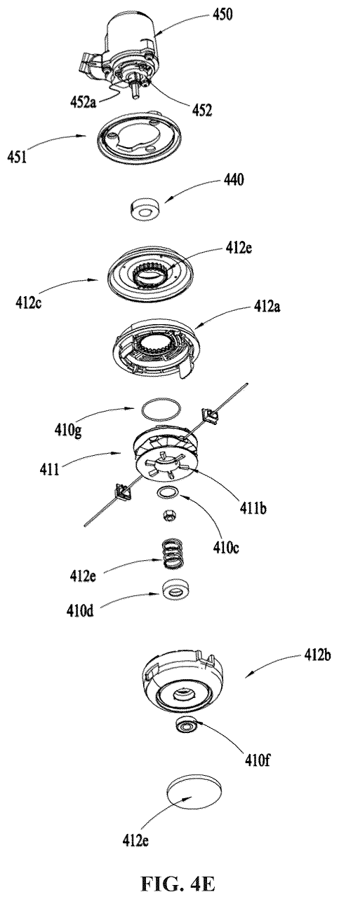

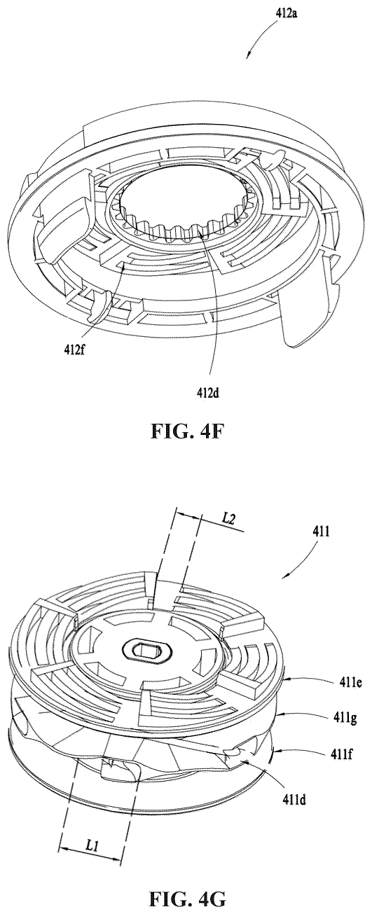

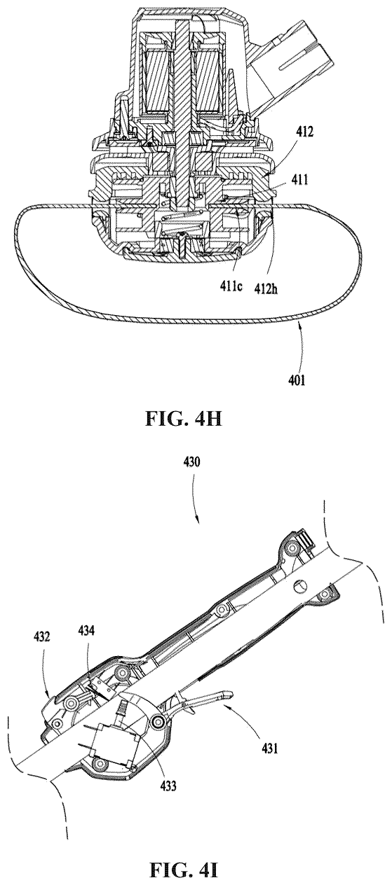

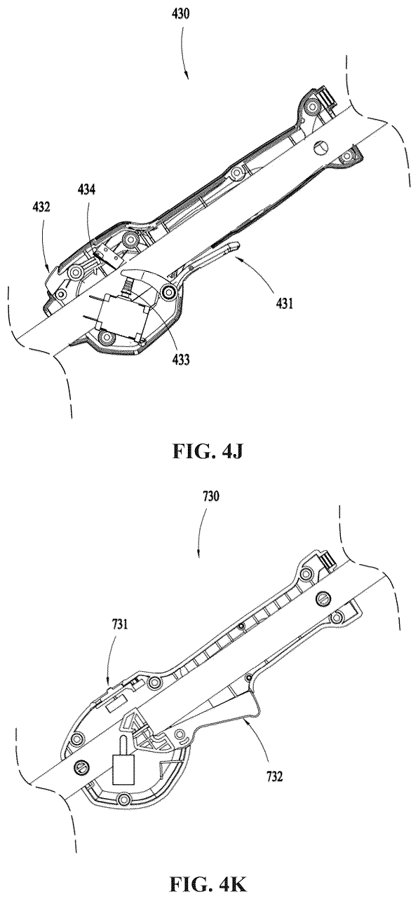

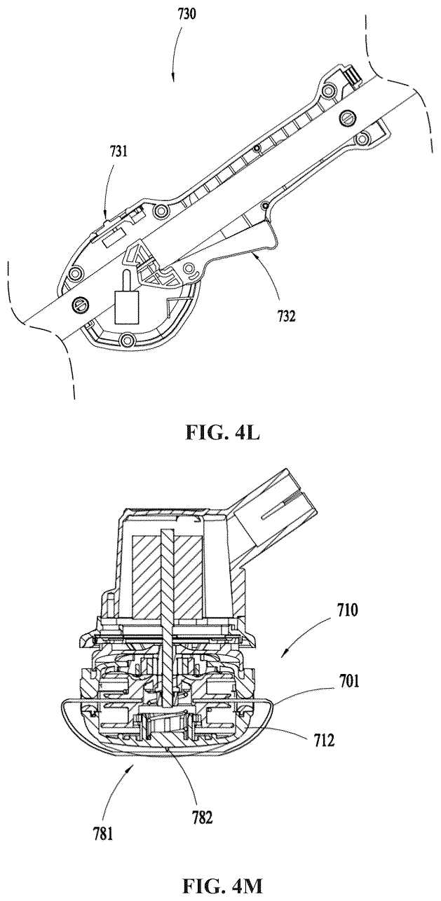

Referring to FIGS. 4A-4C, a grass trimmer 400 includes a trimming head 410, a driving device 420 and an operating device 430.

The trimming head 410 is configured to mount and accommodate a trimming line 401. The trimming line 401 is partially accommodated in the trimming head 410. The trimming line 401 has a part extending out of the trimming head 410 which is used to cut vegetation when the trimming head 410 is rotated.

The trimming head 410 can be driven by the driving device 420 to rotate about an axis 410a so as to drive the trimming line 401 to cut vegetation. The operating device 430 is used for the user to operate so as to control the grass trimmer 400.

Specifically, the driving device 420 includes a motor 421 and a driving shaft 422. The driving shaft 422 is connected fixedly with the trimming head 410 so as to drive the trimming head 410 to rotate.

The grass trimmer 400 further includes a first housing 450, a second housing 460 and a battery pack 470. The first housing 450 is configured to mount and accommodate the motor 421. The battery pack 470 acting as a power source at least can supply power to the motor 421 of the grass trimmer 400. The second housing 460 is configured to engage with the battery pack 470 detachably.

A circuit board is accommodated in the second housing 460, which is connected with the motor 421 electrically so that the battery pack 470 can supply power to the motor 421 and control the motor 421. The first housing 450 and the second housing 460 are connected with each other through a connecting rod assembly 490. The operating device 430 is fixedly mounted on the connecting rod assembly 490. The grass trimmer 400 further includes an auxiliary handle 491 for the user to grip which is fixedly mounted on the connecting rod assembly 490.

The trimming line 401 is mounted on the trimming head 410. A guard 480 is used to prevent the trimming line 401 from hurting the user, so that it can realize the function of safety and protection.

Referring to FIGS. 4C-4H, the trimming head 410 includes a spool 411 and a head housing 412.

The spool 411 for winding the trimming line 401 is connected with the driving shaft 422 and can be driven by the driving shaft 422 to rotate about the axis 410a.

The head housing 412 includes an upper cover 412a and a lower cover 412b. The trimming head 410 further includes a fan 412c. The fan 412c includes blades for generating airflow. The fan 412c can be driven by the motor 421 to rotate so as to generate airflow.

In the embodiment in FIGS. 4A-4E, a one-way bearing 440 acting as a damping device is used. The function of the one-way bearing 440 is to make the head housing 412 connect with the motor 421 in a unidirectional rotary way. Specifically, a supporting element 452 is connected with the motor 421, which allows the driving shaft 422 to pass through. The supporting element 452 is formed with a projecting portion 452a for supporting an inner ring of the one-way bearing 440. The one-way bearing 440 is not connected with the head housing 412 directly, but connected between the supporting element 452 and the fan 412c. So, the fan 412c is only able to rotate unidirectionally relative to the supporting element 452. Because the fan 412c is connected with the head housing 412 fixedly, the head housing 412 is only able to rotate unidirectionally relative to the supporting element 452 as well.

The upper cover 412a is formed with first connecting teeth 412d. The fan 412c is formed with second connecting teeth 412e for engaging with the first connecting teeth 412d. Through the engagement between the first connecting teeth 412d and the second connecting teeth 412e, the upper cover 412a can be rotated with the fan 412c synchronously. The engagement between the first connecting teeth 412d and the second connecting teeth 412e can provide a guiding effect, so that the head housing 412 is able to slide relative to the fan 412c along the axis 410a and the fan 412c is able to rotate about the axis 410a together with the head housing 412. That is the fan 412c is connected with the head housing 412 fixedly.

The grass trimmer 400 further includes a guard 451 fastened to the first housing 450. The guard 451 is able to cover the blades of the fan 412c in a radial direction of the axis 410a so as to prevent grass clippings from winding on the fan 412c. And the guard 451 is able to change the direction of the airflow of the fan 412c, so that the airflow generated by the fan 412c can blow the grass clippings outward along the radial direction of the axis 410a.

The spool 411 is driven directly by the driving shaft 422 to rotate. The head housing 412 can rotate relative to the spool 411 and slide relative to the spool 411 in the direction of the axis 410a.

Referring to FIGS. 4D-4G, the spool 411 is formed with first engaging teeth 411a on the upper portion and second engaging teeth 411b on the lower portion. The head housing 412 is formed with first matching teeth 412f and second matching teeth 412g therein. Specifically, the first matching teeth 412f is formed on the upper cover 412a, and the second matching teeth 412g is formed on the lower cover 412b.

When the head housing 412 is at a first axial position relative to the spool 411, the first matching teeth 412f are engaged with the first engaging teeth 411a. So, when the spool 411 is rotated, it can drive the head housing 412 to rotate synchronously. Specifically, the transmitting surfaces of the first matching teeth 412f and the first engaging teeth 411a are inclined surfaces, so that the first matching teeth 412f and the first engaging teeth 411a only can rotate together unidirectionally. When the spool 411 is rotated reversely, the spool 411 rotates relative to the head housing 412 due to the skid between the inclined surfaces.

When the head housing 412 is at a second axial position relative to the spool 411, the second engaging teeth 411b is engaged with the second matching teeth 412g. Because the transmitting surfaces of the second engaging teeth 411b and the second matching teeth 412g are inclined surfaces, the skid can occur between the second engaging teeth 411b and the second matching teeth 412g. So, when the head housing 412 is at the second axial position relative to the spool 411, the head housing 412 cannot be driven by the spool 411 completely. The head housing 412 still can rotate relative to the spool 411, but the speed difference of the relative rotation is decreased by the engagement of the second engaging teeth 411b and the second matching teeth 412g.

The trimming head 410 includes a spring 410b. The spring 410b can generate a force acting between the lower cover 412b and the spool 411, so that the head housing 412 is biased to the axial position and can rotate with the spool 411 synchronously. That is the first axial position described above.

The trimming head 410 further includes a first contacting element 410c and a second contacting element 410d. The spring 410b is disposed between the first contacting element 410c and the second contacting element 410d and can act on the first contacting element 410c and the second contacting element 410d directly. The first contacting element 410c and the second contacting element 410d can prevent the spring 410b from wearing on the spool 411 and the head housing 412, which are made of metal.

The trimming head 410 further includes a button 410e which is connected rotatably with the lower cover 412b. A bearing 410f is disposed between the button 410e and the lower cover 412b, so that the button 410e can be rotated relative to the lower cover 412b. Meanwhile, the button 410e and the lower cover 412b can move together in the direction of the axis 410a. When the position of the button 410e is changed, the lower cover 412b can move therewith. That is, the axial position of the head housing 412 can be changed when the button 410e is bumped.

When the grass trimmer 400 is in the cutting mode, the user can bump the trimming head 410, and the button 410e contacts with the ground to make the head housing 412 slide, so that the first engaging teeth 411a is disengaged with the first matching teeth 410f and rotated relative to the first matching teeth 410f. Further, when the button 410e is bumped, the head housing 412 can slide to the second axial position relative the spool 411 and rotate at a lower speed relative to the spool 411. So, the trimmer line 401 wound on the spool 411 can be fed out of the head housing 412 partially, and the grass trimmer 400 performs a line feeding mode. This arrangement has advantages that is, when the motor 421 is rotated at a speed in the cutting mode, the relative rotation speed of the head housing 412 and the spool 411 is controlled, so that the trimmer line 401 cannot be fed excessively during each bumping.

The button 410e is able to rotate freely relative to the lower cover 412b under the action of the bearing 410f, so that the wearing of the trimmer head 410 is reduced. The spring 410b can generate a force acting on the head housing 412 so as to make the head housing 412 move downwardly relative to the spool 411. An anti-vibration element 410g is disposed between the upper cover 412e and the spool 411 for reducing the impact between the upper cover 412e and the spool 411. Specifically, the anti-vibration element 410g is a rubber washer.

The spool 411 is formed with an inner aperture 411c and the head housing 412 is formed with an outer aperture 412h allowing the trimming line 401 to pass from the inside to the outside of the head housing 412. When the cutting mode is finished, the inner aperture 411c and the outer aperture 412h are aligned automatically in the circumferential direction. Or, when the trimming line 40a is not mounted on the trimming head 410 and the motor 421 is stopped, the inner aperture 411c and the outer aperture 412h are aligned automatically in the circumferential direction.

The spool 411 is formed with several inner apertures 411c, and the number of the inner apertures 411c is even. The several inner apertures 411c are distributed uniformly in the circumferential direction of the axis 410e. Specifically, the number of the first engaging teeth 411a is corresponded with the number of the inner apertures 411c. Similarly, the number of the second engaging teeth 411b is corresponded with the number of the inner apertures 411c. The spool 411 is formed with six inner apertures 411c. The spool 411 is further formed with six first engaging teeth 411a and six second engaging teeth 411b.

The spool 411 is formed with a guiding opening 411d for guiding the trimming line 401 to enter the inner apertures 411c. The guiding opening 411d is expanded gradually along the radial direction of the rotating axis of the spool 411. The first engaging teeth 411a are formed with inclined surfaces.

The guiding opening 411d has a maximum size L1 in the circumferential direction of the axis 410a which is greater than a maximum size L2 between two adjacent first engaging teeth 411a in the circumferential direction of the axis 410a.

When the grass trimmer 400 is in the cutting mode, the transmitting surfaces of the first engaging teeth 411a and the first matching teeth 412f are so arranged that the outer apertures 412h and the inner apertures 411c can be aligned automatically in the circumferential direction when the motor 421 is stopped. Here, the word “align” means that the trimming line 401 passing through the outer apertures 412h can be guided into the inner apertures 411c directly.

The spool 411 is formed with a first flange 411e and a second flange 411f on its two ends. The spool 411 is further formed with a division plate 411g in the middle portion. A first winding portion for winding and accommodating the trimmer line 401 is formed between the first flange 411e and the division plate 411g. A second winding portion for winding and accommodating the trimmer line 401 is formed between the second flange 411f and the division plate 411g.

In the cutting mode, the spool 411 is driven by the driving shaft 422 to rotate, and the upper cover 412a is driven by the spool 411 to rotate. The fan 412c is driven by the upper cover 412a to rotate. The fan 412c can rotate relative to the second housing 460 in a first direction referring to an arrow B in FIG. 4B. At this moment, the motor 421 is rotated forwardly so as to drive the spool 411 and the head housing 412 to rotate in the first direction.

As shown in FIG. 4H, when it is needed to supplement the trimming line 401, two ends of the trimming line 401 can be passed through the opposite outer apertures 412h of the head housing 412 respectively, and then the two ends of the trimming line 401 are extended into the two opposite inner apertures 411c of the spool 411 respectively. Sure, the user can insert two trimming lines 401 into the two inner apertures 411c respectively. At this moment, the user can control the grass trimmer 400 to make it perform the auto-winding mode. The motor 421 is rotated reversely so as to drive the spool 411 to rotate in a second direction opposite to the first direction. Due to the effect of the one-way bearing 440, the fan 412c cannot rotate in the second direction. The fan 412c is connected with the head housing 412 through the first connecting teeth 412d and the second connecting teeth 412e, so the head housing 412 cannot rotate in the second direction. The spool 411 is driven by the driving shaft 422 to rotate relative to the head housing 412 in the second direction so as to realize the auto-winding function.

Otherwise, the first engaging teeth 411a, the second engaging teeth 411b, the first matching teeth 410f and the second matching teeth 410g are inclined teeth. The inclined surfaces of the inclined teeth cannot stop the spool 411 rotating relative to the head housing 412.

When the spool 411 is wound with enough trimming line 401, the excess trimming line 401 which has not been wound needs to be to cut off. Referring to FIGS. 4A and 4H, the grass trimmer 400 includes a line breaking device 481 for cutting off the trimming line 401 automatically in the auto-winding mode.

The line breaking device 481 includes a line breaking element 482. The trimming head 410 can rotate relative to the line breaking element 482. The line breaking element 482 is fastened to the guard 480. In the auto-winding mode, the trimming line 401 can be driven by the trimming head 410 to pass the line breaking element 482. When the trimming line 401 is tensioned, it can be cut off by the line breaking element 482. In the cutting mode and feeding mode, the trimming line 401 can be cut off in the middle by the line breaking element 482, and the trimming line 401 is divided into two parts.

Sure, the trimming line 401 can be cut off in a bumping way when it is tensioned on the outside of the head housing 412.

Referring to FIGS. 41 and 4J, the operating device 430 includes a first operating element 431 and a second operating element 432. The first operating element 431 has an initial status and a first preset operating status. The second operating element 432 has an initial status and a second preset operating status. As shown in FIG. 4I, the first operating element 431 and the second operating element 432 are in the initial status. As shown in FIG. 4J, the first operating element 431 is in the first preset operating status and the second operating element 432 is in the second preset operating status. When the first operating element 431 and the second operating element 432 are in the first preset operating status and the second preset operating status respectively, the grass trimmer 100 can start the auto-winding mode.

The operating device 430 includes a first resetting assembly 433 and a second resetting assembly 434. The first resetting assembly 433 can make the first operating element 431 get out of the first preset operating status when the first operating element 431 is not operated by the user. The second resetting assembly 434 can make the second operating element 432 get out of the second preset operating status when the second operating element 432 is not operated by the user.

When the user only operates the first operating element 431 and does not operate the second operating element 432, that is the second operating element 432 is not in the second preset operating status, the first operating element 431 is operated to move to the first preset operating status. At this moment, the grass trimmer 400 is in the cutting mode.

Referring to FIGS. 4K and 4L, another operating device 730 includes a first operating element 731 and a second operating element 732. The first operating element 731 is used to activate a motor. The second operating element 732 is used for the user to operate so as to choose the auto-winding mode of the grass trimmer. The second operating element 732 has a first position a second position. As shown in FIG. 4K, the second operating element 732 is in the first position which corresponds with the auto-winding mode. At this moment, when the motor is activated by the first operating element 731, the grass trimmer goes into the auto-winding mode. As shown in FIG. 4L, the second operating element 732 is in the second position which corresponds with the cutting mode. At this moment, when the motor is activated by the first operating element 731, the grass trimmer goes into the cutting mode.

As shown in FIG. 4M, in another alternative embodiment, a line breaking device 781 can cut off a trimming line 701 in the auto-winding mode. The line breaking device 781 includes a line breaking element 782 which is able to rotate with a trimming head 710 synchronously. In the auto-winding mode, the trimming line 701 is driven by the trimming head 710 to close to the line breaking element 782 so that the trimming line 701 is cut off. The line breaking element 782 is fixed to a head housing 712. In the auto-winding mode, the trimming line 701 is close to the head housing 712. When the trimming line 701 is tensioned and contacts with the line breaking element 782, it is cut off by the line breaking element 782.

In the embodiment in FIG. 4A, the head housing 412 is formed with outer apertures 412h. In the auto-winding mode, the head housing 412 is rotated relative to the spool 411. The head housing 412 acts as a hand of the user winding the trimming line 401, and the outer apertures 412h act as the fingers of the user holding the trimming line 401. So, the head housing 412 can be defined as a line holding element. The line holding element can hold the trimming line 401 so that the trimming line 401 can rotate relative to the spool 411. The outer apertures 412h can be defined as a line holding structure. The line holding structure acts as the fingers to hold and locate the trimming line 401, and meanwhile allow the trimming line 401 to pass the outer apertures 412h continuously and wind on the spool 411.

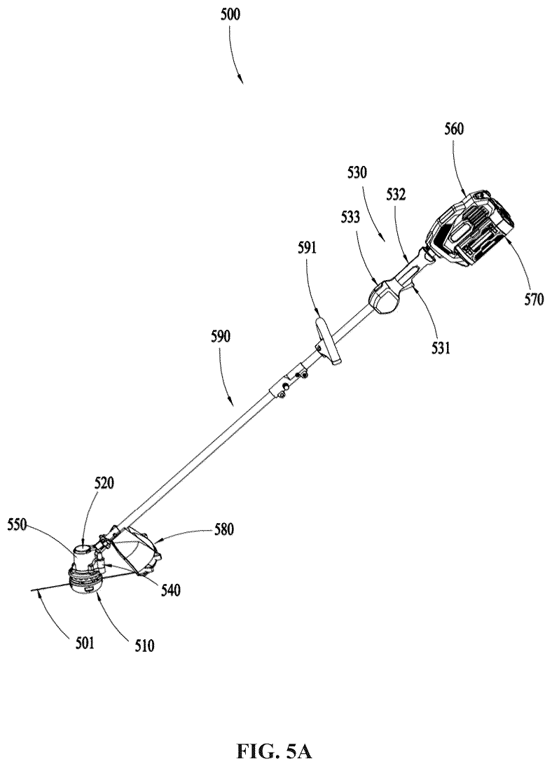

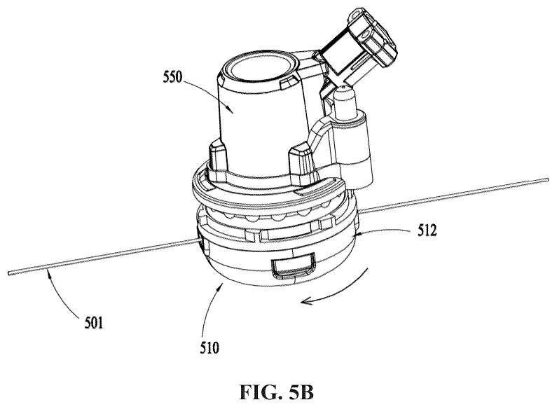

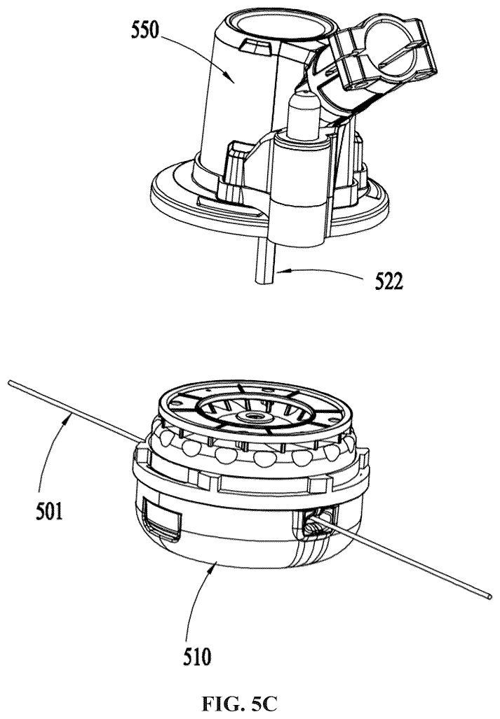

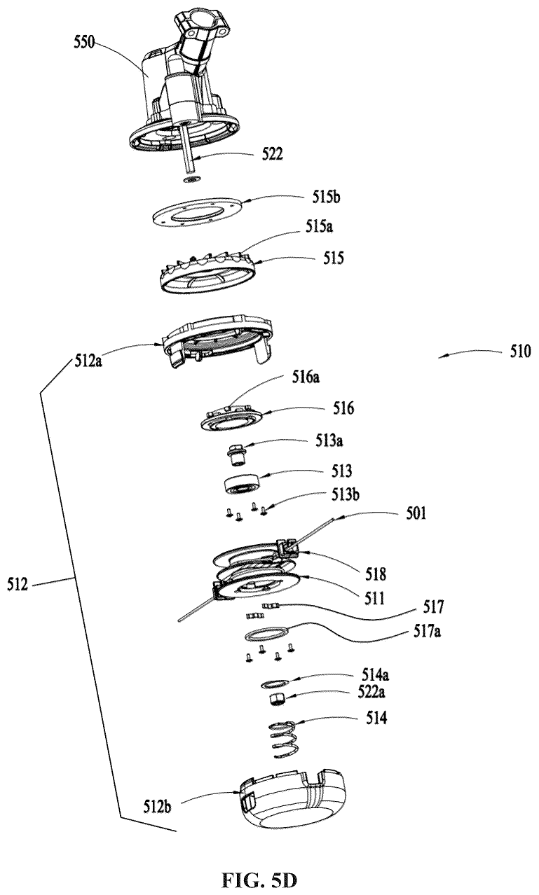

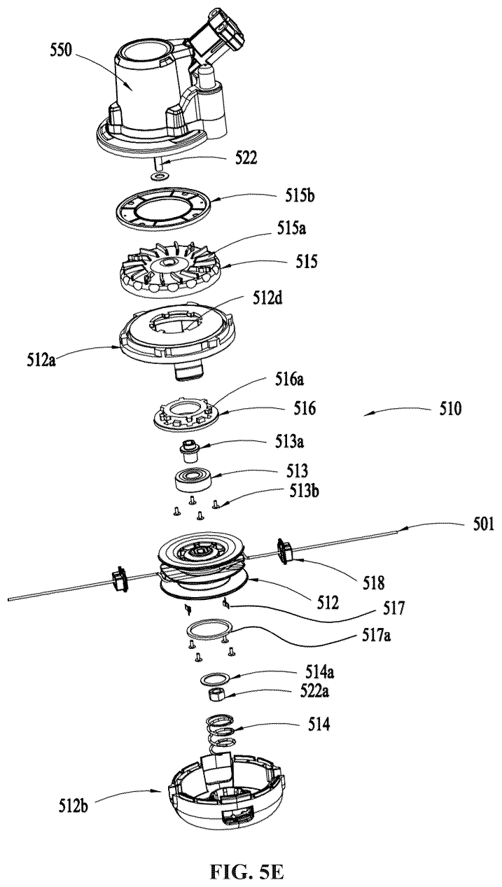

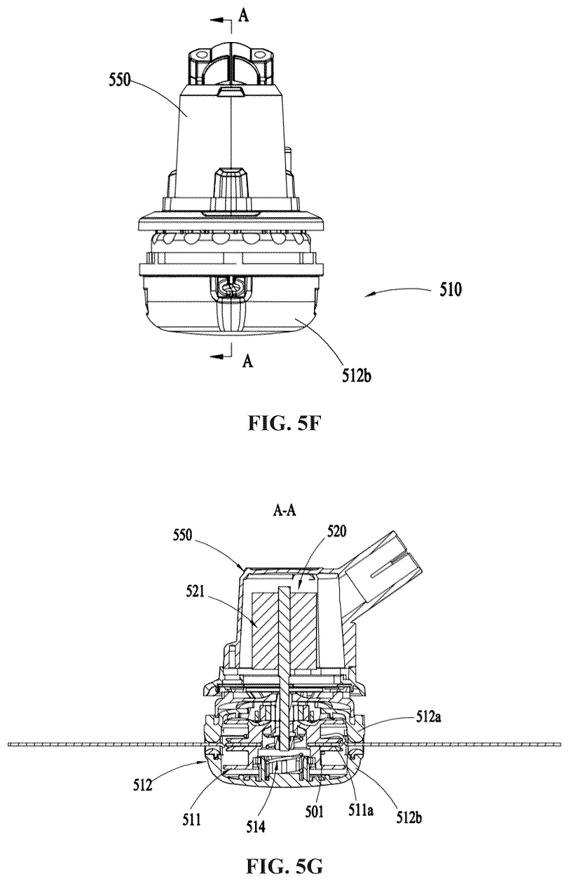

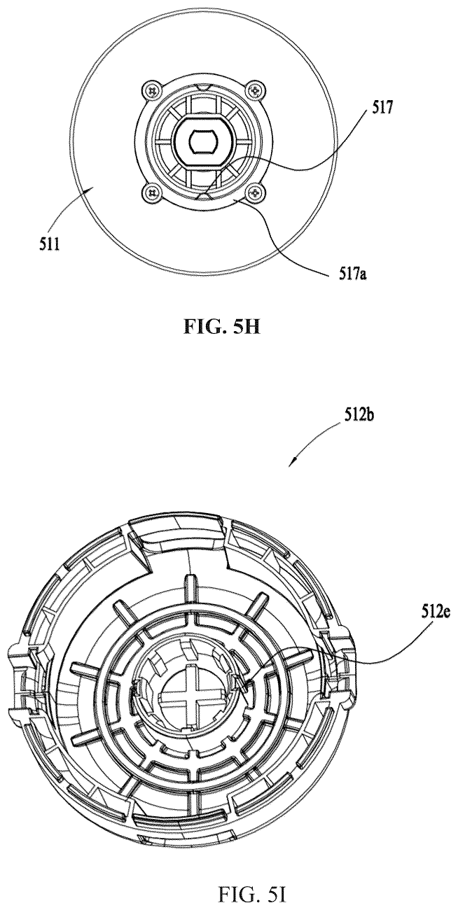

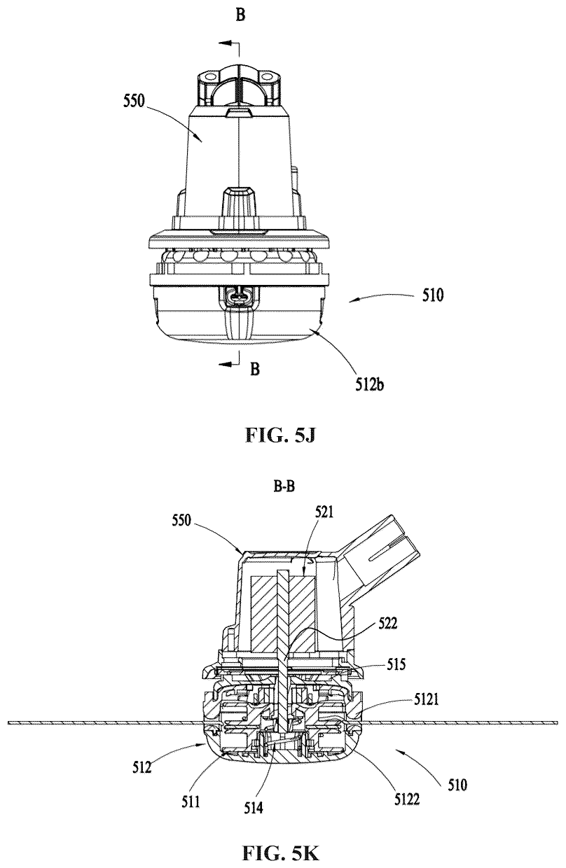

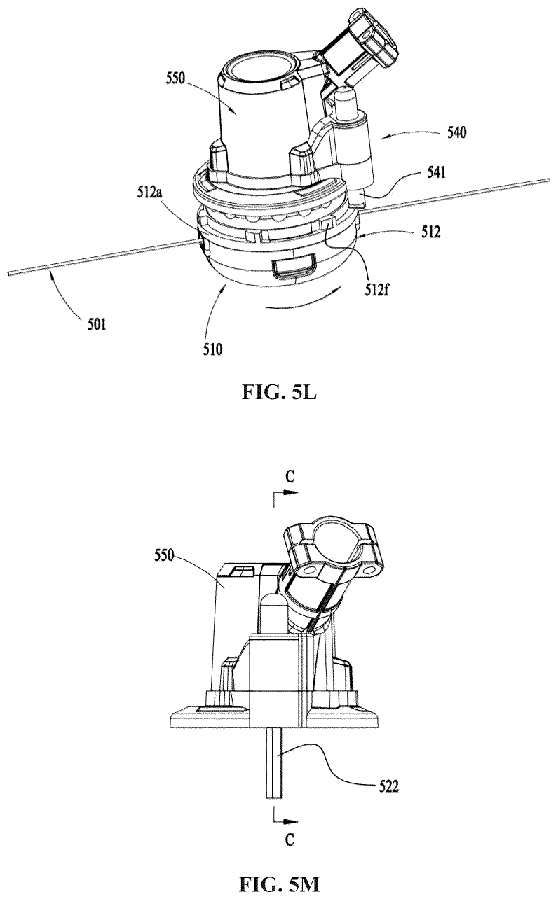

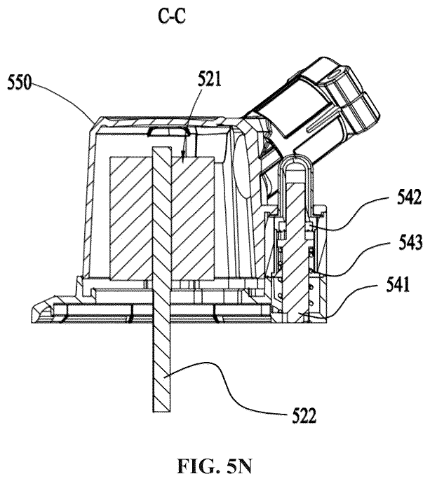

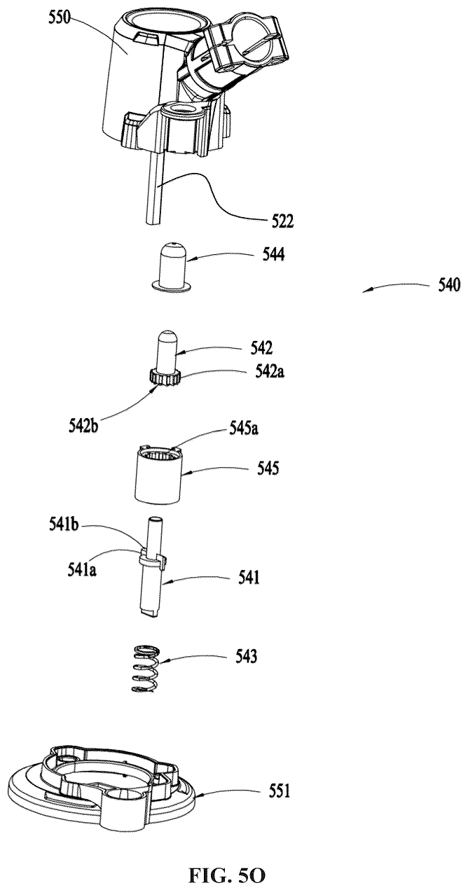

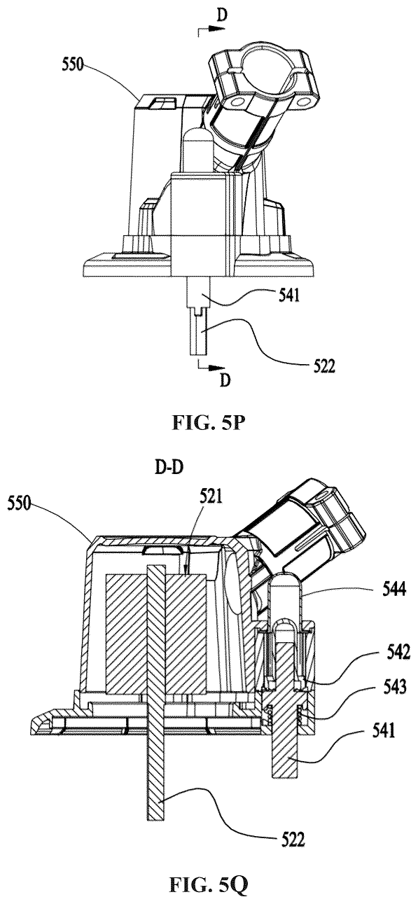

Referring to FIGS. 5A-5C, a grass trimmer 500 includes a trimming head 510, a driving device 520 and an operating device 530.

The driving device 520 includes a driving shaft 522. The driving shaft 522 is connected with the trimming head 510 so as to drive the trimming head 510 to rotate about a central axis 502. The driving device 520 further includes a motor 521. Specifically, the driving shaft 522 is an output shaft of the motor 521.

The grass trimmer includes a first housing 550, a second housing 560 and a battery pack 570. The motor 521 is fixed to the first housing 550. The battery pack 570 for supplying power to the motor 521 is connected with the second housing 560 detachably. Further, a circuit board is disposed in the second housing 560, which is connected with the motor 521 to control the motor 521. The first housing 550 and the second housing 560 is connected through a connecting rod assembly 590. The operating device 530 is fixed to the connecting rod assembly 590. The grass trimmer 500 further includes an auxiliary handle 591 fixed to the connecting rod assembly 590 for the user to grip.

A trimming line 501 is mounted on the trimming head 510. A guard 580 can prevent the trimming line 501 from hurting the user so as to realize the function of protection.

Referring to FIGS. 5D-5G, the trimming head 510 includes a spool 511 and a head housing 512. The spool 511 allowing the trimming line 501 to wind thereon is formed with an inner aperture 511a and the end of the trimming line 501 is extended into the inner aperture 511a. Specifically, the spool 511 is formed with two inner apertures 511a on the opposite sides. Two trimming lines 501 can be inserted in the two inner apertures 511a respectively. Or, two ends of one trimming line 501 can be inserted in the two inner apertures 511a respectively. The spool 511 is accommodated in the head housing 512. The head housing 512 includes an upper cover 512a and a lower cover 512b which are coupled with each other through a snap joint.

The spool 511 is disposed between the upper cover 512a and the lower cover 512b. The head housing 512 is formed with outer apertures 512c allowing the trimming line 501 to go through the head housing 512 from the inside. Specifically, the outer apertures 512c are formed on the lower cover 512b. Further, the trimming head 510 includes eyelets 518 fastened on the lower cover 512b which allow the trimming line 501 to pass through. More specifically, the eyelets 518 are made of metal which can prevent the trimming line 501 from wearing the lower cover 512b.

The grass trimmer 500 further includes a one-way bearing 513. When the one-way bearing 513 is rotated in one direction, an inner ring and an outer ring of the one-way bearing 513 are rotated synchronously. While, when the one-way bearing 513 is rotated in the reverse direction, the inner ring is rotated relative to the outer ring. When the driving shaft 522 is rotated in one direction, the one-way bearing 513 allows the head housing 512 and the spool 511 to rotate synchronously. While, when the driving shaft 522 is rotated in the reverse direction, the spool 511 is rotated relative the head housing 512 under the action of the one-way bearing 513.

The trimming head 510 includes an elastic element 514 which is able to generate a force between the head housing 512 and the spool 511. The force acts on the head housing 512 to make the head housing 512 depart from the first housing 550 or the motor 521. Specifically, elastic element 514 is disposed between the lower cover 512b and the spool 511. The spool 511 can apply force on the lower cover 512b and the spool 511 respectively through its two ends. The two ends can be connected with the lower cover 512b and the spool 511 directly and apply force on them, or connected with the lower cover 512b and the spool 511 indirectly and apply force on them through other components.

Specifically, the trimming head 510 further includes a washer 514a disposed between the elastic element 514 and the spool 511. The force of the elastic element 514 is transferred to the spool 511 through the washer 514a. When the spool 511 is rotated relative to the head housing 512, the elastic element 514 is rotated relative to the spool 511. The washer 514a is able to prevent the elastic element 514 from wearing the spool 511. When the trimming head 510 is bumped by the user, the elastic element 514 is compressed, and the head housing 512 is moved in a direction close to the first housing 550 or the motor 521. As shown in FIG. 5B, the head housing 512 is moved upward. When the bumping is finished, the elastic element 514 can apply force on the lower cover 512b so as to make the lower cover 512b to move downward or in the direction far from the first housing 550 or the motor 521. So, the line bump feeding is realized.

The grass trimmer 500 further includes a fan 515. The fan 515 can be formed by the head housing 512 or a separate element. Specifically, the fan 515 is a separate element, which is connected with the driving shaft 522 and driven by the driving shaft 522 to rotate. Alternatively, the fan can be connected with the head housing and driven by the head housing to rotate.

Specifically, the fan 515 is provided with several blades 515a. The trimming head 510 includes an end cap 515b fixed to the fan 515. More specifically, the end cap 515b is fixed to the blades 515a. The end cap 515b has an annular shape and allows the driving shaft 522 to pass through. The fan 515 is disposed between the motor 521 and the head housing 512. The fan 515 is also disposed between the first housing 550 and the head housing 512. The fan 515 is also disposed between the first housing 550 and the spool 511. The upper cover 512a is disposed between the fan 515 and the lower cover 512b. The upper cover 512a is also disposed between the fan 515 and the spool 511. It can be considered as the fan 515 is disposed above the head housing 512.

The spool 511 is connected with the driving shaft 522 so as to rotate with the driving shaft 522 synchronously. The fan 515 is rotated with the driving shaft 522 and the spool 511 synchronously. The spool 511 is fixed to the driving shaft 522 through a locating nut 522a, so the axial position of the spool 511 relative to the driving shaft 522 is limited.

The trimming head 510 further includes a connecting element 516 which is formed with a plurality of feeding teeth 516a for feeding line. The head housing 512 is formed with a plurality of matching teeth 512d for engaging with the feeding teeth 516a. The matching teeth 512d is engaged with the feeding teeth 516a so as to control the line bump feeding.

The trimming head 510 further includes a connecting shaft 513a fixed to the driving shaft 522. The fan 515 is fixed to the connecting shaft 513a, so that the fan 515 can be driven by the driving shaft 522 to rotate. The one-way bearing 513 is fixed to the connecting shaft 513a. Specifically, the connecting shaft 513a is disposed in the inner ring of the one-way bearing 513. So, the driving shaft 522 can drive the inner ring of the one-way bearing 513 to rotate, and the inner ring is rotated with the driving shaft 522 synchronously. Further, the connecting shaft 513a can limit the axial position of the one-way bearing 513 relative to the driving shaft 522. The connecting element 516 is fixed to the outer ring of the one-way bearing 513 and rotated with the outer ring synchronously. The one-way bearing 513 and the connecting element 516 are fixed by a screw 513b, so the displacement of the one-way bearing 513 and the connecting element 516 in the axial direction is limited. The connecting element 516 is engaged with the head housing 512 through the engagement of the feeding teeth 516a and the matching teeth 512d. The head housing 512 is driven to rotate by the connecting element 516.

Referring to FIGS. 5D-5L, the trimming head 510 further includes locating elements 517 for aligning the inner apertures 511a and the outer apertures 512c. When it is needed to add a new trimming line 501 to the spool 511, the user can make the head housing 512 rotate to align with the spool 511 conveniently. The trimming line 501 is passed through the outer apertures 512c of the head housing 512 and entered into the inner apertures 511a. The locating elements 517 are fixed to the spool 511. The trimming head 510 includes a pressing plate 517a for fixing the locating elements 517 to the spool 511. The lower cover 512b is formed with locating recesses 512e for engaging with the locating elements 517. When the locating elements 517 are entered into the locating recesses 512e partially, the inner apertures 511a and the outer apertures 512c are aligned.

Referring to FIGS. 5F and 5G, the trimming head 510 is in a free state which is not bumped. Referring to FIGS. 5J and 5K, the trimming head 510 is in a compressed state which is bumped. When the user bumps the trimming head 510 to feed the trimming line 501, the lower cover 512b is contacted with the ground, and the ground applies an upward force to the lower cover 512b so that the upper cover 512a and the lower cover 512b move upward to the state in FIGS. 5J and 5K relative to the spool 511, the fan 515, the motor 521 and the driving shaft 522. At this moment, the head housing 512 is rotated to a certain angle relative to the spool 511. The angle is limited by the engagement of the feeding teeth 516a and the match teeth 512d, so a specific length of the trimming line 501 is released. When the user raises the trimming head 510, the force acting on the lower cover 512b by the ground disappears. The elastic element 514 generates a force to make the lower cover 512b move downward or in a direction far from the spool 511 to the state in FIGS. 5F and 5G. The line bump feeding is finished. This feeding mode is called bump feeding mode. The feeding mode means that an end of the trimming line 501 is disengaged from the spool 511 and extended out of the head housing 512. Or, it could be said that the length of the trimming line 501 located out of the head housing 512 is increased. Or, it could be said that the length of the trimming line 501 for cutting vegetation is increased.

As shown in FIG. 5B, when the grass trimmer is in the cutting mode, the trimming head 510 is rotated clockwise in a direction indicated by an arrow. The spool 511 and the head housing 512 are all rotated clockwise. In the cutting mode, the trimming line 501 is fixed relative to the trimming head 510. The spool 511 is fixed relative to the head housing 512. The grass trimmer 500 also has the auto-winding mode. In the auto-winding mode, the spool 511 is rotated relative to the head housing 512, and the trimming line 501 located out of the head housing 512 is wound on the spool 511 gradually. The rotation direction of the spool 511 in the auto-winding mode is opposite to the rotation direction of the spool 511 in the cutting mode. In the auto-winding mode, the head housing 512 is fixed. Specifically, the head housing 512 is stopped from rotating in the same direction as the spool 511. That is the head housing 512 is stopped from rotating counterclockwise.

Referring to FIGS. 5L to 5Q, the grass trimmer 500 further includes a damping device 540 which is fixed by the first housing 550. The damping device 540 includes a stopping element 541 which is a damping element. The stopping element 541 is used to stop the head housing 512 rotating in one direction relative to the first housing 550. The damping device 540 further includes an activating element 542 and a reset spring 543. The stopping element 541 is controlled to be at different positions by the activating element 542. The reset spring 543 can generate force acting on the stopping element 541 so as to make the stopping element 541 restore to an initial state. The grass trimmer 500 further includes a guard 551 fixed on the first housing 550.

The reset spring 543 is connected with the stopping element 541 and the guard 551 on its two ends respectively and can apply force between the stopping element 541 and the guard 551. The damping device 540 includes a protecting element 544 and a guiding element 545. The activating element 542 is covered by the protecting element 544 so that the user is easy to operate the activating element 542. The guiding element 545 is engaged with the stopping element 541 and the activating element 542 so as to guide the stopping element 541 and the activating element 542. The guiding element 545 is fixed on the first housing 550, which can be integrated with the guard 551 or the first housing 550. The guard 551 can be integrated with the first housing 550. The guard 551, the first housing 550 and the guiding element 545 can be integrated as a component.

The head housing 512 is provided with stopping bulges 512f. The stopping bulges 512f can be engaged with the stopping element 541 for stopping the head housing 512 from rotating relative to the spool 511. Specifically, the stopping bulges 512f are formed on the upper cover 512a and located on the edge of the upper cover 512a.

The stopping element 541 has a first position and a second position relative to the trimming head 510 or the first housing 550. Referring to FIGS. 5B and 5N, in the first position, that is the initial position of the stopping element 541, the stopping element 541 is separated from the head housing 512 and disengaged with the stopping bulges 512f to stop the head housing 512 from rotating in one direction. Or, it could be said that the stopping element 541 is not extended downward. Referring to FIGS. 5L and 5Q, in the second position, that is a stopping position, the stopping element 541 is contacted with the head housing 512 so as to stop the head housing 512 from rotating in one direction relative to the first housing 550. Specifically, the engagement of the stopping element 541 and the stopping bulges 512f can stop the head housing 512 from rotating counterclockwise as the arrow shown in FIG. 5L.

The stopping element 541 is able to slide relative to the trimming head 510 or the first housing 550. The stopping element 541 is able to slide in the direction of the rotating axis of the trimming head 510. Or, it could be said that the sliding direction of the stopping element 541 is substantially parallel to the rotating axis of the trimming head 510. The stopping element 541 is able to rotate relative to the first housing 550 about a rotating axis. The rotating axis of the stopping element 541 is substantially parallel to the rotating axis of the trimming head 510 or the driving shaft 522.

Specifically, the stopping element 541 is provided with guiding ribs 541a. The guiding element 545 is formed with guiding slots 545a. When the stopping element 541 slides relative to the first housing 550, the guiding ribs 541a slide in the guiding slots 545a. The engagement of the guiding ribs 541a and the guiding slots 545a can stop the stopping element 541 from rotating relative to the first housing 550. The activating element 542 is provided with limiting ribs 542a. The engagement of the limiting ribs 542a and the guiding slots 545a can stop the activating element 542 from rotating relative to the first housing 550. The activating element 542 is formed with a driving surface 542b. The stopping element 541 is formed with an engaging surface 541b. Specifically, the driving surface 542b is formed on the bottom of the activating element 542, and the engaging surface 541b is formed on the top of the guiding ribs 541a. When the activating element 542 is pressed downward, the stopping element 541 is pressed to move downward by the activating element 542. The guiding ribs 541a of the stopping element 541 slide in the guiding slots 545a and disengage from the guiding slots 545a finally, and the limiting ribs 542a of the activating element 542 are still in the guiding slots 545a. So, the activating element 542 is stopped from rotating relative to the first housing 550. At this moment, the driving surface 542b is engaged with the engaging surface 541b so as to constitute an engagement of inclined surfaces. Thus, the stopping element 541 is rotated relative to the activating element 542 or the first housing 550 and reaches the stopping position finally.

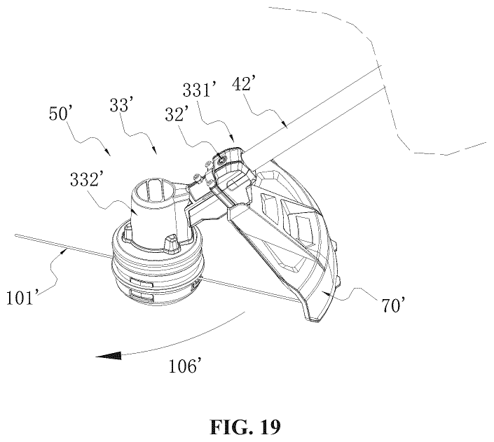

When the auto-winding mode is finished, the user can control the trimming head 510 to enter the cutting mode or the feeding mode, and the trimming head 510 is rotated in another direction. Specifically, the rotation direction of the motor in the cutting mode is different from the rotation direction of the motor in the auto-winding mode. And the rotation direction of the motor in the feeding mode is different from the rotation direction of the motor in the auto-winding mode. When the auto-winding mode is finished and going into the cutting mode or the feeding mode, the trimming head 510 is driven to rotate reversely by the motor. At this moment, the head housing 512 is rotated clockwise in a direction indicated by the arrow in FIG. 19. This direction is opposite to the rotation direction of the head housing 512 stopped by the stopping element 541. The stopping bulges 512f on the head housing 512 is contacted with the stopping element 541 so as to drive the stopping element 541 to rotate. When the guiding ribs 541a of the stopping element 541 is rotated to align with the guiding slots 545a, the stopping element 541 is moved upward under the action of the reset spring 543. The guiding ribs 541a slide upward in the guiding slots 545a and restore to the initial position.

As shown in FIG. 5A, the operating device 530 includes a first operating element 531 and a second operating element 533. When the first operating element 531 is triggered, the grass trimmer 500 is in the cutting mode. The second operating element 533 is used for the user to start the auto-winding mode of the grass trimmer 500. The operating device 530 further includes a handle housing 532 for the user to grip. The first operating element 531 and the second operating element 533 are connected with the handle housing 532. The first operating element 531 and the second operating element 533 are close to each other for easy operation by the user.

Specifically, the grass trimmer 500 includes a first electronic switch and a second electronic switch. The first electronic switch is controlled by the first operating element 531, and the second electronic switch is controlled by the second operating element 533. When the first operating element 531 is triggered, the second operating element 533 cannot be triggered. Similarly, when the second operating element 533 is triggered, the first operating element 531 cannot be triggered. When the first operating element 531 is triggered, the grass trimmer 500 is in the cutting mode. And when the second operating element 533 is triggered while the first operating element 531 is not released, the grass trimmer 500 cannot go into the auto-winding mode. Similarly, when the second operating element 533 is triggered, the grass trimmer 500 is in the auto-winding mode. And when the first operating element 531 is triggered while the second operating element 533 is not released, the grass trimmer 500 cannot go into the feeding mode. Alternatively, the grass trimmer includes a first electronic switch which can be controlled by the first operating element and the second operating element.

The first operating element 531 is able to start the motor 521. When the motor 521 is started by the first operating element 531, the motor 521 rotates in a first running state.

The second operating element 533 is able to start the motor 521. When the motor 521 is started by the second operating element 533, the motor 521 rotates in a second running state. The rotation direction of the motor 521 in the first running state is different from the rotation direction of the motor 521 in the second running state. In the auto-winding mode, the motor 521 runs in the second running state. In the cutting mode, the motor 521 runs in the first running state, and the rotational speed of the motor 521 is greater than or equal to 4000 rpm and less than or equal to 8000 rpm.

Specifically, when the grass trimmer 500 is in the auto-winding mode, the rotational speed of the spool 511 is greater than or equal to 100 rpm and less than or equal to 2000 rpm. More specifically, the rotational speed of the spool 511 is greater than or equal to 300 rpm and less than or equal to 800 rpm. Alternatively, the rotational speed of the spool 511 is greater than or equal to 30 rpm and less than or equal to 600 rpm. Or, the rotational speed of the spool 511 is greater than or equal to 60 rpm and less than or equal to 300 rpm. A ratio of the rotational speeds of the spool 511 in the cutting mode and in the auto-winding mode is greater than or equal to 5 and less than or equal to 300. Further, the ratio of the rotational speeds of the spool 511 in the cutting mode and in the auto-winding mode is greater than or equal to 10 and less than or equal to 200.

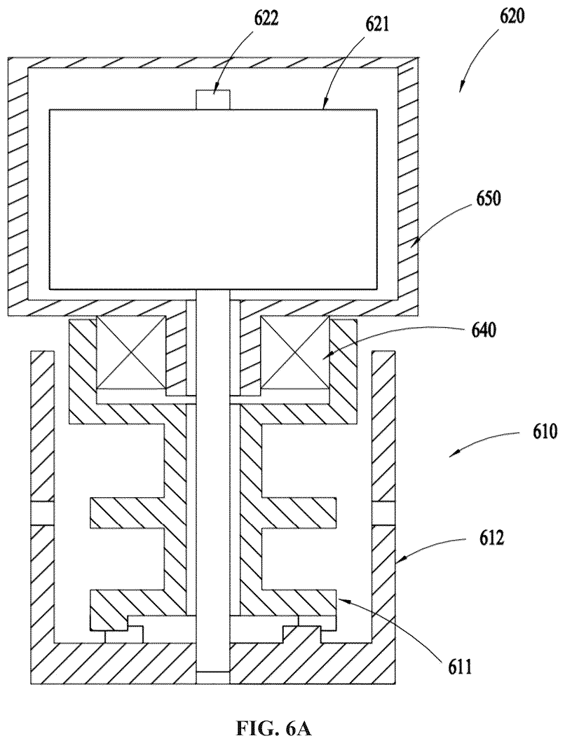

As shown in FIG. 6A, a motor 621 has a driving shaft 622 for driving a head housing 612 and a one-way bearing 640 and a damping device 611 are provided.

A driving device 620 includes the motor 621. A trimming head 610 includes a spool 611 and the head housing 612.

A supporting element 650 is configured as a housing for accommodating the motor 621. The one-way bearing 640 is disposed between the spool 611 and the supporting element 650, so that the spool 511 can only rotate unidirectionally relative to the supporting element 650.

The driving shaft 622 passes through the spool 611, but the spool 611 is not driven by the driving shaft 622 directly. That is, the torque is not transmitted directly between the driving shaft 622 and the spool 611. The driving shaft 622 is connected fixedly with the head housing 612, and the head housing 612 is driven by the head housing 612 directly. And then the spool 611 is driven by the head housing 612 through the transmission structure in FIG. 3B.

According to the example and the principle described above, when the motor 621 is rotated forwardly, the spool 611 and the head housing 612 can be rotated synchronously so as to perform the cutting mode. When the motor 621 is rotated reversely, the spool 611 is rotated relative to the head housing 612 so as to perform the auto-winding mode.

It can be understood that the damping device can not only apply a resistance force on the head housing to damp its rotation, but can also apply a resistance force on the spool to damp its rotation.

In another example, the damping device can apply a resistance force both on the head housing and on the spool. For example, more than one damping element can be disposed based on the embodiment in FIG. 6A, so that the head housing 612 can be damped and slowed down through contacting in the auto-winding mode.

In other words, the damping device includes a first damping element and a second damping element. The first damping element can apply a first resistance force on the spool to damp its rotation. The second damping element can apply a second resistance force on the head housing to damp its rotation. Thus, the head housing can be rotated relative to the spool under the effect of the first resistance force and the second resistance force.

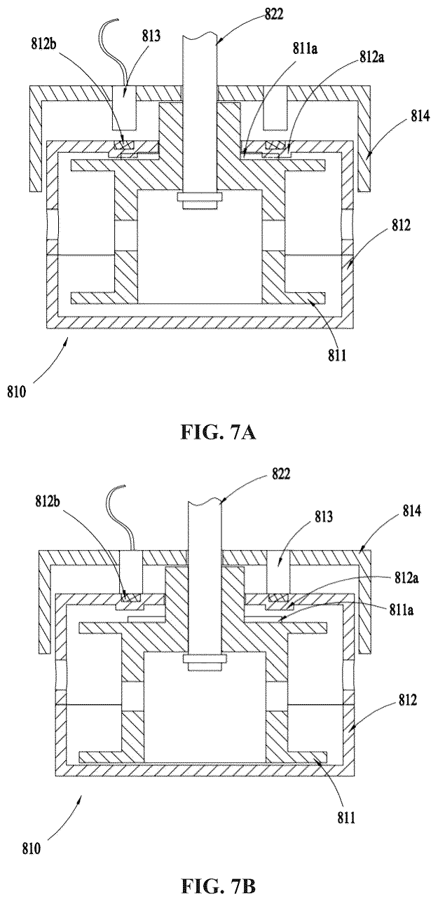

Referring to FIGS. 7A-7B, a trimming head 810 includes a spool 811 and a head housing 812 which are similar to the spool and the head housing described previously. A driving shaft 822 is connected directly with the spool 811 so as to drive the spool 811 to rotate. The spool 811 and the head housing 812 are formed with transmission structures 811a and 812a respectively which can be engaged with each other. When the head housing 812 is at an axial position as shown in FIG. 7A, the transmission structures 811a and 812a are engaged with each other, so the head housing 812 is driven by the spool 811 to rotate together. While, when the head housing 812 is at an axial position as shown in FIG. 7B, the transmission structures 811a and 812a are disengaged from each other. At this moment, if the head housing 812 is damped, the spool 811 is rotated relative to the head housing 812.

For controlling the axial position of the head housing 812, an electromagnet 813 is provided, and a magnetic element 812b is fastened on the head housing 812. A supporting element 814 can be provided for mounting the electromagnet 813. The supporting element 814 can be a guard of the grass trimmer, a housing of the motor or other parts connected fixedly with them.

When it is needed to perform the auto-winding mode, the electromagnet 813 is powered on to generate a magnetic field so as to attract the magnetic element 812b. So, the axial position of the head housing 812 is changed. At this moment, the motor is controlled so as to make the driving shaft 822 drive the spool 811, and a relative rotation is created between the spool 811 and the head housing 812. While, when it is needed to perform the cutting mode, the electromagnet 813 does not generate the magnetic field, and the head housing 812 is moved in the axial direction so as to make the transmission structures 811a and 812a engage. Thus, the spool 811 and the head housing 812 are rotated synchronously.

Alternatively, the magnetic element 812b is an annular element. The electromagnet 813 is disposed at a corresponding position. However, a part of the head housing 812 can be made of magnetic material or metal material.

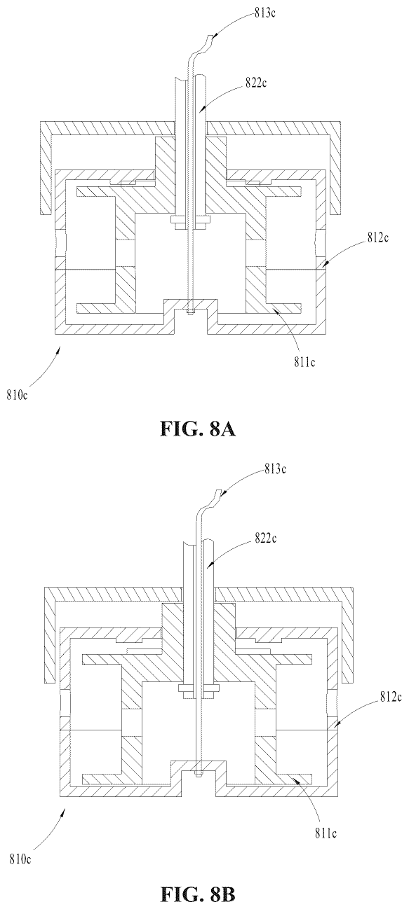

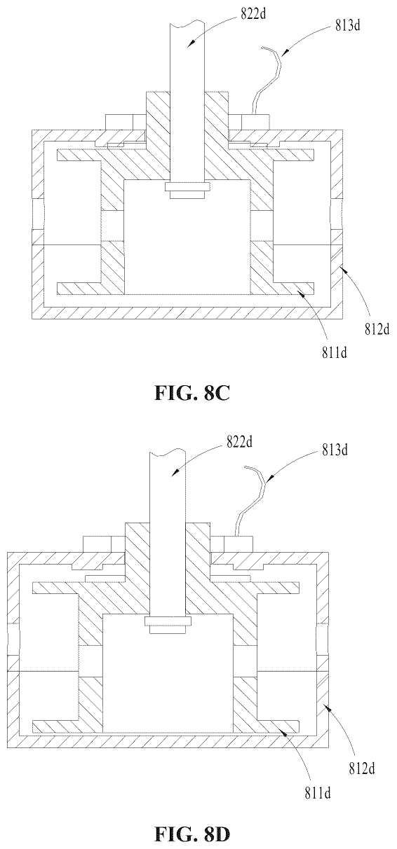

Referring to FIGS. 8A-8B, a trimming head 810c includes a rope, wire, cable, or the like 813c. The rope 813c passes through a driving shaft 822c directly, which is used to pull a head housing 812c to change the position of the head housing 812c. Thus, a spool 811c can be rotated relative to the head housing 812c.

Referring to FIGS. 8C-8D, a trimming head 810d includes a rope 813d for pulling a head housing 812d from the top so as to change the position of the head housing 812d. Thus, a spool 811d can be rotated relative to the head housing 812d. Surely, the motor can be used to drive the head housing or the similar method can be used to change its position so as to realize the function above.

In the embodiments as shown in FIG. 7A-8D, a clutch device is provided for disengaging the spool and the head housing when it is needed. So, only one of the spool and the head housing is driven by the driving shaft, and the relative rotation is created between them. While, when the spool and the head housing are needed to rotate synchronously, they are engaged, so that one of them can drive the other.

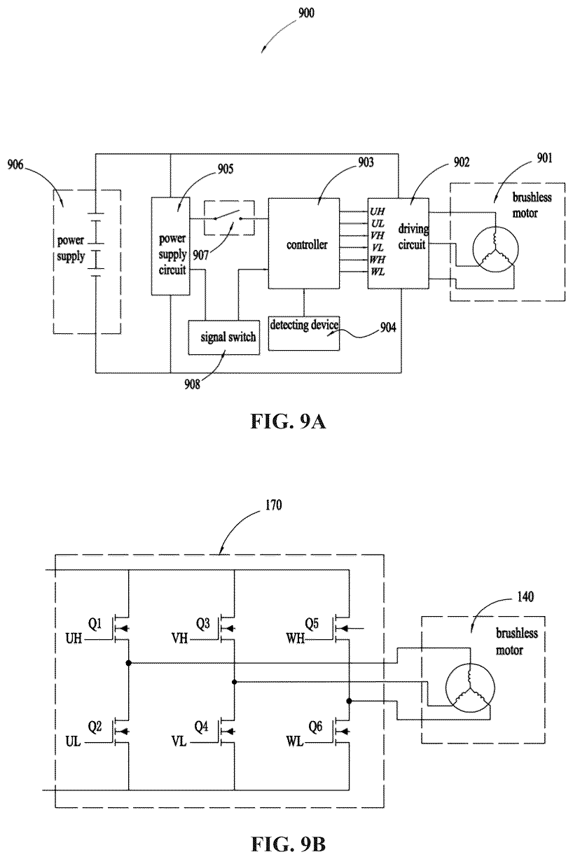

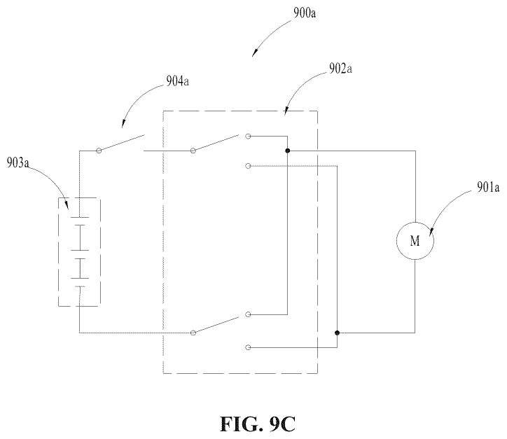

As shown in FIG. 9A, a grass trimmer 900 includes a brushless motor 901, a driving circuit 902, a controller 903, a detecting device 904, a power supply circuit 905 and a power supply 906.

The brushless motor 901 includes three-phase windings with Y-type connection. Surely, the three-phase windings can use triangular connection.

The driving circuit 902 is used to drive the brushless motor 901. As shown in FIG. 9B, specifically, the driving circuit 902 includes six semiconductor switches Q1-Q6 which constitute a full-bridge circuit with six arms. The terminals of the windings of the brushless motor 901 are connected between two corresponding semiconductor switches of the driving circuit 902. The semiconductor switches Q1-Q6 can be driven by corresponding electrical signals so as to conduct the circuit at a certain duty cycle. Thus, the current passes the corresponding winding to drive the brushless motor 901. It is noted that the controlling signal can control the current of the brushless motor 901 through controlling the duty cycle of the semiconductor switches Q1-Q6 so as to control the speed of the brushless motor 901.

The controller 903 is used to control the driving circuit 902, and in particular to send controlling signals to the driving circuit 902. The controller 903 can be constituted by a main chip mainly for operating and outputting signals and a driving chip mainly for sending driving signals to the driving circuit 902. The main chip controls the driving circuit 902 through controlling the driving chip. Surely, the controller 903 can be constituted by one chip.

The detecting device 904 includes a Hall sensor which including several Hall elements. The detecting device 904 can determine the speed of a rotor of the brushless motor 901 according to the signal change of the Hall elements.

The detecting device 904 can detect the voltage and current of the windings of the brushless motor 901 and feedback to the controller 903 as the control basis of the controller 903.

The power supply circuit 905 is mainly used to adjust the voltage of the power supply 906 so that the controller 903 can obtain proper power supply. The power supply 906 is mainly used to supply power to the grass trimmer 900. Alternatively, the power supply 906 is a battery device which can be charged repeatedly.

In this example, a physical switch 907 can be disposed between the controller 903 and the power supply circuit 905 which can be controlled by the user to switch on or off the electric connection between the controller 903 and the power supply circuit 905, so the controller 903 cannot drive the brushless motor 901.

The physical switch 907 can be acted as a main switch of the grass trimmer 900, which is used for the user to control the start of the brushless motor 901.

As shown in FIG. 9A, a signal switch 908 can be provided. The signal switch 908 is able to be operated by the user to send different signals. The controller 903 can output different control modes according to the signals sent by the signal switch 908, so that the brushless motor 901 has different running states. Thus, the signal switch 908 can be acted as an operating element for the user to choose the cutting mode or the auto-winding mode.

Specifically, when the user chooses the cutting mode, the signal switch 908 sends a first signal. At this moment, the user controls the physical switch 907 to power on the controller 903. The controller 903 enters a first control mode according to the first signal received and outputs the driving signal to the driving circuit 902 so as to make the brushless motor 901 rotate forwardly at a high speed. When the user chooses the auto-winding mode, the signal switch 908 sends a second signal which is different from the first signal. The controller 903 enters a second control mode according to the second signal and outputs the control signal so as to make the brushless motor 901 rotate reversely at a low speed.

Surely, two physical switches or two signal switches can be used, which can be used to switch the modes and control the start of the brushless motor 901 respectively.

The speed can be controlled by the duty cycle used for driving the driving circuit 902 when the controller 903 is in the first control mode and the second control mode. The controller 903 can output the driving signal at a high duty cycle in the first control mode, and output the driving signal at a low duty cycle in the second control mode.

Otherwise, in order to make the winding stop automatically, the current of the brushless motor 901 can be detected by the detecting device 904. As shown in FIG. 4H, when the winding is finished, the trimming line is tensioned, and the current of the brushless motor 901 is increased suddenly. The controller 903 can determine whether the trimming line is tensioned according to a current threshold or a current slop threshold so as to make the brushless motor 901 in the auto-winding mode stop.

Otherwise, as the trimming line is being wound, the load of the brushless motor 901 becomes high due to the increase of the mass of the trimming line. So, the current of the brushless motor 901 increases. Thus, a current threshold can be set to determine whether the winding is finished. Similarly, the speed of the motor decreases due to the increase of the load. Thus, a speed threshold or a speed slop threshold can be set to determine whether the winding is finished. When the speed decreases fast or decreases to a certain extent, the controller 903 determines that the auto-winding is finished.

Or, a position sensor or an optical sensor can be used to determine the position and state of the trimming line so as to finish the auto-winding mode.

Otherwise, based on the same principle, in order to prevent the user from starting the auto-winding mode accidentally while the trimming head still has trimming line stored therein, the controller 903 activates the auto-winding mode firstly. If a representation of the high load occurs, for example the large current or low speed, the controller 903 can determine that the auto-winding mode is not suitable for running at this moment. And then the brushless motor 901 is stopped to drive, and a sound signal or a light signal can be used to remind the user.

In a word, the controller 903 can determine the load state of the brushless motor 901 according to the speed or current of the brushless motor 901 so as to determine when to stop the winding and whether the auto-winding mode is suitable currently.

Specifically, the controller 903 can realize the controlling method as following:
a) starting the auto-winding mode;
b) determining whether the winding is suitable currently, if yes, then going to the next step, if no, the auto-winding is stopped; and
c) determining whether the parameters (current, current slop, speed, speed slope) related to the load is beyond a preset range, if yes, the auto-winding mode is stopped, if no, the auto-winding mode is continued.

As shown in FIG. 9C, the grass trimmer 900a includes a brush motor 901a. In order to realize the switching between the forward rotation and the reverse rotation, a toggle switch 902a can be used to switch the connecting methods between the brush motor 901a and a power supply 903a. And then a main switch 904a can be operated to start the brush motor 901a.

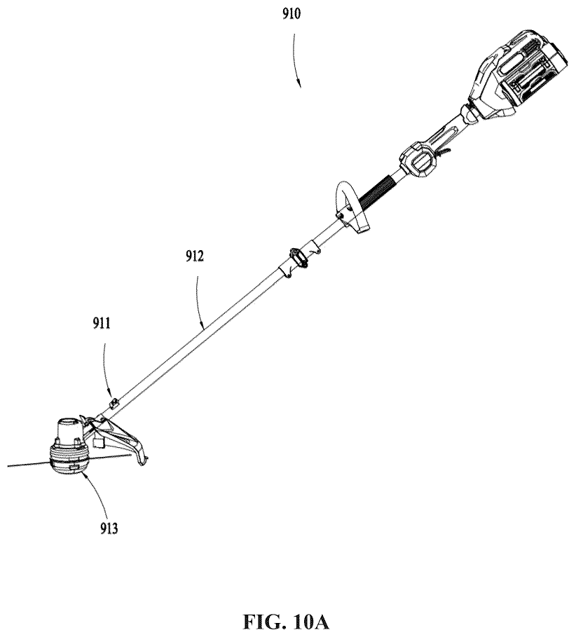

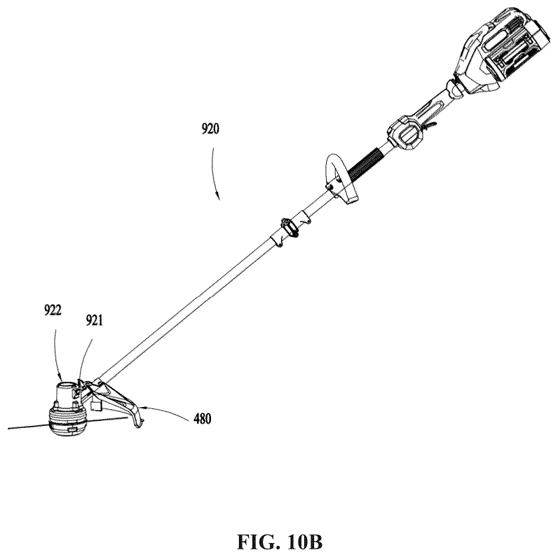

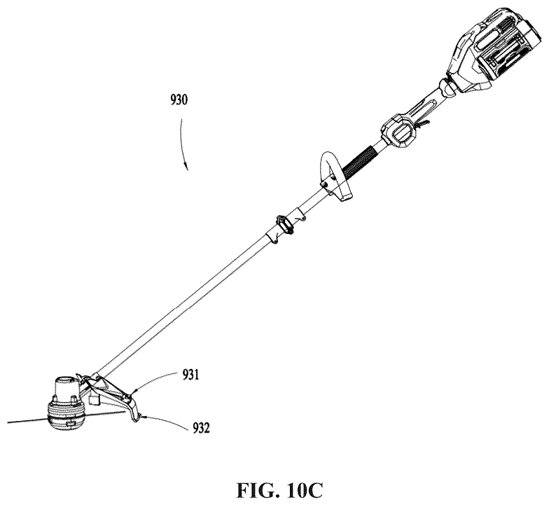

Specifically, a difference between the grass trimmer 910 in FIG. 10A and the grass trimmer 500 in FIG. 5A is the position of the second operating element. In FIG. 10A, the second operating element is disposed on the connecting rod assembly 912 and close to the trimming head 913.

As shown in FIG. 10B, a second operating element 921 of a grass trimmer 920 can be disposed on a first housing 922.

As shown in FIG. 10C, a second operating element 931 of a grass trimmer 930 can be disposed on a first housing 932.

The second operating element is disposed close to the trimming head, so that the user can start the auto-winding mode conveniently when the trimming line is inserted in the trimming head. Otherwise, the first operating element for starting the cutting mode is far from the second operating element, so that the user cannot touch the first operating element while the auto-winding is running. Similarly, the second operating element cannot be touched accidentally while the cutting mode is running.

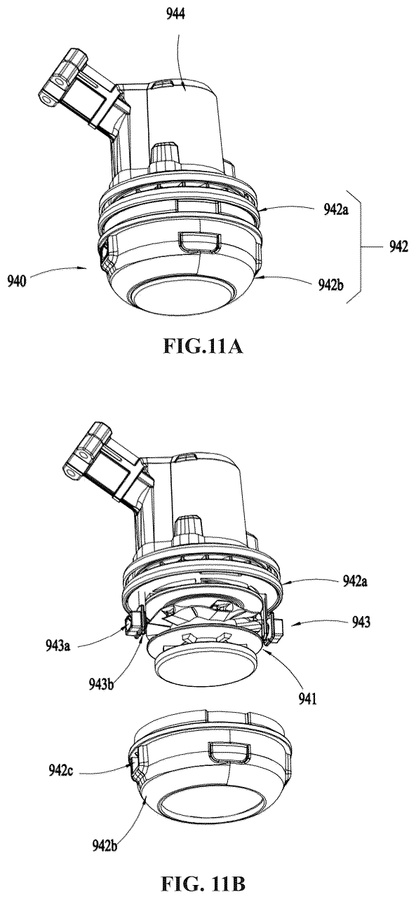

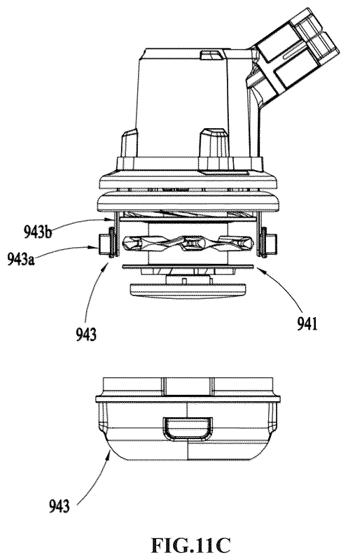

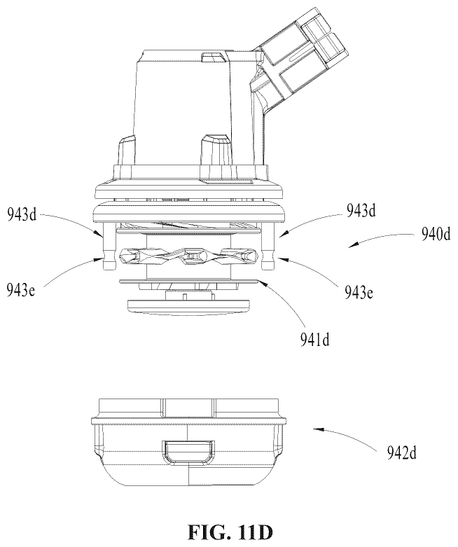

Referring to FIGS. 11A-11C, a grass trimmer 940 includes a spool 941, a head housing 942 and line frame elements 943. The spool 941 can be driven by a motor to rotate. The head housing 942 includes an upper cover 942a and a lower cover 942b which are detachable. The head housing 942 can be rotated relative to the spool 941. The line frame elements 943 can be mounted on the head housing 942, in particular on the upper cover 942a in a detachable or undetachable method. When the line frame elements 943 are mounted on the upper cover 942a, they can be rotated relative to the spool 941. Further, when the line frame elements 943 are mounted on the upper cover 942a, they can be rotated with the head housing 942 constituted by the upper cover 942a and the lower cover 942b synchronously, or with the upper cover 942a when the lower cover 942b is detached. Surely, the line frame elements 943 can be mounted on other part which is able to rotate relative to the spool 941.

The line frame elements 943 are formed with line frame structures 943a allowing the trimming line to pass through and connecting arms 943b for connecting the line frame structures 943a to make the line frame structures 943a locate on the outside of the spool 941. Specifically, taking the rotation axis of the spool 941 as an axial direction, the connecting arms 943b make the line frame structures 943a locate on the outside of the spool 941 in a circumferential direction.

When the line frame elements 943 are mounted on the head housing 942 in the undetachable method, the user can wind the trimming line without opening the head housing 942, that is without separating the upper cover 942a and the lower cover 942b. It is similar to the line winding method described above. The trimming line can be passed through apertures 942c of the head housing 942. Because the line frame elements 943 cannot be rotated relative to the head housing 942, the line frame structures 943a can be aligned with the apertures 942c. So, the trimming line can be passed through the line frame structures 943a and then inserted into the spool 941. Thus, when the auto-winding mode is entered, the spool 941 is rotated relative to the apertures 942c or the line frame structures 943a so that the trimming line is wound on the spool 941. The advantage is that the user can finish the line winding while not having to open the head housing 942.

The user also can realize the line winding in the method of opening the head housing 942. Firstly, the lower cover 942b is opened to expose the spool 941 and the line frame elements 943. And then, the trimming line is passed through the line frame structures 943a and inserted in the spool 941. When the line winding is ready, the grass trimmer can be operated so as to realize the relative rotation of the spool 941 and the line frame elements 943. So, the trimming line passes through the line frame structures 943a continuously and winds on the spool 941. When the line winding is finished, the lower cover 942b can be mounted back. The advantage is that, it is easy for the user to observe the state of line winding and control according to the state of line winding.

Alternatively, the line frame elements 943 can be omitted. A whole or a part of the head housing 942 can be made of transparent material, which can realize the object of observing the state of line winding as well.

Surely, the line frame elements 943 can be a detachable attachment. When it is needed to wind the trimming line, the head housing 942 can be opened, and the lower cover 942b can be separated. And then, the line frame elements 943 are mounted on the upper cover 942a or other part which is rotatable relative to the spool 941, for example a housing 944 for accommodating the motor. When the mounting is finished, the grass trimmer is passed through the line frame structures 943a and inserted in the spool 941. And then the spool 941 is driven to rotate. Surely, the line frame elements 943 can be driven. The trimming line can be wound on the spool 941 through the relative rotation between the spool 941 and the line frame elements 943. Then, the line frame elements 943 are detached, and the free ends of the trimming line can go out from the apertures 942c of the lower cover 942b. And then the lower cover 942b is coupled with the upper cover 942a, and the line winding is finished. Or, the upper cover 942a and the lower cover 942b can be formed with a half of the apertures 942c respectively. When the upper cover 942a and the lower cover 942b constitute a whole, the whole apertures 942c is formed. That is the upper cover 942a and the lower cover 942b are formed with two recesses respectively. After the line frame elements 943 are detached, the trimming line is located in the recesses of the upper cover 942a or the lower cover 942b, and then the upper cover 942a and the lower cover 942b are coupled as a whole. The trimming line can pass the apertures formed by the coupling of the upper cover 942a and the lower cover 942b. It is easy for the user to make the free ends of the trimming line go out of the head housing 942 from the inside.

The advantage of the detachable line frame elements 943 is that, for the grass trimmer with the head housing 942 being capable of detaching entirely or partially, the spool 941 can be exposed through detaching the head housing 942, and then the line frame elements 943 as an attachment is disposed (the line frame elements 943 may be not mounted on the head housing 942 but mounted on other part which is fixed relative to the motor, for example the housing of the motor or the guard). And then the spool 941 is driven at a low speed so as to realize the auto-winding. This can make the previous grass trimmer without auto-winding function have the corresponding hardware structure for auto-winding after the line frame elements 943 are disposed. Surely, the speed of the motor for driving the spool 941 should be adjusted so that the spool 941 is rotated at a low speed during auto-winding to ensure user safety.

Referring to FIGS. 11A-11C, the line frame elements 943 are formed with the line frame structures 943a. When the auto-winding is performed, the line frame elements 943 can be rotated relative to the spool 941. The line frame elements 943 are equivalent to simulating the manual winding of the user's hand, and the line frame structures 943a are equivalent to the fingers for holding the trimming line. So, the line frame elements 943 can be defined as a line holding element for holding the trimming line so as to make the trimming line rotate relative to the spool. And the line frame structures 943a can be defined as a line holding structure which simulates the fingers to hold the trimming line at a location and allows the trimming line pass through the line frame structures 943a continuously so as to wind on the spool 941.

As shown in FIG. 11D, a trimming head 940d includes a spool 941d and a head housing 942d, which is similar to the trimming head 940 in FIGS. 11A-11C. The difference is that the line frame elements 943 are replaced by the winding pins 943d.

Similarly, the head housing 942d can be constituted by an upper cover and a lower cover which are detachable. The winding pins 943d similar to the line frame elements 943 can be detachable or undetachable, which can be mounted on other part being capable of rotating relative to the spool 941d. The difference is that the winding pins 943d are not formed with the line frame structures 943a, but formed with concave parts 943e. The concave parts 943e can locate the trimming line going around the concave parts 943e. When the winding pins 943d are rotated relative to the spool 941d, they can drive the trimming line through the friction force so as to realize the auto-winding. So, the winding pins 943d can be defined as a line holding element, and the concave parts 943e can be defined as a line holding structure.

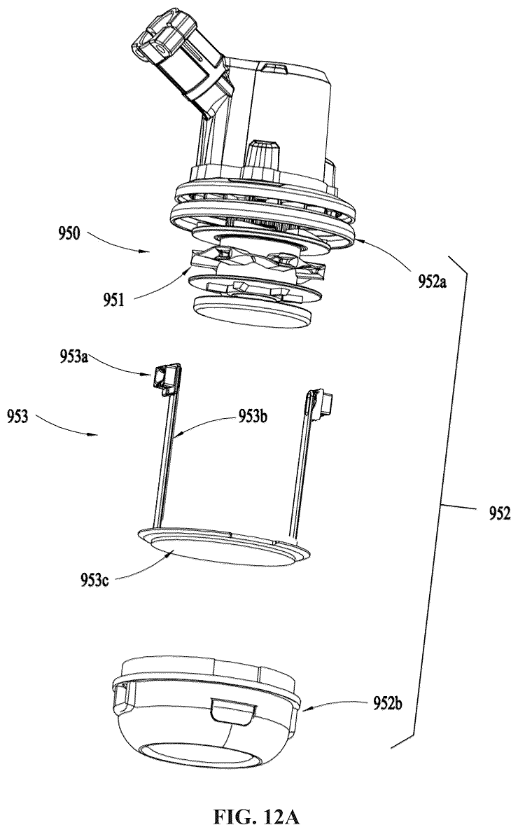

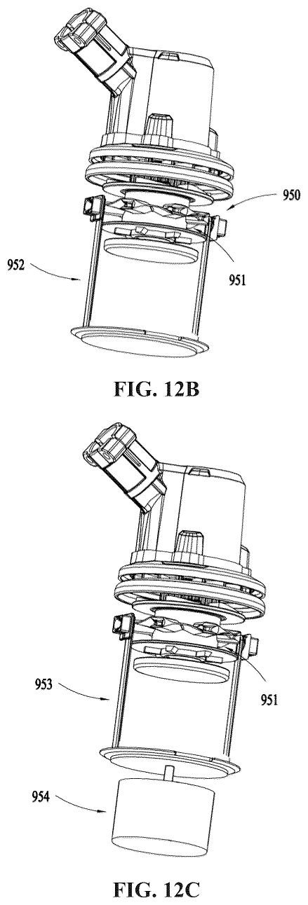

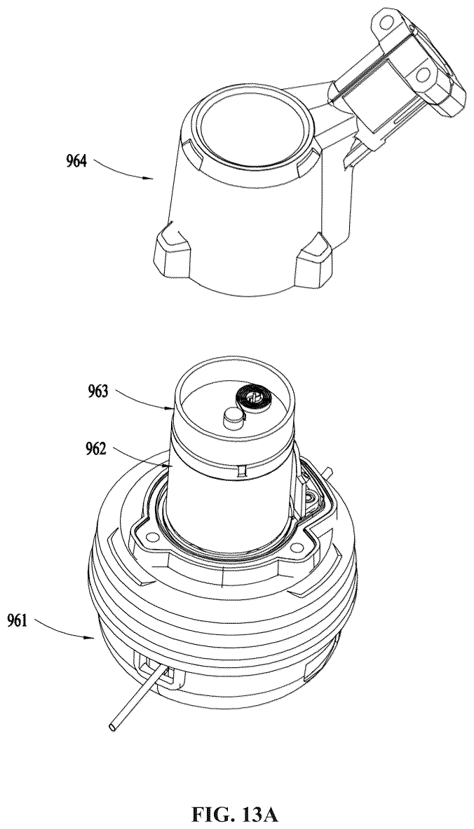

Referring to FIGS. 12A-12B, line frame elements 953 can be acted as functional attachments which are independent of a trimming head 950. Line frame elements 953 include a fixing seat 953c except line frame structures 953a and connecting arms 953b. The fixing seat 953c is connected with the connecting arms 953b. When it is needed to wind the trimming line automatically, an upper cover 952a and a lower cover 952b of a head housing 952 are separated so as to expose a spool 951. And then, the trimming line is passed through the line frame structures 953a and inserted into the spool 951. And then, a motor is started to drive the spool 951. The spool 951 is rotated relative to the line frame elements 953 so as to realize the auto-winding.

In the embodiment in FIG. 12C, an auxiliary device such as a bracket can be used to fix the grass trimmer or the spool 951, and an extra motor 954 is used to drive the line frame elements 953 to rotate relative to the spool 951. So, the auto-winding is realized. In this embodiment, the requirements of configuration of the grass trimmer itself is reduced. The auto-winding can be realized through the line frame elements 953 acting as separate attachments or a combination of the line frame elements 953 and a corresponding driving device, as long as the head housing 952 can be opened. And it is no need to change the grass trimmer too much.

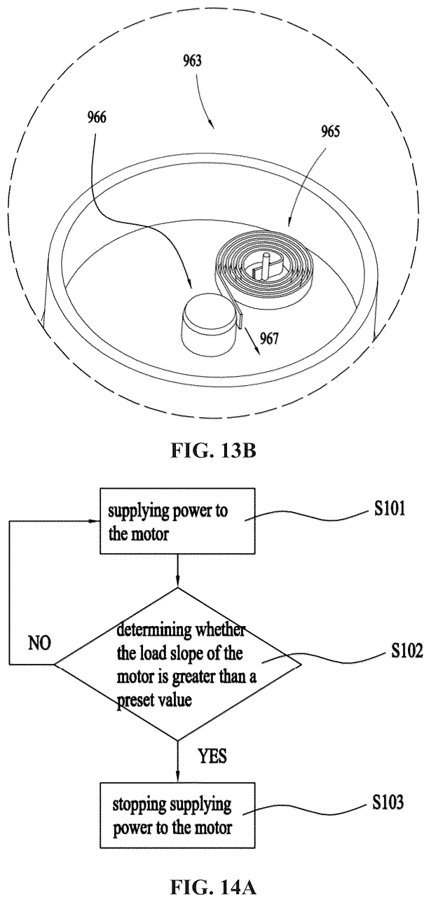

Referring to FIGS. 13A and 13B, a grass trimmer includes a trimming head 961, a motor 962 and an energy storing device 963.

The motor 962 is used to drive the trimming head 961 to rotate so as to cut vegetation. The trimming head 961 includes a spool and a head housing. The spool is accommodated in the head housing. The detail structure of the trimming head 961 can refer to the trimming head 410 in FIGS. 4A-4D.

The grass trimmer includes a housing 964 for accommodating the motor 962. Specifically, the motor 962 is an electric motor having a motor shaft 966 for outputting power.

The grass trimmer has the function of auto-winding. The spool can be rotated relative to the head housing so that the trimming line winds on the spool automatically. Thus, the function of auto-winding is realized. The energy storing device 963 is able to drive one of the spool and the head housing to rotate relative to the other so as to realize the function of auto-winding. The motor 962 rotates to make the energy storing device 963 store energy. Then, the user can control the energy storing device 963 to release energy so as to realize the function of auto-winding.

Specifically, the energy storing device 963 is disposed within the housing 964, which is mounted on the top of the motor 962. The energy storing device 963 includes an elastic element 965 which is a coil spring. The coil spring is coupled with the motor shaft 966 on an end. When the motor shaft 966 is rotated, it drives the end of the coil spring to move in a direction indicated by an arrow 967. And the other end of the coil spring is fixed. At this moment, the coil spring stores energy. When it is needed to realize the function of auto-winding, the coil spring retracts to drive the motor shaft 966 to rotate reversely. The motor shaft 966 is connected with the spool or the head housing, so one of the spool or the head housing is driven by the motor shaft 966 to rotate relative to the other. Thus, the function of auto-winding is realized.

A method for controlling the grass trimmer, in particular a method for controlling the grass trimmer to wind the trimming line based on the embodiments described above is illustrated as flowing.

As described before, the grass trimmer at least includes the spool, the line holding element and the motor. The spool is used to mount the trimming line. Specifically, the trimming line can be mounted on the spool in a winding method or other method such as storing. The main function of the line holding element is similar to the function of the fingers against the trimming line while winding the trimming line with hands. That is the line holding element produces a limiting effect to make the trimming line revolve (taking the spool as a reference) and allow the trimming line to pass the line holding element and wind on the spool. The motor can drive one of the spool and the line holding element, so that the line holding element simulates the relative motion pattern of the hand and the spool when mounting the trimming line manually. That is, the relative rotation is created between the spool and the line holding element.

In is noted that, the line holding element can be constituted by a housing for accommodating the spool. For example, the head housing can be acted as the line holding element.

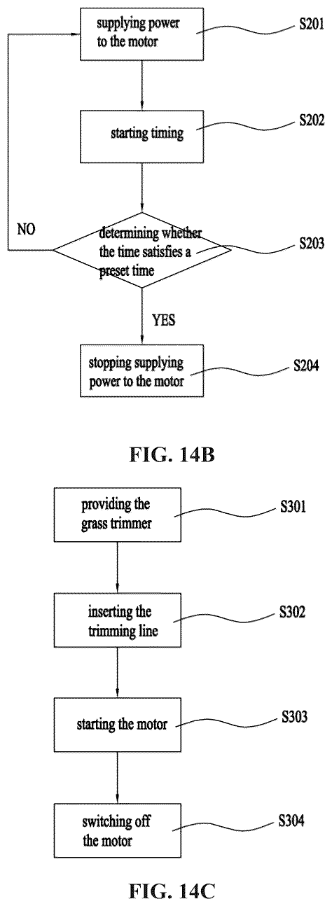

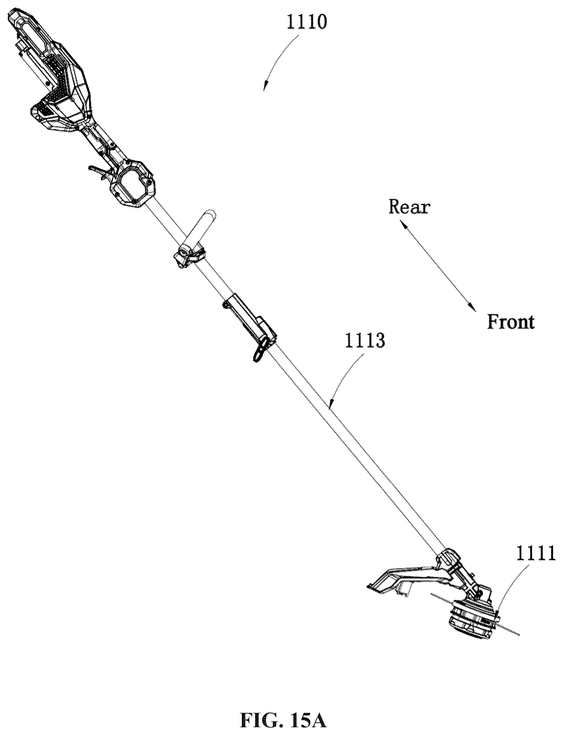

As shown in FIG. 14A, the control method includes: S101 supplying power to the motor so as to produce a relative rotation between the spool and the line holding element. More specifically, the control method supplies power to the motor when the grass trimmer is operated by the user. The power supplied to the motor can be electric energy.

Further, the grass trimmer includes a controller and an operating element. The controller is used to control whether to supply power to the motor. When the operating element is activated by the user, the grass trimmer is controlled by the controller to supply power to the motor. Alternatively, if the operating element is activated again, the grass trimmer is controlled by the controller to stop supplying power to the motor.

Further, the grass trimmer includes another operating element. When the operating element is activated again, the grass trimmer is controlled by the controller to stop supplying power to the motor. Alternatively, the two different operating elements are needed to be pressed to make the grass trimmer supply power to the motor.

Otherwise, the grass trimmer can be stopped from supplying power to the motor in an automatic method. The operating method includes: S101 supplying power to the motor, S102 determining whether the load slope of the motor is greater than a preset value, and S103 stopping supplying power to the motor. Specifically, the controller determines whether to stop supplying power to the motor according to the load slop of the motor (the slope in the present invention should be considered as including mathematic definition which indicates rising tendency such as the derivative). When the load slope of the motor is greater than the preset value, the grass trimmer is controlled automatically to stop supplying power to the motor. When the load slope of the motor isn't greater than the preset value, the grass trimmer is controlled to supply power to the motor continuously. The load state can be determined according to the speed or the speed slope of the motor. When the speed slope is less than a preset value, the controller stops supplying power to the motor.

When the motor is an electric motor, the current slope of the electric motor can be used to make a similar judgement control. Specifically, when the current slope of the electric motor is greater than a preset value, the controller stops supplying power to the motor.

As shown in FIG. 14B, alternatively, the control method can use a timing method. The control method includes: S201 supplying power to the motor, S202 starting timing, S203 determining whether the time satisfies a preset time, and S204 stopping supplying power to the motor. Specifically, when the grass trimmer is controlled by the controller to supply power to the motor, timing is started. When the time satisfies the preset time, the grass trimmer is controlled to stop supplying power to the motor. when the time does not satisfy the preset time, the grass trimmer is controlled to supply power to the motor continuously.

Otherwise, the motor can be provided with different power so that the spool and the line holding element can rotate at a first relative speed and a second relative speed respectively. The speed of the motor can be changed, so the relative rotation speed between the spool and the line holding element can be changed. However, when the grass trimmer supplies power to the motor to mount the trimming line, the relative rotation speed between the spool and the line holding element should be less than the rotation speed of the trimming line or the spool while the trimming line is cutting vegetation.

As shown in FIG. 14C, a method for operating the grass trimmer to wind the trimming line is illustrated as following. The method mainly includes the following steps:

S301 providing the grass trimmer.

In this step, the grass trimmer includes the spool for winding the trimming line, line holding element being formed with line holding structure allowing the trimming line to pass through and the motor being capable of driving one of the spool and the line holding element.

However, the grass trimmer in this step can be the grass trimmer in the foregoing examples. It is noted that the line holding element is detachable.

S302 inserting the trimming line.

In this step, the trimming line is associated with the line holding element and inserted in the spool. As for associating the trimming line with the line holding element, it is dependent on the specific form of the line holding element and the line holding structure, which can refer to the examples described above. Similarly, inserting in the spool can be understood as inserting in the holes or apertures formed on the spool or other structure which can limit the ends of the trimming line to hold the trimming line thereon. This step can make both the spool and the line holding structure act on the trimming line so as to get ready to mount the trimming line.

S303 starting the motor.

The user can start the motor through the operating element or an action activating the sensor disposed on the grass trimmer, so that the relative rotation is produced between the spool and the line holding element.

S303 switching off the motor.

The user can switch off the motor to make the spool and the line holding element be relatively static. However, the controller of the grass trimmer can be used to determine when to switch off the motor.

Alternatively, the operating element disposed on the grass trimmer can be triggered to start the motor, and the motor can be switched off by triggering the operating element once again or by triggering another operating element.

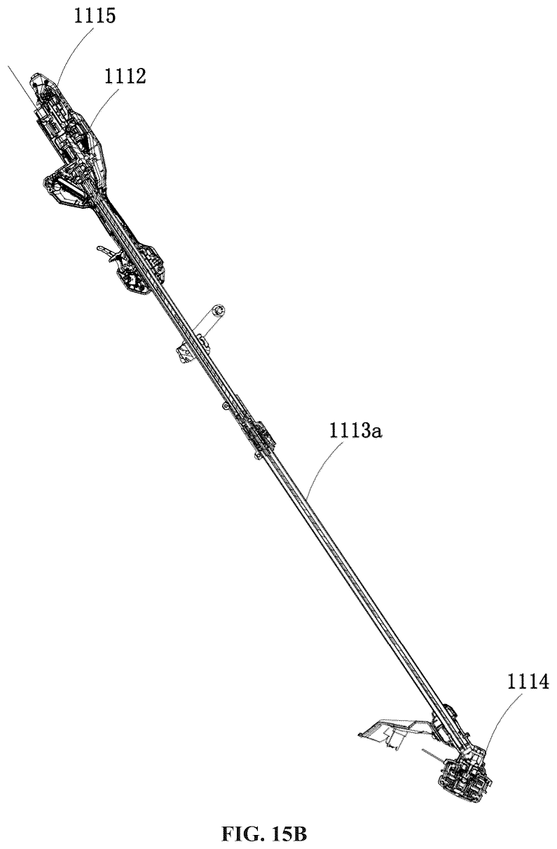

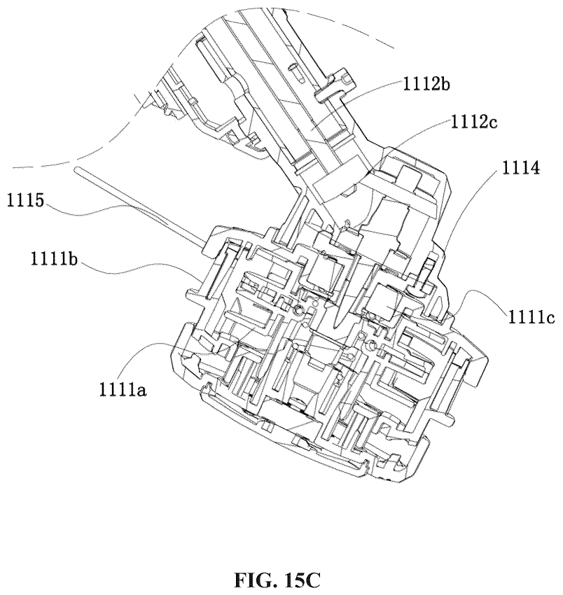

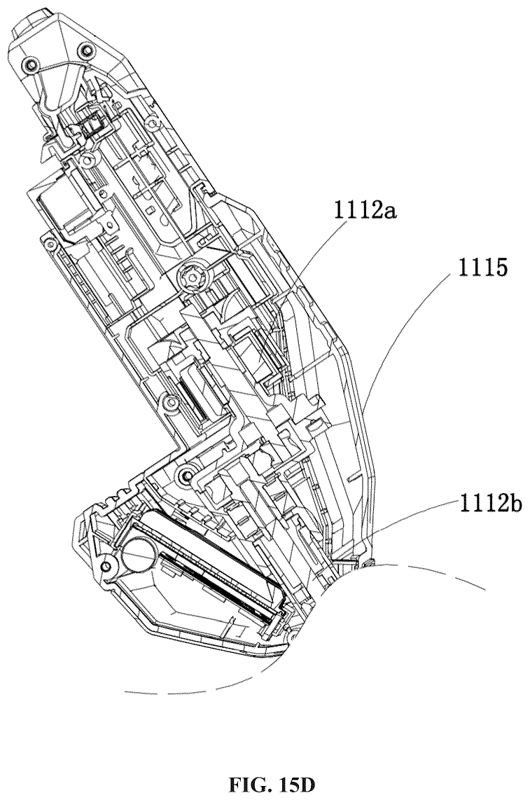

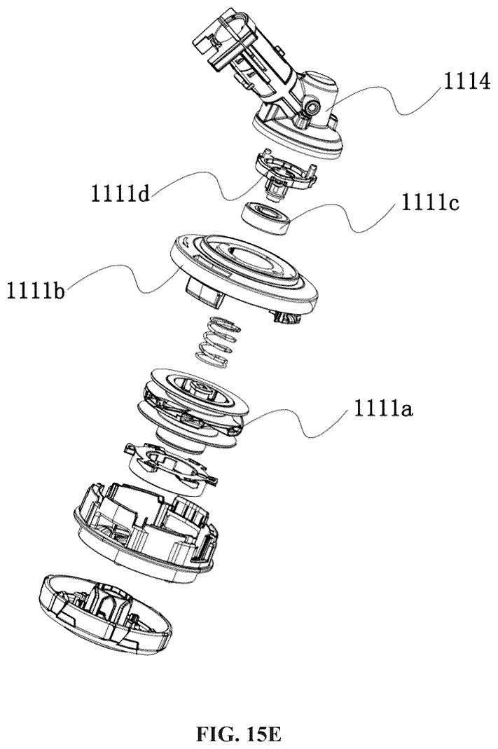

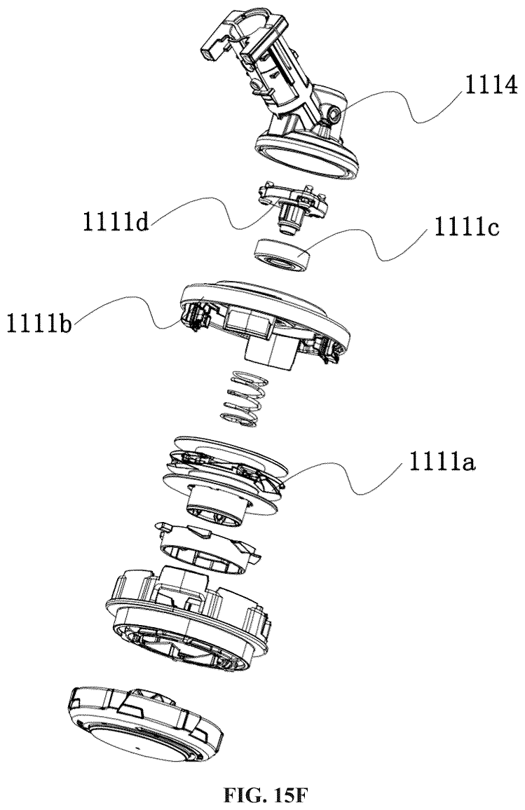

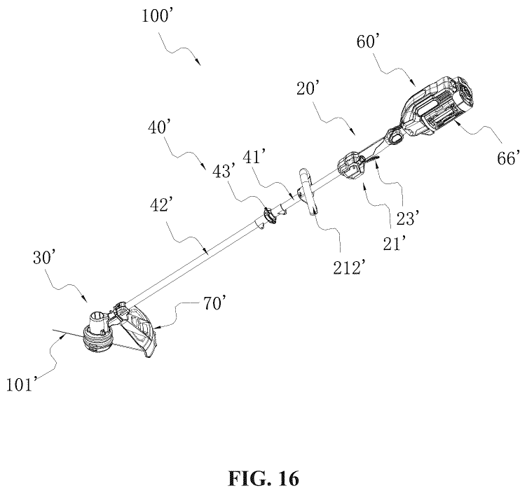

A grass trimmer 1110 of an example of FIGS. 15A and 15B includes a trimming head 1111, a driving device 1112 and a connecting rod assembly 1113. As shown in FIGS. 15A to 15F, the connecting rod assembly 1113 includes a connecting rod 1113a, the trimming head 1111 is disposed at a front end of the connecting rod 1113a, the driving device 1112 includes a motor 1112a, and the motor 1112a is an electric motor disposed at a rear end of the connecting rod 1113a. The grass trimmer 1110 includes a first housing 1114 and a second housing 1115. The first housing 1114 is disposed at the front end of the connecting rod 1113a, and the trimming head 1111 is connected to the first housing 1114. The second housing 1115 is disposed at the rear end of the connecting rod 1113a, the motor 1112a is mounted to the second housing 1115, at least part of the motor 1112a is disposed in the second housing 1115, and the second housing 1115 is also used for mounting a battery pack that supplies power to the motor 1112a. The driving device 1112 further includes a driving shaft 1112b and a transmission assembly 1112c. The driving shaft 1112b extends from the rear end of the connecting rod 1113a to the front end of the connecting rod 1113a. At least part of the transmission assembly 1112c is arranged in the first housing 1114 and is connected to the trimming head 1111 to drive the trimming head 1111. One end of the drive shaft 1112b is connected to the transmission assembly 1112c, and the other end is connected to the motor 1112a.

The trimming head 1111 includes substantially the same spool 1111a and head housing 1111b as the grass trimmer 500 in FIG. 5. The trimming head 1111 also includes a one-way bearing 1111c having substantially the same structure as that in FIG. 5. The inner ring of the one-way bearing 1111c is fixedly connected to the first housing 1114 through a connecting piece 1111d, and the outer ring of the one-way bearing 1111c is fixedly connected to the head housing 1111b.

The trimming head 1111 has a cutting mode and an auto-winding mode. When the trimming head 1111 is in the cutting mode, the motor 1112a drives the spool 1111a and the head housing 1111b to rotate synchronously through the drive shaft 1112b and the transmission assembly 1112c. When the trimming head 1111 is in the cutting mode, a trimming line 1115 is fixed relative to the trimming head 1111, or in other words, the spool 1111a is fixed relative to the head housing 1111b. When the trimming head 1111 is in the auto-winding mode, the motor 1112a drives the spool 1111a to rotate relative to the head housing 1111b through the drive shaft 1112b and the transmission assembly 1112c. When the trimming head 1111 is in the auto-winding mode, the spool 1111a rotates relative to the head housing 1111b. The direction of rotation of the spool 1111a in the auto-winding mode is opposite to the direction of rotation of the spool 1111a in the cutting mode. In the auto-winding mode, the head housing 1111b is fixed, and the one-way bearing 1111c prevents the head housing 1111b in the counterclockwise direction. In the cutting mode, the one-way bearing 1111c allows the head housing 1111b to rotate clockwise, and the head housing 1111b can rotate synchronously with the spool 1111a.

As shown in FIG. 16 to FIG. 18, a grass trimmer 100′ includes a motor 10′, an operation device 20′, a grass trimming mechanism 30′ and a connecting pipe 40′.

The operation device 20′ is used for user's operation to control the grass trimmer 100′. In one example, the operation device 20′ includes a handle 21′, a first switch 22′ and a first operation member 23′. The handle 21′ is used for being gripped by the user. The handle 21′ includes a handle housing 211′. The first switch 22′ is arranged inside the handle housing 211′. The handle housing 211′ includes a left handle housing 211a′ and a right handle housing 211b′. The first switch 22′ is located between the left handle housing 211a′ and the right handle housing 211b′. The connecting pipe 40′ is clamped by the left handle housing 211a′ and the right handle housing 211b′ from two sides of the connecting pipe 40′. In another example, the grass trimmer 100′ further includes an auxiliary handle 212′. The auxiliary handle 212′ is fixed to the connecting pipe 40′.

The first operation member 23′ is used for being operated by the user so as to control the first switch 22′, when the handle 21′ is gripped by the user. The first switch 22′ is electrically connected to the motor 10′ and configured to control the motor 10′. The first switch 22′ may activate the motor 10′ so that the grass trimmer 100′ realizes the cutting function. In another example, the first switch 22′ is further configured to control a rotating speed of the motor 10′. The first operation member 23′ is a trigger. The operation device 20′ further includes a locking member 24′ for preventing the first operation member 23′ from being accidentally activated. When the locking member 24′ is triggered, the first operation member 23′ can be operated by the user. The locking member 24′ is a trigger. The first operation member 23′ is rotatably connected to the handle housing 211′ about a first axis 103′. The locking member 24′ is rotatably connected to the handle housing 211′ about a second axis 104′. The first axis 103′ is perpendicular to the second axis 104′. The connecting pipe 40′ extends along a first straight line 105′. The first axis 103′ is perpendicular to the first straight line 105′. The second axis 104′ is perpendicular to the first straight line 105′. When the handle 21′ is gripped by the user, the locking member 24′ may be triggered by the thumb, and the first operation member 23′ is triggered by the index finger, so that the operation is convenient and comfortable.

As shown in FIG. 19 to FIG. 21, the grass trimming mechanism 30′ is used for realizing the tooling function. The grass trimming mechanism 30′ includes a grass trimming head 50′. The grass trimming head 50′ is used for accommodating the cutting line 101′. A portion of the cutting line 101′ protruding out of the grass trimming head 50′ is driven by the grass trimming head 50′ to rotate so as to cut the vegetation. The motor 10′ is configured to drive the grass trimming head 50′ to rotate. The grass trimming head 50′ includes a spool 53′ and a housing 52′. The spool 53′ is configured for being wound by the cutting line 101′. At least a portion of the spool 53′ is arranged within the housing 52′.

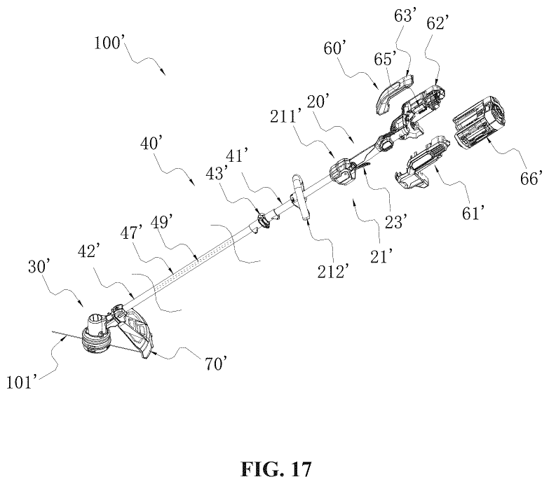

As shown in FIG. 16 to FIG. 17, the connecting pipe 40′ is connected to the operation device 20′ and the grass trimming mechanism 30′. The connecting pipe 40′ is connected to the grass trimming head 50′ and a handle 21′.

The grass trimmer 100′ has an auto-winding mode and a cutting mode.

When the grass trimmer 100′ is in the auto-winding mode, the spool 53′, the housing 52′ or the cutting line 101′ do not need to be manually rotated, and the cutting line 101′ can be automatically wound to the spool 53′. In one example, when the grass trimmer 100′ is in the auto-winding mode, the motor 10′ drives at least one of the spool 53′ and the housing 52′, so that the spool 53′ and the housing 52′ are relatively rotated to automatically wind the cutting line 101′ to the spool 53′.

When the grass trimmer 100′ is in the cutting mode, the motor 10′ drives the spool 53′ and the housing 52′ to synchronously rotate, and the cutting line 101′ and the spool 53′ remain relatively fixed, so that the motor 10′ drives the grass trimming head 50′ to rotate so as to drive the cutting line 101′ to rotate, achieving the cutting of the vegetation.

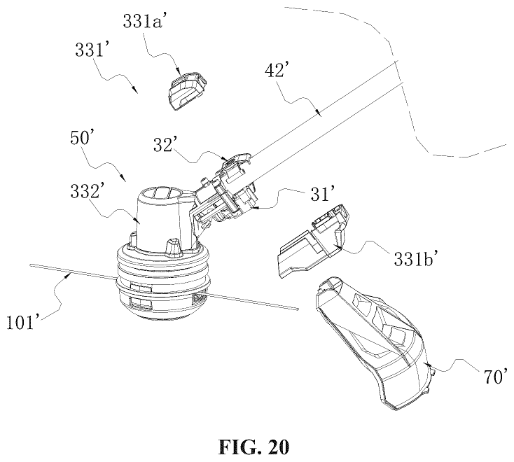

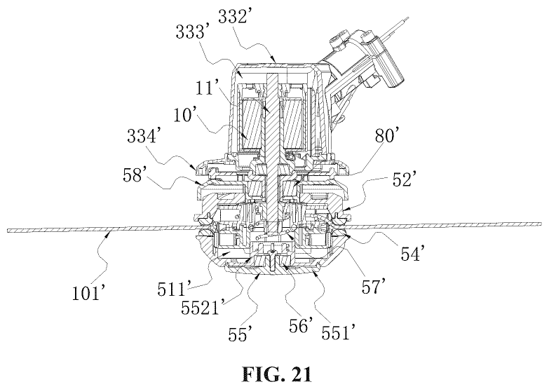

As shown in FIG. 20 and FIG. 21, the grass trimming mechanism 30′ further includes a second switch 31′ and a second operation member 32′. The second switch 31′ is electrically connected to the motor 10′. The second operation member 32′ is configured for being operated by the user to control the second switch 31′. The second switch 31′ is configured to control the motor 10′ so that the grass trimmer 100′ is in or enters the auto-winding mode. The motor 10′ drives at least one of the spool 53′ and the housing 52′ so that the spool 53′ and the housing 52′ are relatively rotated to automatically wind the cutting line 101′ to the spool 53′. The first switch 22′ is configured to control the motor 10′ so that the grass trimmer 100′ is in or enters the cutting mode. The motor 10′ drives the spool 53′ and the housing 52′ to synchronously rotate so as to drive the cutting line 101′ to rotate to cut the vegetation.

In one example, when the grass trimmer 100′ is in the auto-winding mode, a rotating speed of the spool 53′ is greater than or equal to 100 rpm, and less than or equal to 2000 rpm. In one example, the rotating speed of the spool 53′ is greater than or equal to 200 rpm, and less than or equal to 800 rpm. In another example, the rotating speed of the spool 53′ is greater than or equal to 30 rpm, and less than or equal to 600 rpm. Or the rotating speed of the spool 53′ is greater than or equal to 60 rpm, and less than or equal to 300 rpm. A ratio of a rotating speed of the spool 53′ in the cutting mode to a rotating speed of the spool 53′ in the auto-winding mode is greater than or equal to 5, and less than or equal to 300. In another example, the ratio of the rotating speed of the spool 53′ in the cutting mode to the rotating speed of the spool 53′ in the auto-winding mode is greater than or equal to 10, and less than or equal to 200.

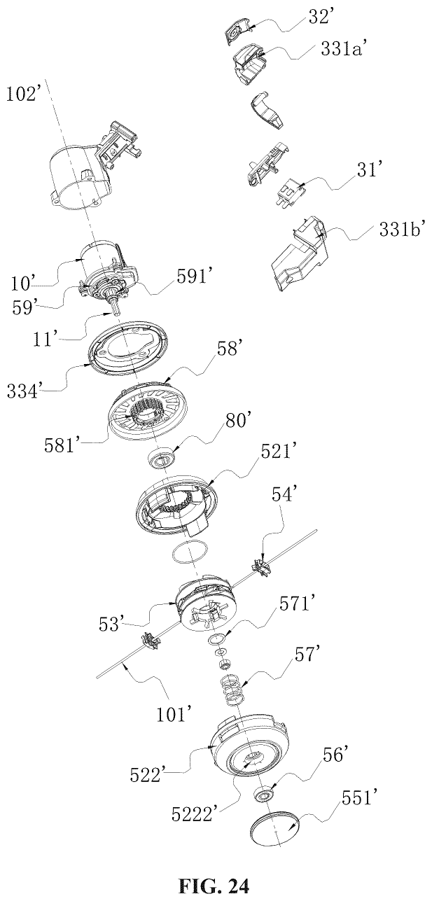

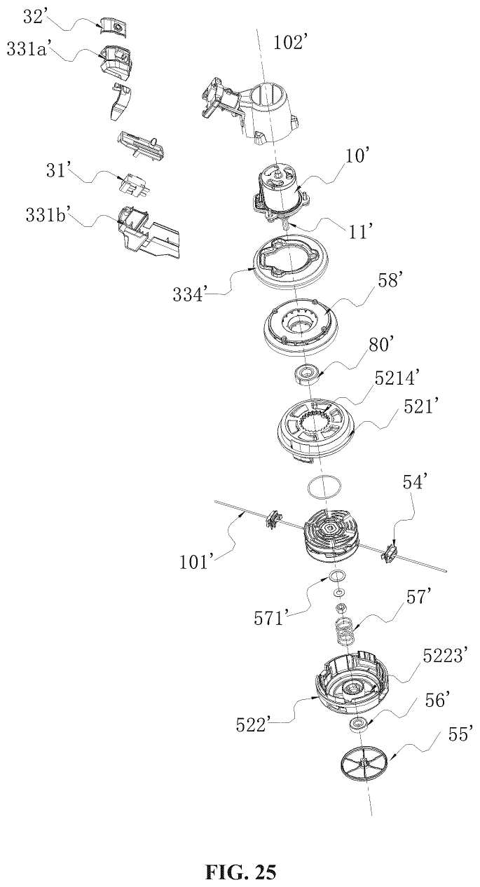

As shown in FIG. 19, FIG. 20, FIG. 24 and FIG. 25, the grass trimming mechanism 30′ further includes a working housing 33′. The working housing 33′ is configured for connecting each component of the grass trimming mechanism 30′ to be a whole. In one example, the working housing 33′ includes a switch housing 331′ and a motor housing 332′. The switch housing 331′ and the motor housing 332′ may be a whole or may be two separate detachable components. In one example, the switch housing 331′ is configured to fix and accommodate the second switch 31′. The motor housing 332′ is configured to accommodate or mount the motor 10′. The switch housing 331′ is fixed to the motor housing 332′. The working housing 33′ is connected to one end of the connecting pipe 40′. In one example, the motor housing 332′ is fixed to the one end of the connecting pipe 40′, and the switch housing 331′ is connected to the one end of the connecting pipe 40′. The connecting pipe 40′ is arranged throughout the switch housing 331′. The switch housing 331′ includes a first switch housing 331a′ and a second switch housing 331b′. The first switch housing 331a′ and the second switch housing 331b′ are arranged on two sides of the connecting pipe 40′. The motor 10′ and grass trimming head 50′ are arranged on a same end of the connecting pipe 40′. The motor is located inside the working housing 33′.

In another example, the motor is arranged on one end of the connecting pipe facing away from the grass trimming head, that is, the motor is not located inside the working housing.

A shield 70′ plays a role of safety protection, and prevents the cutting line 101′ from causing damages to the user. In one example, the shield 70′ is fixed to the working housing 33′. In one example, the shield 70′ is fixed to the motor housing 332′. At least a portion of the switch housing 331′ is located between the motor housing 332′ and the shield 70′. In one example, the shield is fixed to the connecting pipe.

The second operation member 32′ is adjacent to the grass trimming head 50′. After the cutting line 101′ and the spool 53′ are combined, the second operation member 32′ may be directly operated by the user to activate the automatic winding function. The first operation member 23′ is arranged away from the grass trimming head 50′. When the user grips the handle 21′ to perform the cutting operation, the user can be away from the grass trimming head 50′ to avoid the occurrence of the damages. The first operation member 23′ and the second operation member 32′ are away from each other. The first operation member 23′ and the second operation 32′ are arranged on two ends of the connecting pipe 40′, so that the user is unable to touch the second operation member 32′ when operating the first operation member 23′, and the user is also unable to touch the first operation member 23′ when operating the second operation member 32′, which effectively avoids the damages caused by the housing where one operation member is accidentally touched when another operation member is operated by the user.

The second operation member 32′ and the second switch 31′ are located on two sides of the connecting pipe 40′. In one example, the second switch 31′ is arranged below the connecting pipe 40′, and the second operation member 32′ is arranged above the connecting pipe 40′. The grass trimming head 50′ and the second operation member 32′ are located on the two sides of the connecting pipe 40′. The second operation member 32′ is located above the connecting pipe 40′ and away from the grass trimming head 50′ to prevent the cutting line 101′ from causing damages to the human body when the second operation member 32′ is operated by the user. An angled area is formed by the motor housing 332′ and the connecting pipe 40′. In other words, the angled area is formed by the grass trimming head 50′ and the connecting pipe 40′. The second switch 31′ is located within the angled area. The angled area realizes the protection on the second switch 21′ and prevents the second switch 31′ from touching the ground to cause damages. The manner that the second operation member 32′ and the second switch 31′ are located on the two sides of the connecting pipe 40′ also avoids the problem of excessive volume caused by the second operation member 32′ and the second switch 31′ being located on the same side of the connecting pipe 40′.

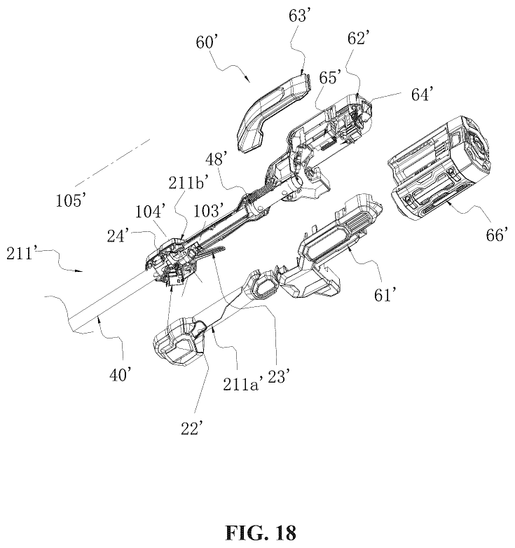

As shown in FIG. 17 and FIG. 18, the grass trimmer 100′ further includes a circuit board 65′, a first housing 60′ and a battery pack 66′. The circuit board 65′ is electrically connected to the first switch 22′, and electrically connected to the second switch 31′. The circuit board 65′ is accommodated by the first housing 60′. The circuit board 65′ is electrically connected to the motor 10′ and the battery pack 66′ so that the battery pack 66′ supplies power to the motor 10′ and controls the motor 10′.

The first housing 60′ is formed with a first chamber 64′ for accommodating the circuit board 65′. The motor housing 332′ is formed with a second chamber 333′ for accommodating the motor 10′. The connecting pipe 40′ has a hollow tubular structure. The connecting pipe 40′ is formed with an airflow passage 47′ for communicating the first chamber 64′ with the second chamber 333′. Cooling airflow can pass through the airflow passage 47′ to communicate the first chamber 64′ with the second chamber 333′ so as to cool the motor 10′ and the circuit board 65′.

The grass trimmer 100′ includes a guide wire 49′. The guide wire 49′ is electrically connected to the battery pack 66′ and the motor 10′. The guide wire 49′ is located inside the connecting pipe 40′.

In one example, the first housing and the handle housing may be a whole. When the first housing and the handle housing is a whole, it should be understood that the whole may be described to be the first housing or may be described to be the handle housing.

The battery pack 66′ may be detachably connected to the first housing 60′. The first housing 60′ is fixed to another end of the connecting pipe 40′. In one example, the first housing 60′ and the motor housing 332′ are respectively fixed to the two ends of the connecting pipe 40′.

In one example, the grass trimmer includes a cable wire. The cable wire is connected to the battery pack or commercial power.

In one example, the grass trimmer may be not provided with the operation member. That is, the grass trimmer does not include one or both of the first operation member and the second operation member. The grass trimmer is controlled by adopting a non-contact switch.

In one example, the grass trimmer is not provided with the second operation member and the second switch. The grass trimmer includes the non-contact switch. In other words, the second switch is a non-contact switch. The non-contact switch is configured to activate the motor 10′ to drive at least one of the spool 53′ and the housing 52′ so that the spool 53′ and the housing 52′ are relatively rotated to automatically wind the cutting line 101′ to the spool 53′.

In one example, the non-contact switch is a voice-activated switch. In one example, the non-contact switch is a light-activated switch. In one example, the non-contact switch is an infrared sensor switch. In one example, the non-contact switch is magnetic switch. In one example, the non-contact switch is a proximity switch.

The grass trimmer 100′ further includes a remote controller. The remote controller is configured for the remote control to control the on/off of the non-contact switch. The user may adopt a mobile device, such as a mobile phone, to control the grass trimmer 100′.

In one example, the grass trimming head 50′ and the non-contact switch are located on the same end of the connecting pipe 40′.

In one example, the grass trimming head 50′ and the non-contact switch are located on the two ends of the connecting pipe 40′.

In one example, the non-contact switch is located inside the first housing 60′.

In one example, the non-contact switch and the first switch 22′ are located inside the handle housing 211′.

In one example, the non-contact switch is located inside the connecting pipe 40′.

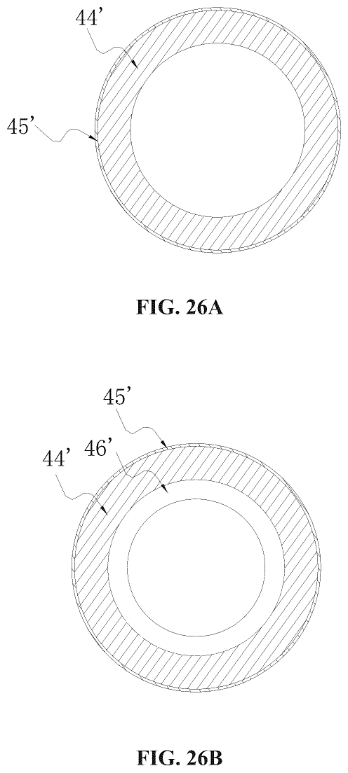

As shown in FIG. 16 and FIG. 26A, the connecting pipe 40′ includes an inner layer member 44′ made of a fiber material and an outer layer member 45′ made of a fiber material. The outer layer member 45′ is wrapped around an outer periphery of the inner layer member 44′. A thickness of the inner layer member 44′ is greater than a thickness of the outer layer member 45′.

In one example, a fiber arrangement direction of the inner layer member 44′ is different from a fiber arrangement direction of the outer layer member 45′.

The inner layer member 44′ is rolled from multi-layered fiber material sheets arranged layer by layer. The fiber arrangement direction of the inner layer member 44′ extends along a straight line. The fiber arrangement direction of the inner layer member 44′ coincides with an extending direction of the connecting pipe 40′. Fibers of the outer layer member 45′ are arranged in cross.

The inner layer member 44′ has a relatively high strength. The outer layer member 45′ enhances the stability of combining the multi-layered fiber material sheets. The connecting pipe 40′ has a relatively high strength, reliability and stability.

A wall thickness of the connecting pipe 40′ is greater than or equal to 0.5 mm, less than or equal to 1.5 mm.

In one example, a density of the motor housing 332′ is greater than a density of the handle housing 211′. The density of the handle housing 211′ is greater than a density of the inner layer member 44′.

In one example, the inner layer member 44′ is made of a carbon fiber material. The outer layer member 45′ is made of a carbon fiber material. The handle housing 211′ is made of a plastic material. The motor housing 332′ is made of a metal material.

The connecting pipe 40′ may be formed as a complete long pipe, or be formed by connecting a plurality of long pipes. In one example, the connecting pipe 40′ is formed by connecting the first connecting pipe 41′ and the second connecting pipe 42′. The first connecting pipe 41′ and the second connecting pipe 42′ are connected by a connecting seat 43′ to facilitate the storage and transportation.

As shown in FIG. 18, the grass trimmer 100′ further includes a fixing clamp 48′. The fixing clamp 48′ is formed by bending a metal sheet. The fixing clamp 48′ is sleeved on an outer periphery of the connecting pipe 40′. The connecting pipe 40′ is fixed to the first housing 60′ by the fixing clamp 48′. The first housing 60′ includes a first housing 61′ and a second housing 62′. The connecting pipe 40′ is located between the first housing 61′ and the second housing 62′. The first housing 60′ further includes an arm support member 63′ for supporting the user's arm. The arm support member 63′ is located on an upper portion of the first housing 60′.

A ratio of a circumference of the connecting pipe 40′ to a size of the fixing clamp 48′ in the extending direction of the connecting pipe 40′ is greater than or equal to 6, and less than or equal to 16.

In one example, as shown in FIG. 26B, the connecting pipe 40′ further includes an embedded member 46′. The inner layer member 44′ is sleeved on an outer periphery of the embedded member 46′. A material of the embedded member 46′ is different from a material of the inner layer member 44′. The embedded member 46′ is made of plastic or a metal material.

In one example, the inner layer member is a tubular body formed by the fiber material being surrounded or stacked.

As shown in FIG. 21, the grass trimming head 50′ is configured to mount and accommodate the cutting line 101′. One portion of the cutting line 101′ is accommodated inside the grass trimming head 50′, and another portion of the cutting line 101′ protrudes out of the grass trimming head 50′ to cut the vegetation when the grass trimming head 50′ is rotated. The motor 10′ drives the grass trimming head 50′ to rotate about a central axis 102′ so as to drive the cutting line 101′ to rotate to cut the vegetation. In one example, the motor may be replaced by an internal combustion engine.

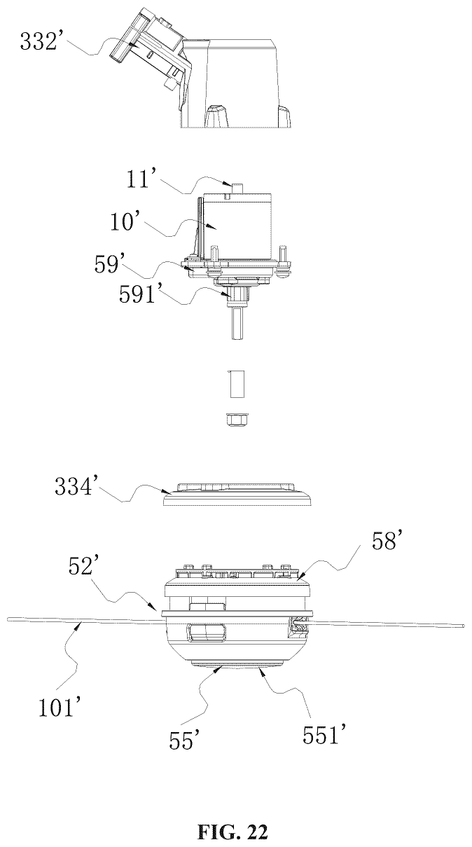

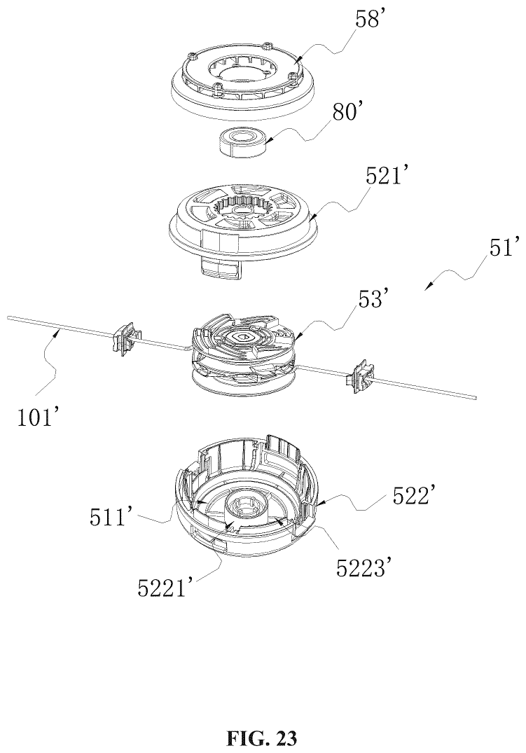

As shown in FIG. 22 and FIG. 23, the grass trimming head 50′ includes the spool 53′ and the housing 52′. The motor 10′ includes a motor shaft 11′. The motor shaft 11′ is connected to the spool 53′ to drive the spool 53′ to rotate. The housing 52′ includes an upper housing 521′ and a lower housing 522′. The grass trimming head 50′ further includes a fan 58′. The fan 58′ is provided with a blade for generating airflow. The motor 10′ is configured to drive the fan 58′ to rotate to generate the airflow.

The grass trimmer 100′ includes a damping device 80′. In one example, the damping device 80′ includes a one-way bearing 81′. The one-way bearing 81′ is configured to enable the housing 52′ being in a one-way rotational connection to the motor 10′. In one example, the one-way bearing 81′ is configured to allow the housing 52′ to rotate in only one direction with respect to the motor 10′ or the motor housing 332′. That is, the one-way bearing 81′ prevents the housing 52′ from rotating in another direction with respect to the motor 10′ or the motor housing 332′.

As shown in FIG. 21 to FIG. 25, the grass trimmer 100′ is provided with a support member 59′. The support member 59′ is fixed to motor 10′ and enables the motor shaft 11′ to pass therethrough. The support member 59′ is formed with a boss portion 591′ to support an inner ring of the one-way bearing 81′. The inner ring of the one-way bearing 81′ is sleeved on an outer periphery of the boss portion 591′ and fixed to the support member 59′.

The one-way bearing 81′ is connected to the housing 52′. In one example, the one-way bearing 81′ is connected to the housing 52′ through an intermediate piece. The intermediate piece is configured to be a fan 58′. The one-way bearing 81′ is arranged between the support member 59′ and the fan 58′ instead of being directly connected to the housing 52′, so that the fan 58′ is rotated in only one direction with respect to the support member 59′. The fan 58′ is in a non-rotational connection to the housing 52′, thus the housing 52′ is rotated in only one direction with respect to the support member 59′. The fan 58′ is in a synchronous rotation with the housing 52′, that is, the fan 58′ and the housing 52′ are non-rotatable with respect to each other.

In one example, the upper housing 521′ is formed with a first connecting tooth 5214′. The fan 58′ is formed with a second connecting tooth 581′ connected to the first connecting tooth 5214′. The first connecting tooth 5214′ and the second connecting tooth 581′ are matched to realize a synchronous rotation of the first connecting tooth 5214′ and the second connecting tooth 581′. And the first connecting tooth 5214′ and the second connecting tooth 581′ are matched with respect to each other to play a role of guiding, so that the housing 52′ is slidable with respect to the fan 58′ along the central axis 102′, and the fan 58′ is rotatable along with the housing 52′ about the central axis 102′.

In one example, the one-way bearing is fixed to the housing.

In one example, the housing is formed with the blade for generating the airflow, that is, no separate fan is provided, in other words, the fan and the housing is arranged to be a whole.

In the cutting mode, the motor shaft 11′ is rotated to drive the spool 53′ to rotate, and the spool 53′ drives the upper housing 521′ to rotate. In one example, the spool 53′ is formed with a first engaging tooth 536′. The upper housing 521′ is formed with a first matching tooth 5211′. The first engaging tooth 536′ is matched with the first matching tooth 5211′, so that the spool 53′ drives the upper housing 521′ to rotate.

The upper housing 521′ drives the fan 58′ to rotate. Under the action of the one-way bearing 81′, the fan 58′ is rotatable with respect to the motor housing 332′ along a first direction (referring to a direction shown by an arrow 106′ in FIG. 19). At this time, the motor 10′ is rotated in a forward direction to drive the spool 53′ and the housing 52′ to rotate along the first direction, realizing the motor 10′ driving the grass trimming head 50′ to rotate along the first direction. The motor 10′ drives the spool 53′ and the housing 52′ to synchronously rotate.

When the cutting line 101′ needs to be replenished by the user, the cutting line 101′ may pass through an outer aperture 544′ on one side to enter into a housing cavity 511′, and pass through an inner aperture 5351′ to pass through a line guide passage 5352′, and then pass out from the housing 52′ through an outer aperture 544′ on another side. When the cutting line 101′ needs to be wound to the spool, the user does not need to open the housing, namely, disassembly the upper housing and the lower housing. The cutting line may be directly inserted into the housing, and then be wound to be spool through the relative rotation of the spool and the housing. Such grass trimming head is usually referred to as an externally inserted winding grass trimming head.

The grass trimmer 100′ is controlled by the user to execute the auto-winding mode. The motor 10′ is reversely rotated to drive the spool 53′ to rotate along a second direction opposite to the first direction. Since the non-rotational effect of the one-way bearing 81′, the fan 58′ cannot be rotated along the second direction. The fan 58′ is connected to the housing 52′ through the first connecting tooth 5214′ and the second connecting tooth 581′, that is, the housing 52′ is non-rotatable along the second direction. The spool 53′ is, driven by the motor shaft 11′, rotated with respect to the housing 52′ along the second direction to realize the automatic winding.

The first matching tooth 5211′ or a second matching tooth 5223′ is a ratchet, so that the spool 53′ and the housing 52′ is rotatable with respect to each other in the auto-winding mode, and the spool 53′ can drive the housing 52′ to rotate in the cutting mode.

The grass trimmer 100′ further includes a fan cover 334′ fixed to the motor housing 332′. The fan cover 334′ covers the blade of the fan 58′ at least in a radial direction of the central axis 102′ to prevent the grass clippings from being wound around the fan 58′. And the fan cover 334′ is configured to change an airflow flowing direction of the fan 58′, so that the airflow generated by the fan 58′ blows the grass clippings outwards and downwards along the radial direction of the central axis 102′.

The motor shaft 11′ directly drives the spool 53′ to rotate. The housing 52′ is rotatable with respect to the spool 53′, and is slidable with respect to the spool 53′ along the central axis 102′. The housing 52′ is slidable with respect to the spool 53′ between a first axial position and a second axial position.

When the housing 52′ is in the first axial position with respect to the spool 53′, the first matching tooth 5211′ is matched with the first engaging tooth 536′, so that the spool 53′ drives the motor 52′ to synchronously rotate when the spool 53′ is rotated.

The grass trimmer 100′ has a feeding mode. The feeding mode is configured to enable a portion of the cutting line 101′ being wound around the spool 53′ to be released to increase a length of the cutting line 101′ passing out from the grass trimming head 50′. When the grass trimmer 100′ is in the cutting mode, the user knocks the grass trimming head 50′, so that the housing 52′ is moved to the second axial position from the first axial position, and the spool 53′ is rotatable with respect to the housing 52′ to release a portion of the cutting line 101′.

In one example, the spool 53′ is formed with the first engaging tooth 536′ and a second engaging tooth 537′. The housing 52′ is formed with the first matching tooth 5211′ matched with the first engaging tooth 536′ and the second matching tooth 5223′ matched with the second engaging tooth 537′. A plurality of first matching teeth 5211′ are arranged along a circumferential direction of the central axis 102′. A plurality of first engaging teeth 536′ are arranged along the circumferential direction of the central axis 102′. In one example, the engaging tooth 536′ is arranged on an upper portion of the spool 53′, and the second engaging tooth 537′ is arranged on a lower portion of the spool 53′. The first matching tooth 5211′ is formed on the upper housing 521′, and the second matching tooth 5223′ is formed on the lower housing 522′.

When the housing 52′ is moved to the second axial position, the first matching tooth 5211′ is unengaged with the first engaging tooth 536′, so that the spool 53′ and the housing 52′ is rotatable with respect to each other. At this time, the second engaging tooth 537′ and the second matching tooth 5223′ are matched so that the housing 52′ is rotated by a specific angle with respect to the spool 53′ so as to release a specific length of cutting line 101′.

The grass trimming head 50′ further includes a spring 57′. The spring 57′ is configured to apply an acting force between the upper housing 522′ and the spool 53′ so that the housing 52′ is moved to the first axial position in which the housing 52′ is synchronously rotated with the spool 53′. In one example, the spring 57′ is a compression spring. When the housing 52′ is not subject to an external force generated by the user knocking the ground, the spring 57′ applies the acting force to the housing 52′ to make the housing 52′ back to the first axial position. The spool 53′ is formed with a groove 5344′. The spring 57′ is arranged inside the groove 5344′. The lower housing 522′ is provided with a protrusion portion 5221′ protruding towards the upper housing 521′. The protrusion portion 5221′ and the groove 5344′ are matched to guide the housing 52′ to move with respect to the spool 53′ between the first axial position and the second axial position. The spring 57′ is arranged between the protrusion portion 5221′ and the spool 53′. One end of the spring 57′ is in contact with the protrusion portion 5221′, and another end of the spring 57′ is provided with a first contact member 571′. The first contact member 571′ reduces wear between the spool 53′ and the spring 57′. The first contact member 571′ is a metal member. The spool 53′ and the housing 52′ are plastic members.

In one example, the spring may not be in direct contact with the housing. In one example, the contact member is arranged between the spring and the housing. The contact member is in direct contact with the spring.

In one example, the first engaging tooth is arranged on the lower portion of the spool, the first matching tooth is formed on the lower housing. The spring applies the acting force to the spool or the housing assembly so that the first matching tooth and the first engaging tooth are in contact.

The spool 53′ is provided with the inner aperture 5351′ for the cutting line 101′ to be inserted into, and the inner aperture 5351′ is capable of fixing the cutting line 101′.

The grass trimming head 50′ includes a housing assembly 51′. The housing assembly 51′ is formed with the housing cavity 511′ and the outer aperture 544′. The cutting line 101′ may be inserted into the housing cavity 511′ from the outside of the housing assembly 51′. At least a portion of the spool 53′ is arranged inside the housing cavity 511′. The spool 53′ is rotatable with respect to the housing assembly 51′ about the central axis 102′.

In one example, the housing assembly 51′ includes the housing 52′ and an eyelet member 54′. The housing 52′ is formed with the housing cavity 511′. The eyelet member 54′ is formed with an outer aperture 544′. The eyelet member 54′ is fixed to the housing 52′. The eyelet member 54′ is made of a metal material. The housing 52′ is made of a plastic material. The eyelet member 54′ may prevent the cutting line 101′ form wearing a hole wall of the outer aperture 544′.

In one example, the housing assembly includes the housing, and the housing assembly does not include the eyelet member. The housing is formed with the outer aperture. In one example, the housing includes the upper housing and the lower housing, in other words, the housing assembly includes the upper housing and the lower housing.

The inner aperture 5351′ and the outer aperture 544′ may be automatically aligned, so that it is convenient for the user to insert the cutting line 101′ into the housing cavity 511′ through the outer aperture 544′ and insert the cutting line 101′ into the inner aperture 5351′. In other words, the cutting line 101′ passing through the outer aperture 544′ may be directly inserted into the inner aperture 5351′.

The housing assembly 51′ is formed with a first positioning surface 5212′. The spool 53′ is formed with a second positioning surface 5362′ matched with the first positioning surface 5212′. When the first positioning surface 5212′ is in contact with the second positioning surface 5362′, the inner aperture 5351′ is aligned with the outer aperture 544′.

The grass trimming head 50′ further includes a driving member. The driving member is configured to apply an acting force to the housing assembly 51′ or the spool 53′, and the acting force causes the housing assembly 51′ and the spool 53′ to rotate with respect to each other so that the first positioning surface 5212′ and the second positioning surface 5362′ are in contact.

In one example, the spring 57′ is the driving member. The spring 57′ is arranged between the housing assembly 51′ and the spool 53′. The spring 57′ applies an acting force to the spool 53′ or the housing assembly 51′, and the acting force causes the first positioning surface 5212′ and the second positioning surface 5362′ to go towards each other.

The first matching tooth 5211′ or the first engaging tooth 536′ has an inclined surface inclined to a normal surface of the central axis 102′. An angle between the inclined surface and the normal surface of the central axis 102′ is greater than or equal to 8 degrees, and less than or equal to 18 degrees. By arranging the inclined surface, the first matching tooth 5211′ and the second matching tooth 5223′ enables the spool 53′ and the housing 52′ to relatively rotate under the driving by the acting force of the spring 57′.

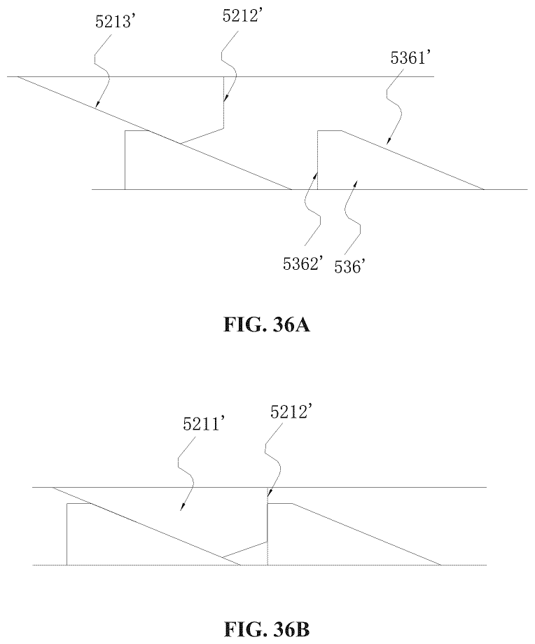

As shown in FIG. 36A and FIG. 36B, in one example, the first matching tooth 5211′ is formed with a first inclined surface 5213′ and the first positioning surface 5212′. The first engaging tooth 536′ is formed with a second inclined surface 5361′ and the second positioning surface 5362′.

The first inclined surface 5213′ and the first positioning surface 5212′ are located on two sides of the first matching tooth 5211′. The second inclined surface 5361′ and the second positioning surface 5362′ are located on two sides of the first engaging tooth 536′.

When the first positioning surface 5212′ is in contact with the second positioning surface 5362′, the two sides of the first matching tooth 5211′ are in contact with two adjacent first engaging teeth 536′ respectively.

When the first positioning surface 5212′ is in contact with the second positioning surface 5362′, the first inclined surface 5213′ is in contact with the second inclined surface 5361′.

The spool 53′ is formed with a plurality of inner apertures 5351′. An even number of the inner apertures 5351′ are provided. An even number of first engaging teeth 536′ are provided. The plurality of inner apertures 5351′ are evenly distributed in a circumferential direction of an axis of the spool 53′. In one example, a number of the first engaging teeth 536′ is the same as a number of the inner apertures 5351′.

In one example, a number of the second engaging teeth 537′ is the same as a number of the inner apertures 5351′. For example, the spool 53′ is formed with six inner apertures 5351′, and the spool 53′ is formed with six first engaging teeth 536′ and six second engaging teeth 537′.

The spool 53′ is formed with at least one winding portion 531′ for the cutting line 101′ winding and two flange portions 532′ arranged on two ends of the winding portion 531′. The inner aperture 5351′ is arranged on the two flange portions 532′.

In one example, the spool 53′ includes two winding portions 531′ and three flange portions 532′.

The spool 53′ includes an upper winding portion 5331′, a lower winding portion 5341′, a middle flange portion 535′, an upper flange portion and a lower flange portion. The upper winding portion 5331′ is configured for winding the cutting line 101′ and the lower winding portion 5341′ is configured for winding the cutting line 101′. The upper flange portion, the lower flange portion and the middle flange portion 535′ are configured to limit a position of the cutting line 101′. The upper flange portion is connected to an upper end of the upper winding portion 5331′. The lower flange portion is connected to a lower end of the lower winding portion 5341′. The middle flange portion 535′ is located between the upper winding portion 5331′ and the lower winding portion 5341′. In one example, the middle flange portion 535′ is formed with the inner aperture 5351′ for the cutting line 101′ to be inserted into.

The spool 53′ includes a first part and a second part. The first part and the second part are referred to as an upper spool 533′ and a lower spool 534′ respectively. The lower spool 534′ is coupled to the upper spool 533′ to form a whole. The upper spool 533′ includes the upper winding portion 5331′, a first flange portion 5332′ and a second flange portion 5333′. The lower spool 534′ includes the lower winding portion 5341′, a third flange portion 5342′ and a fourth flange portion 5343′. The first flange portion 5332′ is connected to the upper end of the upper winding portion 5331′. The second flange portion 5333′ is connected to a lower end of the upper winding portion 5331′. The third flange portion 5342′ is connected to an upper end of the lower winding portion 5341′. The fourth flange portion 5343′ is connected to the lower end of the lower winding portion 5341′. The first flange portion 5332′ is the upper flange portion, and the fourth flange portion 5343′ is the lower flange portion. The second flange portion 5333′ and the third flange portion 5343′ cooperatively form the middle flange portion 535′.

The upper spool 533′ is coupled to the lower spool 534′ to form the line guide passage 5352′ for cutting line 101′ passing through the spool 53′. Two ends of the line guide passage 5352′ are defined as the inner apertures 5351′. The cutting line 101′ may be inserted into the line guide passage 5352′ through the inner aperture 5351′.

The line guide passage 5352′ extends along a curve.

The upper spool 533′ is coupled to the lower spool 534′ to form two line guide passages 5352′ intersected with each other. In one example, the upper spool 533′ is coupled to the lower spool 534′ to form three line guide passages, any two of which are intersected with each other. The three line guide passages 5352′ is arranged around the central axis 102′.

The line guide passage 5352′ is formed by the upper spool 533′ and the lower spool 534′, which is beneficial for the processing and manufacturing of the line guide passage 5352′. The spool 53′ is arranged between the upper housing 521′ and the lower housing 522′. The spool 53′ is formed with the groove 5344′. In one example, the lower spool 534′ is formed with the groove 5344′. The lower housing 522′ is provided with the protrusion portion 5221′ protruding towards the upper housing 521′. The protrusion portion 5221′ and the groove 5344′ are matched to guide the housing 52′ to move with respect to the spool 53′ along the central axis 102′. At least a portion of the spring 57′ is located inside the groove 5344′. The spring 57′ is arranged throughout the groove 5344′ and between the upper spool 533′ and the lower housing 522′. The spring 57′ applies an acting force so that the upper spool 533′ and the lower housing 522′ are moved away from each other. In other words, the spring 57′ applies an acting force so that the upper housing 521′ and the upper spool 533′ are moved closer to each other.

The upper spool 533′ is fixed to the motor shaft 11′. The motor 10′ drives the upper spool 533′ to rotate.

The housing assembly 51′ is provided with the protrusion portion 5221′ protruding towards the housing cavity 511′. A minimum distance from the protrusion portion 5221′ to the inner aperture 5351′ is greater than or equal to 3 mm.

The hole wall of the outer aperture 544′ protrudes towards the housing cavity 511′ to form the protrusion portion 5221′. In one example, the outer aperture 544′ is provided with two protrusion portions 5221′. The two protrusion portions 5221′ are located on two sides of the outer aperture 544′ and arranged along the circumferential direction of the central axis 102′. That is, the two protrusion portions 5221′ are located on left and right sides of the outer aperture 544′ instead of upper and lower sides.

In one example, the eyelet member 54′ is formed with the outer aperture 544′. A distance from the eyelet member 54′ to the spool 53′ is less than 3 mm. A distance from the eyelet member 54′ to the flange portion 532′ is less than or equal to 3 mm. In one example, a distance from the eyelet member 54′ to the middle flange portion 535′ is less than or equal to 3 mm.

An end portion of the cutting line 101′ being inserted into the housing cavity 511′ through the outer aperture 544′ is less likely to be deviated and can be smoothly inserted into the inner aperture 5351′.

At least portion of the eyelet member 54′ protrudes towards the spool 53′. The eyelet member 54′ is formed with two bumps 542′ protruding towards the spool 53′. The two bumps 542′ are arranged on two sides of an observation hole and arranged along the circumferential direction of the central axis 102′.

The two bumps 542′ are located between an upper surface and a lower surface of the middle flange portion 535′. A size of each bump 542′ along a direction of the central axis 102′ is less than a size of the middle flange portion 535′ along the direction of the central axis 102′.

The outer aperture 544′ is a waist-shaped hole. A size of the outer aperture 544′ along the direction of the central axis 102′ is defined as a height of the outer aperture 544′. A size of the outer aperture 544′ along a direction perpendicular to the central axis 102′ is defined as a width of the outer aperture 544′. A size of the outer aperture 544′ in an extending direction is defined as a depth of the outer aperture 544′.

A distance between the two bumps 542′ is the same as the width of the outer aperture 544′. The width of the outer aperture 544′ is greater than the height of the outer aperture 544′.

The eyelet member 54′ is formed with a notch 543′ on one side of a projection of the eyelet member 54′ on a plane perpendicular to the central axis 102′ facing towards the spool 53′. The eyelet member 54′ is U-shaped.

The eyelet member 54′ includes a body 541′ and the two bumps 542′. The body 541′ is formed with the outer aperture 544′. The two bumps 542′ extend outward from the body 541′. The two bumps 542′ extend outward from a same side of the body 541′.

The distance from the eyelet member 54′ to the flange portion 532′ is less than a maximum outer diameter of the cutting line 101′.

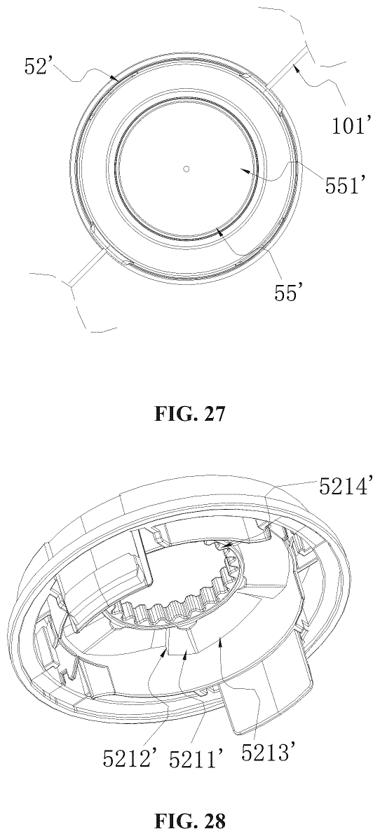

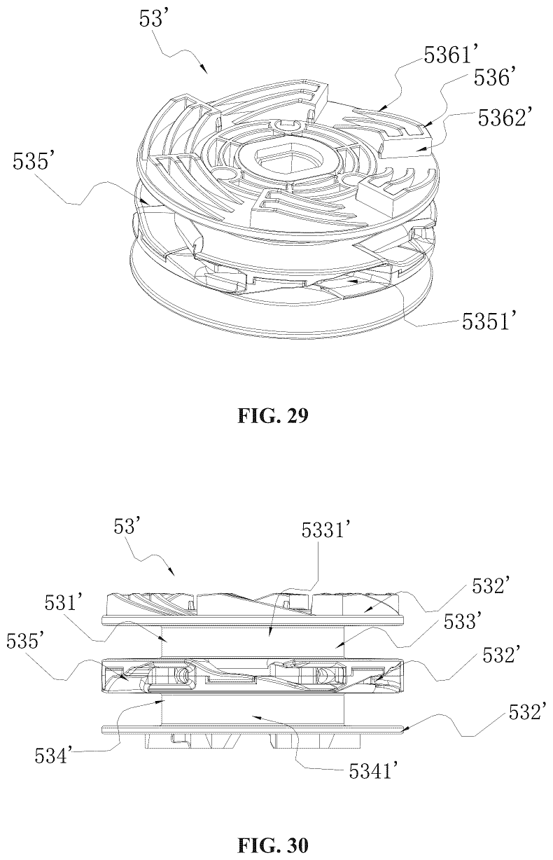

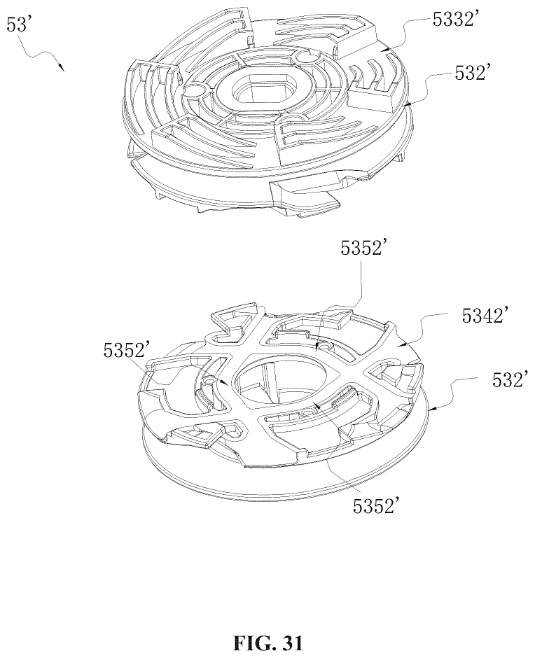

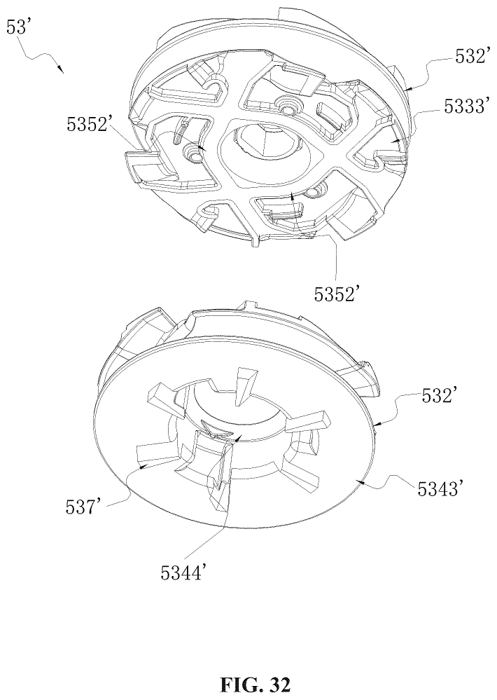

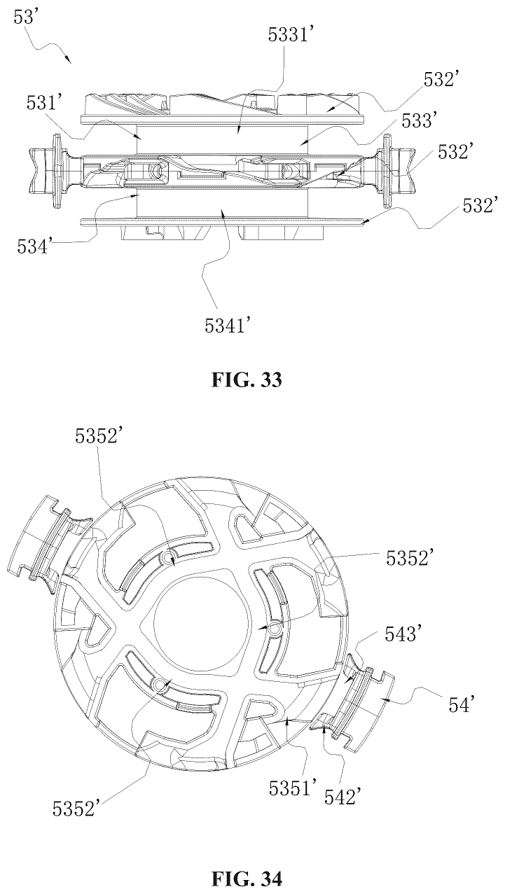

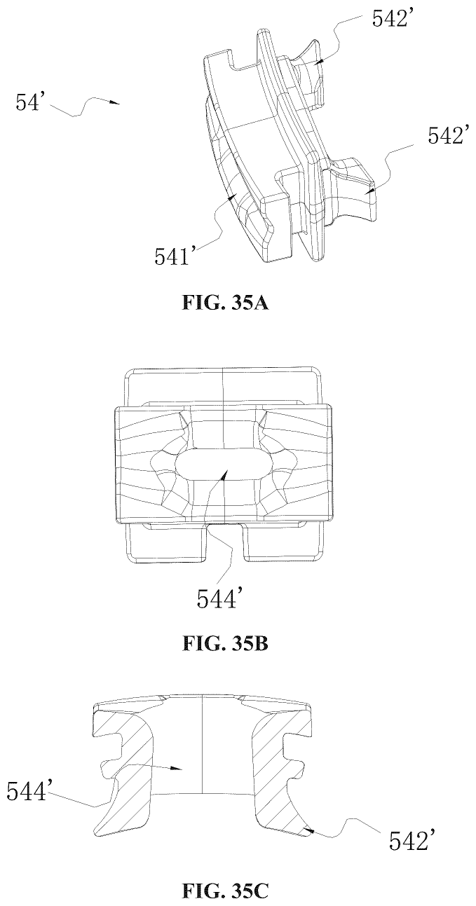

As shown in FIG. 21, FIG. 22 and FIG. 27, the grass trimming head 50′ further includes a knocking cap 55′. The knocking cap 55′ is rotatably connected to the lower housing 522′ so that the knocking cap 55′ and the lower housing 522′ are rotatable with respect to each other. At the same time, the knocking cap 55′ is synchronously moved with the lower housing 522′ in a direction of the axis. In other words, when a position of the knocking cap 55′ is changed, the lower housing 522′ is moved along with the knocking cap 55′, namely, the housing 52′ will change the axial position by knocking the knocking cap 55′.

The knocking cap 55′ includes a contact portion 551′ protruding out of an outer surface of the housing 52′.

A ratio of a projection area of the contact portion 551′ on the plane perpendicular to the central axis 102′ to a projection area of the housing 52′ on the plane perpendicular to the central axis 102′ is greater than or equal to 0.3, and less than or equal to 1.

A surface of the contact portion 551′ is a smooth curved surface. A projection of the contact portion 551′ on the plane perpendicular to the central axis 102′ has a circular shape.

A ratio of the projection area of the contact portion 551′ on the plane perpendicular to the central axis 102′ to a projection area of the spool 53′ on the plane perpendicular to the central axis 102′ is greater than or equal to 0.5, and less than or equal to 1.2.

A ratio of a maximum size of the contact portion 55′ in the radial direction of the central axis 102′ to a maximum size of the spool 53′ in the radial direction of the central axis 102′ is greater than or equal to 0.7, and less than or equal to 1.1.

An area of the contact portion 551′ is relatively large, so that grass trimming head 50′ is ensured to be in contact with the ground before the housing 52′ is in contact with the ground when the grass trimming head 50′ is obliquely knocked by the user, which effectively avoids the wear of the housing 52′.

A bearing 56′ is arranged between the knocking cap 55′ and the lower housing 522′ and connected to the knocking cap 55′ and the lower 522′. The lower housing 522′ is formed with a mounting groove 5222′. In one example, the protrusion portion 5221′ is formed with the mounting groove 5222′. The bearing 56′ is arranged inside the mounting groove 5222′. The bearing 56′ is connected to the knocking cap 55′ and the lower housing 522′.

Under the action of the bearing 56′, the knocking cap 55′ is freely rotatable with respect to the lower housing 522′, reducing the wear of the grass trimming head 50′. The spring 57′ applies the acting force to the housing 52′ so that the housing 52′ is moved downward with respect to the spool 53′. A shock absorbing member for slowing the impact between the lower housing 521′ and the spool 53′ is arranged between the lower housing 521′ and the spool 53′. In one example, the shock absorbing member is a rubber gasket.

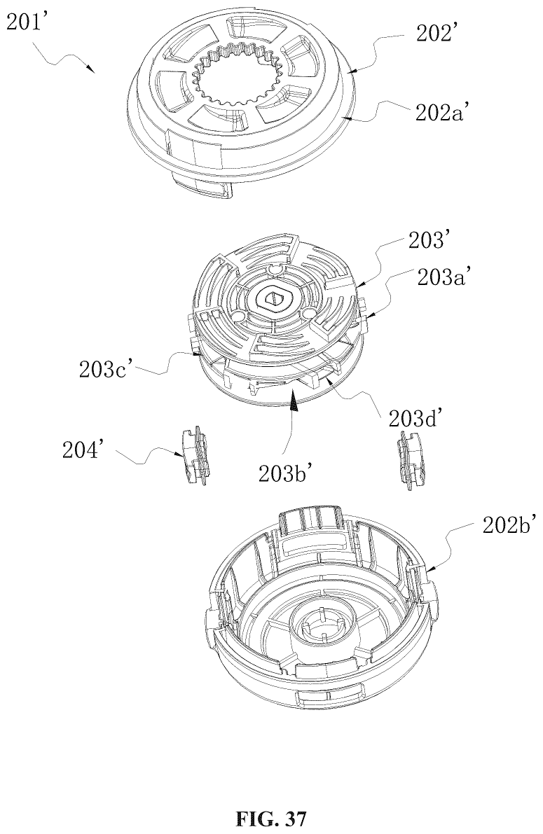

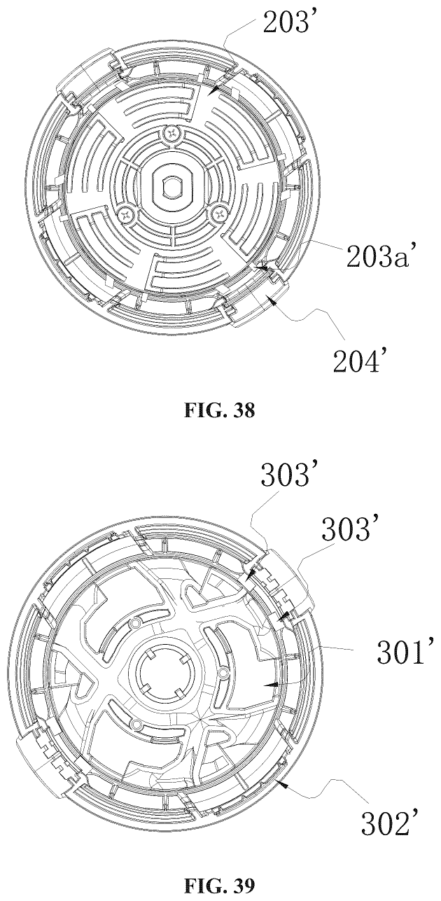

As shown in FIG. 37 and FIG. 38, a grass trimming head 201′ includes a spool 203′ and a housing assembly. The housing assembly is formed with a housing cavity and an outer aperture. The cutting line can be inserted into the housing cavity from the outside of the housing assembly. At least a portion of the spool 203′ is arranged inside the housing cavity. The spool 203′ is rotatable with respect to the housing assembly about the central axis.

In one example, the housing assembly includes a housing 202′ and an eyelet member 204′. The housing 202′ is formed with the housing cavity. The eyelet member 204′ is formed with the outer aperture and fixed to the housing 202′. The housing 202′ includes an upper housing 202a′ and a lower housing 202b′.

A structure of the housing 202′ in FIG. 37 is the same as a structure of the housing 52′ in FIG. 16 to FIG. 27. The differences between the grass trimming head 201′ in FIG. 37 and the grass trimming head 50′ in FIG. 16 to FIG. 27 are that the spool 203′ and the eyelet member 204′ are different from the spool 53′ and the eyelet member 54′ in FIG. 16 to FIG. 27.

In one example, the spool 203′ is formed with a bump 203a′ towards the housing 202′. The eyelet member 204′ is not provided with a bump. In one example, the spool 203′ includes a winding portion 203b′ and a flange portion 203c′. An inner aperture 203d′ is arranged on the flange portion 203c′. The bump 203a′ is arranged on the flange portion 203c′. Two bumps 203a′ are provided and located on two sides of the inner aperture 203d′. The two bumps are arranged to guide the end portion of the cutting line entering the housing cavity, which is beneficial for the cutting line being directly inserted into the inner aperture 203d′.

A minimum distance from the bump 203a′ to the outer aperture is less than or equal to 3 mm. A minimum distance from the bump 203a′ to the eyelet member 204′ is less than or equal to 3 mm. The minimum distance from the bump 203a′ to the outer aperture is less than or equal to a maximum outer diameter of the cutting line. The maximum outer diameter of the cutting line is a maximum size of a cross section of the cutting line perpendicular to an extending direction of the cutting line.

In one example, a difference between a grass trimming head in FIG. 39 and the grass trimming head 50′ in FIG. 16 to FIG. 27 is that a bump 303′ is formed by a housing 302′ instead of the eyelet member. A spool 301′ and the spool 53′ are the same in structure.

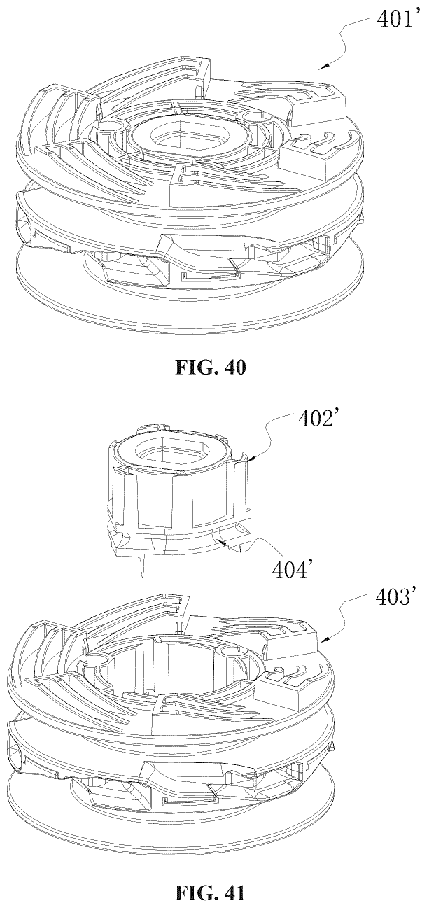

As shown in FIG. 40 and FIG. 41, a spool 401′ includes two winding portions and three flange portions. In one example, the spool 401′ includes an upper winding portion, a lower winding portion, a middle flange portion, an upper flange portion and a lower flange portion. The upper winding portion and the lower winding portion are configured for the cutting line winding around. The upper flange portion, the lower flange portion, and the middle flange portion are configured to limit a position of the cutting line. The upper flange portion is connected to an upper end of the upper winding portion. The lower flange portion is connected to a lower end of the lower winding portion. The middle flange portion is located between the upper winding portion and the lower winding portion. In one example, the middle flange portion is formed with an inner aperture for the cutting line to be inserted into. A whole structure of the spool 401′ shown in FIG. 40 and FIG. 41 is the same as the whole structure of the spool 53′ shown in FIG. 16 to FIG. 27, and a different therebetween is that structures of the pieces combined into the spool 401′ are different.

In one example, the spool 401′ includes a first piece 403′ and a second piece 402′. The first piece 403′ and the second piece 402′ are combined into the spool 401′. The first piece 403′ is formed with a winding portion and a flange portion. In one example, the first piece 403′ is formed with an upper winding portion, a lower winding portion, a middle flange portion, an upper flange portion and a lower flange portion.

The spool 401′ is formed with at least two line guide passages 404′ intersected with each other. In one example, the spool 401′ is formed with three line guide passages 404′. The first piece 403′ and the second piece 402′ are combined to form the line guide passages 404′. Two ends of the line guide passages 404′ are defined as inner apertures. In one example, an intersection portion of the two line guide passages 404′ intersected with each other is formed by the combination of the first piece 403′ and the second piece 402′. The first piece 403′ is arranged around the second piece 402′, and arranged on an outer periphery of the second piece 402′.

The spool 401′ is constructed in a manner that the spool can be constructed and machine shaped by a simple mold, which is simple and quick in manufacture.

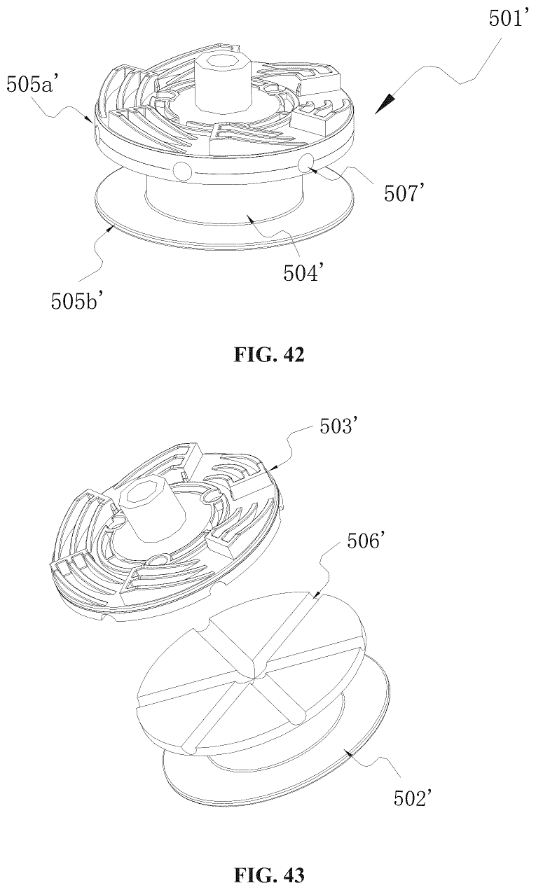

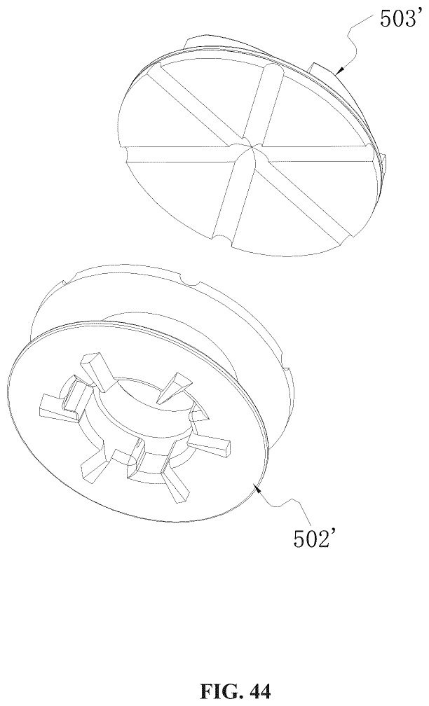

As shown in FIG. 42 to FIG. 44, a spool 501′ is formed with at least one winding portion 504′ for the cutting line winding around and two flange portions 505a′ and 505b′ arranged on two ends of the winding portion 504′. An inner aperture 507′ is arranged on the flange portions 505a′ and 505b′.

In one example, the spool 501′ is formed with one winding portion 504′. An upper flange portion 505a′ and a lower flange portion 505b′ are located on the two ends of the winding portion 504′ respectively. The inner aperture 507′ is arranged on the upper flange portion 505a′ and the lower flange portion 505b′.

The spool 501′ includes a first piece 502′ and a second piece 503′. The first piece 502′ and the second piece 503′ are combined to form the spool 501′. The first piece 502′ is formed with a winding portion 504′. The first piece 502′ and the second piece 503′ together form an upper flange portion 505a′ and a lower flange portion 505b′. The first piece 502′ and the second piece 503′ are arranged along a rotational axis of the spool 501′. The second piece 503′ is located above the first piece 502′.

The first piece 502′ and the second piece 503′ are formed with the line guide passage 506′. In one example, the first piece 502′ and the second piece 503′ are combined to form at least two line guide passages 506′ intersected with each other. In one example, the first piece 502′ and the second piece 503′ are combined to form three line guide passages 506′, any two of which are intersected with each other. Two ends of the line guide passages 506′ are defined as inner apertures 507′.

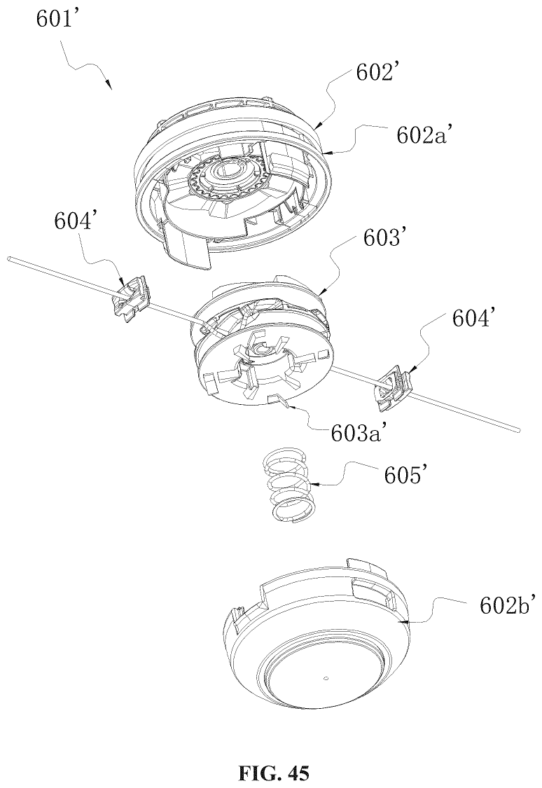

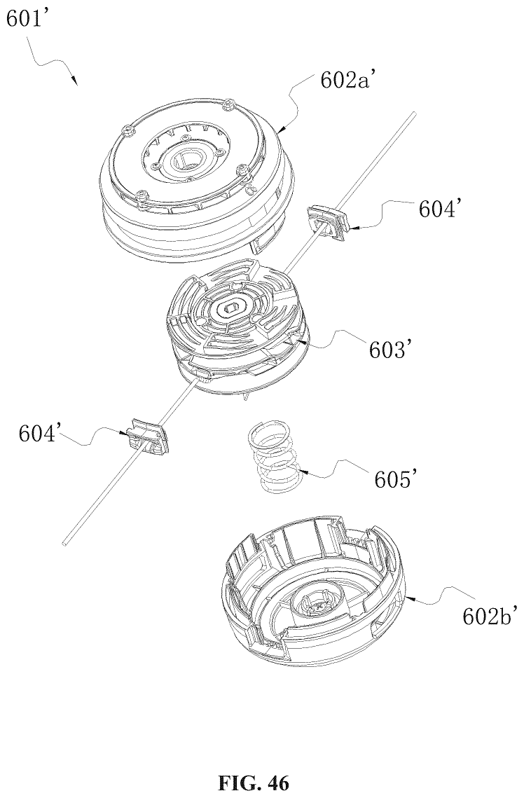

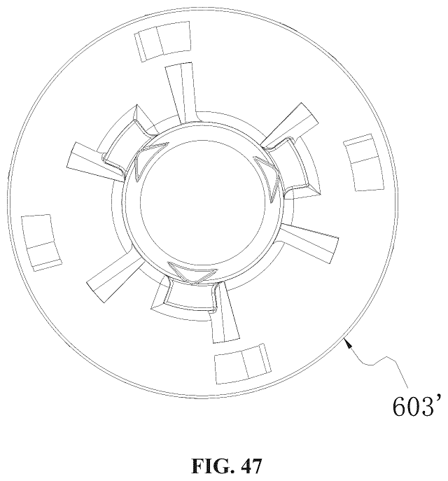

As shown in FIG. 45 to FIG. 47, a grass trimming head 601′ includes a spool 603′ and a housing assembly. The housing assembly is formed with a housing cavity and provided with an outer aperture for cutting line passing through the housing cavity from the outside of the housing assembly. The housing assembly includes a housing 602′ and an eyelet member 604′. The housing 602′ is formed with a housing cavity. At least a portion of the spool 603′ is located inside the housing cavity. The housing 602′ includes an upper housing 602a′ and the lower housing 602b′. The eyelet member 604′ is formed with an outer aperture. A spring 605′ is arranged between the lower housing 602b′ and the spool 603′.

Structures of the spool 603′ and the housing assembly in FIG. 45 to FIG. 47 are the same as the structures of the spool 53′ and the housing assembly in FIG. 16 to FIG. 27. A difference between the grass trimming head 601′ in FIG. 45 to FIG. 47 and the grass trimming head 50′ in FIG. 16 to FIG. 27 is that the grass trimming head 601′ further includes an elastic member 603a′. The elastic member 603a′ is a driving member. In one example, the elastic member 603a′ is an elastic tab. The elastic member 603a′ is fixed to a bottom portion of the spool 603′ and connected to the spool 603′ and the housing assembly. One end of the elastic member 603a′ is in contact with the lower housing 602b′. The elastic member 603a′ applies an acting force to the lower housing 602b′, and the acting force causes the lower housing 602b′ to rotate with respect to the spool 603′ so that a first positioning surface and a second positioning surface go towards each other. In on example, when the elastic member 603a′ is compressed, the elastic member 603 generates at least one component force causing the lower housing 602b′ to rotate with respect to the spool 603′, thereby driving the housing assembly to rotate with respect to the spool 603′. When the first positioning surface is in contact with the second positioning surface, the spool 603′ prevents the housing assembly from rotating. The elastic member 603 drives the housing 602′ to rotate with respect to the spool 603′, and the outer aperture is aligned with the inner aperture when the first positioning surface is in contact with the second positioning surface. The automatic alignment of the outer aperture and the inner aperture is convenient for the user. The user can conveniently insert the cutting line into the inner aperture through the outer aperture.

In one example, a torsion spring may be used as the driving member. The torsion spring is in contact with the spool and the housing to apply an acting force to the housing, and the acting force causes the housing to rotate with respect to the spool.

In one example, the driving member drives the spool to rotate with respect to the housing assembly. The driving member applies an acting force to the spool, and the acting force causes the spool to rotate with respect to the housing assembly.

In one example, the driving member drives the spool and the housing assembly to rotate. The driving member applies an acting force to the spool and the housing assembly, and the acting force causes the first positioning surface and the second positioning surface to go towards each other.

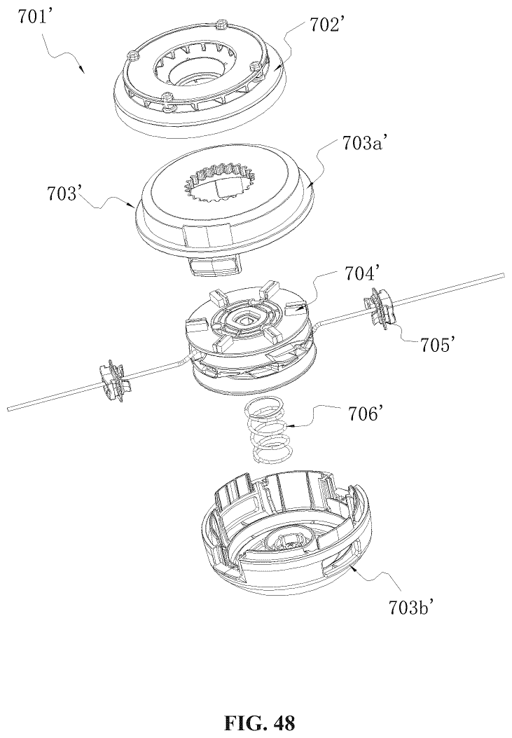

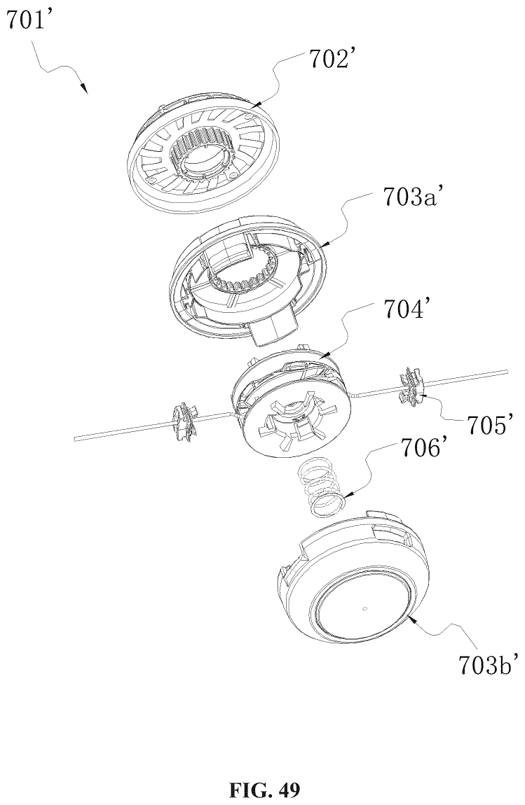

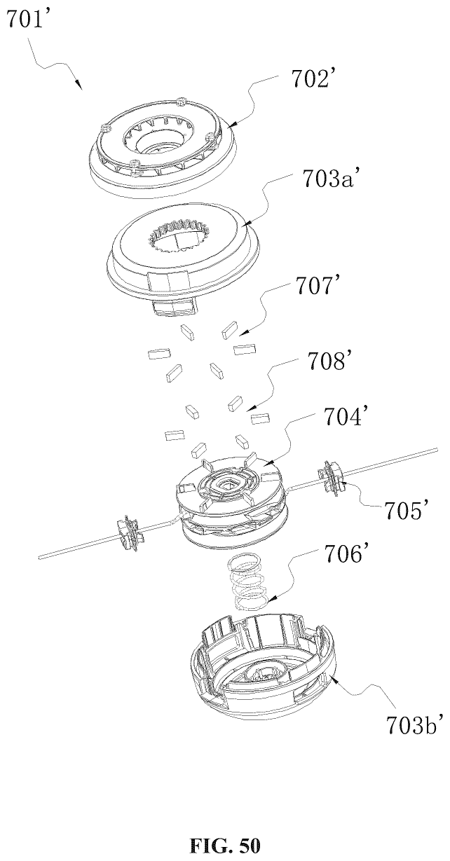

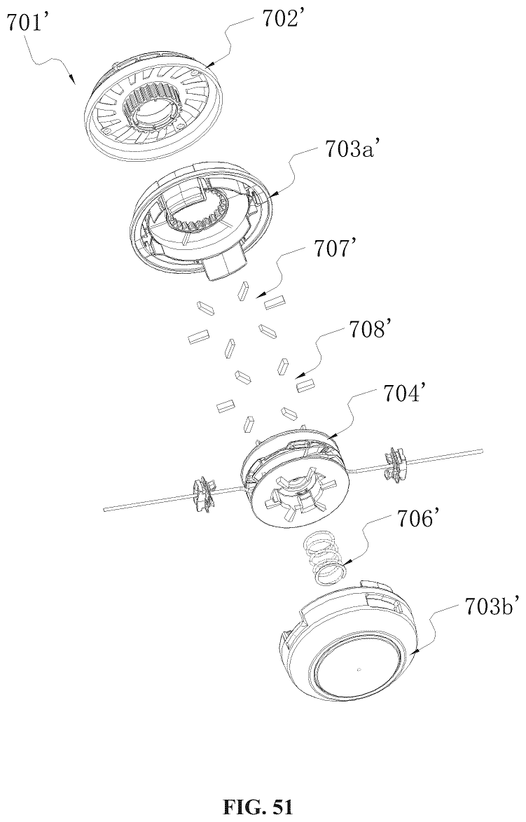

As shown in FIG. 48 to FIG. 51, a grass trimming head 701′ includes a housing assembly. The housing assembly is formed with a housing cavity and an outer aperture. The cutting line can be inserted into the housing cavity from the outside of the housing assembly. At least a portion of a spool 704′ is arranged inside the housing cavity. The spool 704′ is rotatable with respect to the housing assembly about a central axis. The spool 704′ is provided with an inner aperture for the cutting line to be inserted into. The inner aperture is configured to fix the cutting line.

In one example, the housing assembly includes a housing 703′ and an eyelet member 705′. The housing 703′ is formed with the housing cavity. The housing 703′ includes an upper housing 703a′ and a lower housing 703b′. The eyelet member 705′ is formed with an outer aperture and fixed to the housing 703′. The housing assembly is formed with a first positioning surface. The spool 704′ is formed with a second positioning surface matched with the first positioning surface. When the first positioning surface is in contact with the second positioning surface, the inner aperture is aligned with an outer aperture.

The grass trimming head 701′ further includes a fan 703′. The fan 703′ is synchronously rotated with the housing 703′. The fan 702′ in FIG. 48 to FIG. 51 is the same as the fan 58′ in FIG. 16 to FIG. 27.

The grass trimming head 701′ further includes a magnetic member. The magnetic member is used as the driving member. The magnetic member applies an acting force to the housing assembly or the spool 704′, and the acting force causes the first positioning surface and the second positioning surface to go towards each other. The magnetic member applies an acting force to the housing assembly or the spool 704′, and the acting force causes the housing assembly and the spool 704′ to rotate with respect to each other so that the first positioning surface is in contact with the second positioning surface.

In one example, a first magnetic member 707′ is fixed to the housing 703′, and a second magnetic member 708′ is fixed to the spool 704′. A magnetic direction of the second magnetic member 708′ is opposite to a magnetic direction of the first magnetic member 707′. The first magnetic member 707′ and the second magnetic member 708′ repel each other to generate an acting force causing the spool 704′ and the housing 703′ to rotate with respect to each other.

In one example, the housing 703′ is formed with a first matching tooth 703c′. One end of the first matching tooth 703c′ is provided with a first positioning surface. The first magnetic member 707′ is fixed to one end of the first matching tooth 703c′ facing away from the first positioning surface.

The spool 704′ is formed with a first engaging tooth 704a′. One end of the first engaging tooth 704a′ is provided with a second positioning surface. The second magnetic member 708′ is fixed to one end of the first engaging tooth 704a′ facing away from the second positioning surface. A structure of the first matching tooth 703c′ of the housing assembly in FIG. 48 to FIG. 51 is different from the structure the first matching tooth 5211′ of the housing assembly 51′ in FIG. 16 to FIG. 27, while other structures thereof are the same. A structure of the first engaging tooth 704a′ of the spool 704′ in FIG. 48 to FIG. 51 is different from the structure of the first engaging tooth 536′ of the spool 53′ in FIG. 16 to FIG. 27, while other structures thereof are the same. The first positioning surface in FIG. 48 to FIG. 51 is the same as the first positioning surface 5212′ in FIG. 16 to FIG. 27. The second positioning surface in FIG. 48 to FIG. 51 is the same as the second positioning surface 5362′ in FIG. 16 to FIG. 27.

In one example, a number of first engaging teeth 704a′ is the same as a number of inner apertures. A number of first magnetic members 707′ is the same as a number of the inner apertures. A number of second magnetic members 708′ is the same as a number of the inner apertures. In one example, six inner apertures are provided.

In one example, the grass trimmer includes a magnetic member and a metal member. The magnetic member is fixed to one of the spool and the housing, and the metal member is fixed to another of the spool and the housing. The magnetic member generates a suction force to the metal member. The magnetic member drives the housing assembly or the spool 704′ to rotate with respect to the other one so that the first positioning surface is in contact with the second positioning surface, realizing the automatic alignment of the inner aperture and the outer aperture.

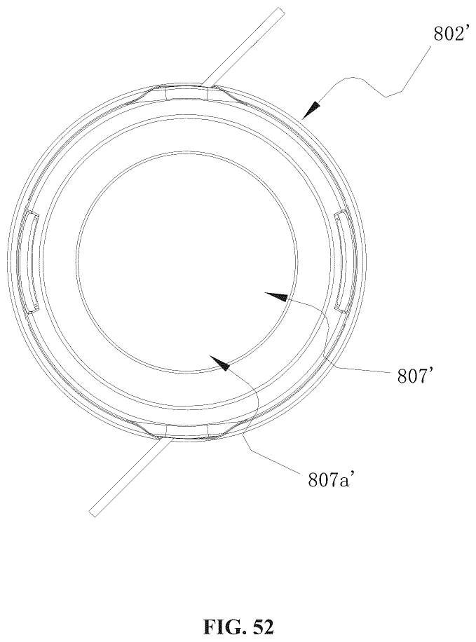

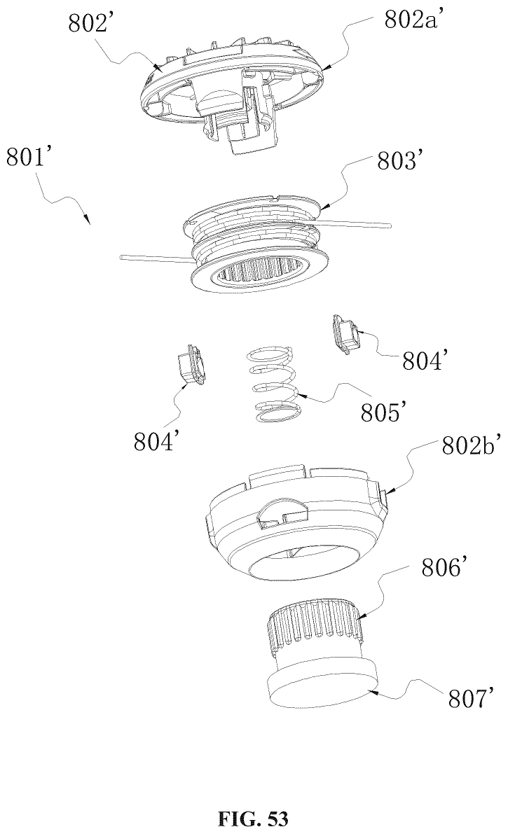

As shown in FIG. 52 and FIG. 53, a grass trimming head 801′ includes a housing 802′, a spool 803′, a knocking cap 807′, a knocking cap supporting member 806′ and a spring 805′. The spool 803′ is configured for the cutting line wining. At least a portion of the spool 803′ is arranged inside the housing 802′, and the spool 803′ is rotatable with respect to the housing 803′ about a central axis. The housing 802′ includes an upper housing 802a′ and a lower housing 802b′. The spool 803′ is located between the upper housing 802′ and the lower housing 802b′. The upper housing 802a′ is formed with a first matching tooth. The knocking cap supporting member 806′ is formed with a first engaging tooth matched with the first matching tooth. In one example, the first engaging tooth is arranged on an inner surface of the knocking cap supporting member 806′. An eyelet member 804′ is fixed to the housing 802′. The eyelet member 804′ is formed with an outer aperture.

The spring 805′ is arranged between the knocking cap supporting member 806′ and the upper housing 802a′. The knocking cap 807′ is rotatably connected to the knocking cap supporting member 806′. The knocking cap 807′ includes a contact portion 807a′ protruding out of an outer surface of the housing 802′. The contact portion 807a′ is configured to be in contact with the ground. The lower housing 802b′ is formed with an outlet. The knocking cap 807′ protrudes out of the housing 802′ from the outlet. The spool 803′ is formed with a guiding portion. The knocking cap supporting member 806′ is formed with a cooperating portion. The cooperating portion is arranged on an outer surface of the knocking cap supporting member 806′. The guiding portion and the cooperating portion are matched so that the spool 803′ and the knocking cap supporting member 806′ remain in a synchronous rotation and are slidable along the central axis.

A ratio of a projection area of the contact portion 807a′ on a plane perpendicular to the central axis to a projection area of the housing 802′ on the plane perpendicular to the central axis is greater than or equal to 0.3, and less than or equal to 1. A surface of the contact portion 807a′ is a smooth curved surface. A projection of the contact portion 807a′ on the plane perpendicular to the central axis has a circular shape.

In on example, the knocking cap supporting member and the spool may be a whole, that is, the knocking cap is rotatably connected to the spool.

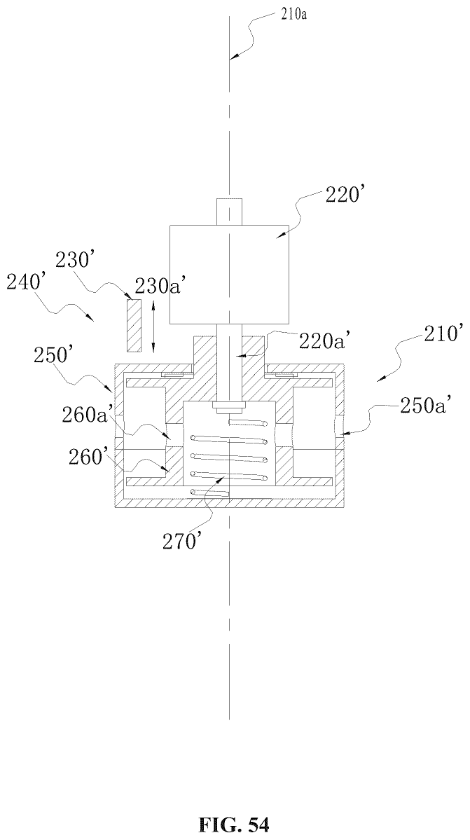

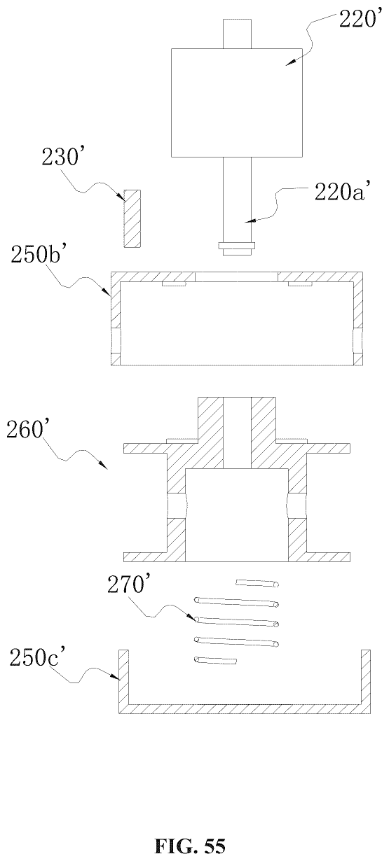

As shown in FIG. 54 and FIG. 55, a grass trimming head 210′ is configured to mount and accommodate a cutting line. One portion of the cutting line is accommodated inside the grass trimming head 210′, and another portion of the cutting line protrudes out of the grass trimming head 210′ to cut the vegetation when the grass trimming head 210′ is rotated.

The motor 220′ is configured to drive the grass trimming head 210′ to rotate about a central axis 210a′, thereby driving the cutting line to rotate to cut the vegetation. In one example, the motor 220′ includes a motor shaft 220a′. The motor shaft 220a′ is connected to the grass trimming head 210′ to drive the grass trimming head 210′ to rotate.

The grass trimming head 210′ includes a spool 260′ and a housing 250′. The spool 260′ is configured for the cutting line winding around and accommodated inside the housing 250′. The spool 260′ is provided with an inner aperture 260a′. The inner aperture 260a′ is configured for fixing the cutting line or for the cutting line passing through. The housing 250′ is formed with an outer aperture 250a′ for the cutting line passing through. In one example, the housing 250′ includes an upper housing 250b′ and a lower housing 250c′, which is convenient for the housing 250′ to be assembled with the spool 260′ and for the user to open the housing 250′ to detect a situation inside the housing 250′.

The grass trimming head 210′ further includes a spring 270′ applying an acting force between the housing 250′ and the spool 260′. The spring 27′ applies an acting force causing the spool 260′ to go away from the lower housing 250c′.

When the cutting line needs to be replenished by the user, the user may align the inner aperture 260a′ with the outer aperture 250a′, and then insert the cutting line into the inner aperture 260a′ through the outer aperture 250a′. As long as the spool 260′ and the housing 250′ are moved with respect to each other, the cutting line is limited by the outer aperture 250a′ so that the cutting line is gradually wound around the spool 260′ with the moving of the outer aperture 250a′ with respect to the spool 260′. The motor shaft 220a′ is connected to the spool 260′, and directly drives the spool 260′ to rotate about the central axis 210a′. The spool 260′ is rotatably connected to the housing 250′.

The grass trimmer further includes a damping device 240′. In one example, the damping device 240′ includes a friction member 230′. The friction member 230′ is movable along a direction 230a′. When the friction member 230′ is moved to be in contact with the housing 250′, the friction member 230′ causes, due to the contact friction, the housing 250′ to have a tendency to rotate about the spool 260′. With the increase of the friction force, the friction member 230′ causes the spool 260′ and the housing 250′ to rotate with respect to each other, so that the grass trimmer has an auto-winding mode. The motor 220′ drives at least one of the spool 260′ and the housing 250′ so that the spool 260′ and the housing 250′ are rotated with respect to each so as to automatically wind the cutting line around the spool 260′. In one example, under the driving of the motor 220′ and the action of the friction member 230′, the spool 260′ and the housing 250′ are rotated with respect to each other so as to automatically wind the cutting line around the spool 260′. The friction member 230′ does not completely prevent the housing 250′ from rotating, but only reduce a rotational speed of the housing 250′, thereby realizing the relative rotation of the spool 260′ and the housing 250′.

Of course, when the spool 260′ is wound by enough cutting line and a portion of the cutting line protruding out of the housing 250′ is not sufficient to cut the vegetation, the spool 260′ and the housing 250′ is relatively rotated to realize the automatic string release.

In one example, the friction member 230′ is configured to generate a damping function on the housing 250′ so as to slow down the rotation of the housing 250′, thereby causing the housing 250′ and the spool 260′ to relatively rotate. The user may directly or indirectly operate the friction member 230′ to realize the cutting mode and the auto-winding mode of the grass trimmer. Of course, the user may firstly place the friction member 230′ under a state corresponding to a desired mode and then start the motor 220′.

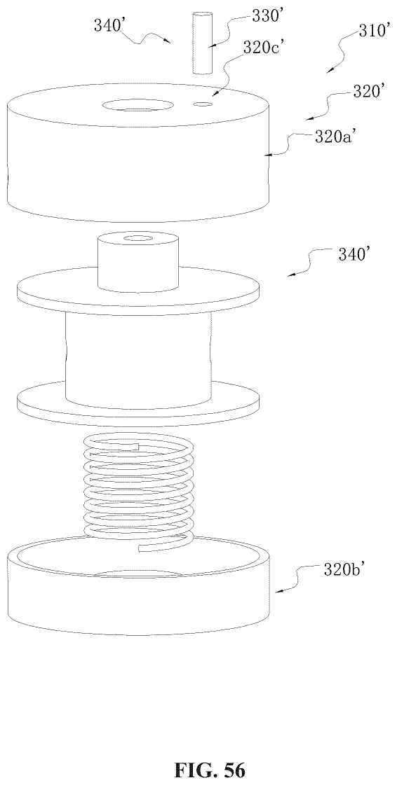

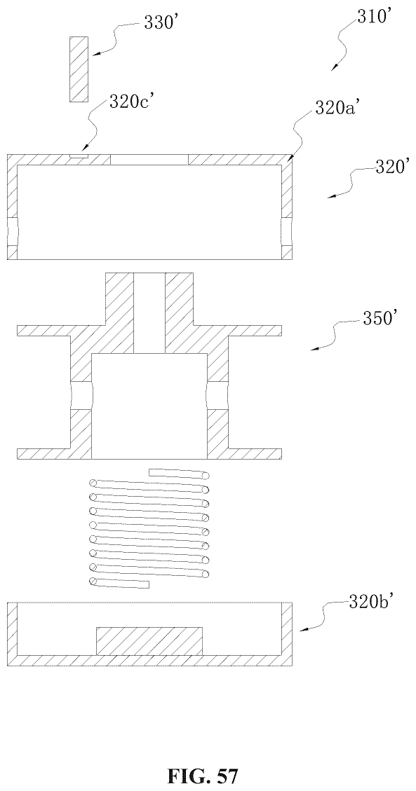

As shown in FIG. 56 and FIG. 57, in one example, a grass trimming head 310′ includes a spool 350′ and a housing 320′. The housing 320′ includes an upper housing 320a′ and a lower housing 320b′.

Compared to the damping device 240′ in FIG. 54 and FIG. 55, a damping device 340′ in FIG. 56 and FIG. 57 includes a stopping member 330′ for preventing the housing 320′ from rotating. The housing 320′ is formed with a stopping groove 320c′ matched with the stopping member 330′. In one example, the stopping groove 320c′ is arranged on the upper housing 320a′. In the auto-winding mode, the stopping member 330′ is inserted into the stopping groove 320c′ and matched with the stopping groove 320c′, so that the housing 320′ is completely prevented from rotating with respect to the whole grass trimmer. Also, the relative rotation of the spool 350′ and the housing 320′ is realized so that the cutting line can be automatically wound around the spool 350′, realizing the automatic winding function.

The stopping member 330′ is also configured to damp the rotation of the housing 320′. The difference is as follows. The damping effect of the friction member 230′ is to slow down the moving tendency. The damping effect of the stopping member 330′ is to limit the displacement. The slowing down of the moving tendency and the limitation of the displacement are both defined as damping. The friction member 230′ and the stopping member 330′ may be both considered as the damping device 340′.

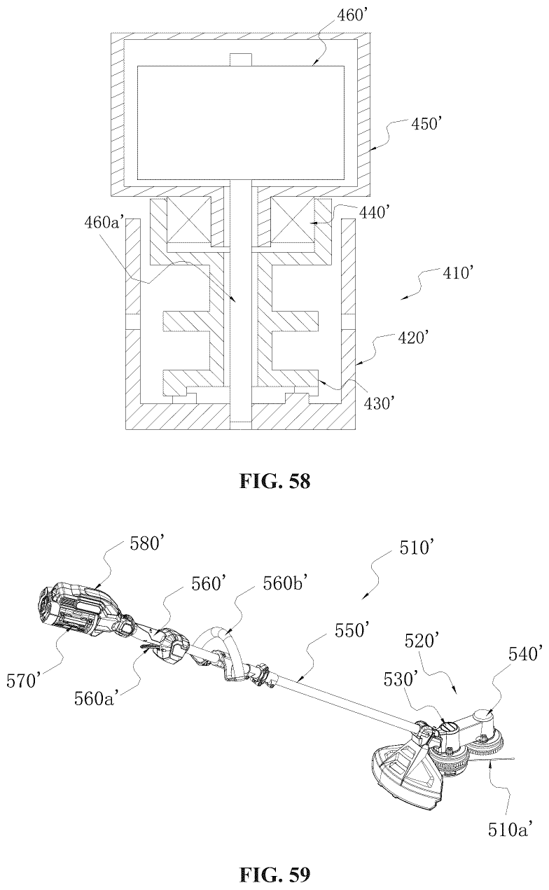

FIG. 58 shows a solution in which a motor shaft 460a′ of the motor 460′ drives the housing 420′ and a one-way bearing 440′ is adopted to damp the spool 430′.

As shown in FIG. 58, the grass trimming head 410′ includes a spool 430′ and a housing 420′. The motor 460′ is accommodated by the motor housing 450′. The one-way bearing 440′ is arranged between the spool 430′ and the motor housing 450′ so that the spool 430′ is rotatable with respect to the motor housing 450′ in only one direction. In one example, the motor housing 450′ is formed with a boss portion. An inner ring of the one-way bearing 440′ is sleeved on an outer periphery of the boss portion, and fixedly connected to the motor housing 450′. An outer ring of the one-way bearing 440′ is rotatable with respect to the motor housing 450′ in only one direction. The outer ring of the bearing 440′ is prevented from rotating with respect to the motor housing 450′ in another direction. The spool 430′ is sleeved on the outer ring of the one-way bearing 440′. The one-way bearing 440′ enables the spool 430′ to rotate with respect to the motor housing 450′ in only one direction.

The motor shaft 460a′ is arranged throughout the spool 430′ and does not directly drive the spool 430′, namely the motor shaft 460′ does not directly transmit the torque to the spool 430′. The motor shaft 460a′ is in a non-rotational connection to the housing 420′ and directly drives the housing 420′.

According to the foregoing solutions and principles, when the motor 460′ is rotated in a forward direction, the spool 430′ and the housing 420′ may be synchronously rotated to perform the cutting mode. And when the motor 460′ is rotated in a reverse direction, the spool 430′ remains still, and the spool 430′ and the housing 420′ may be relatively rotated to perform the auto-winding mode.

It will be appreciated that the damping device may not only apply a resistance force damping the rotation of the housing to the housing, but also apply a resistance force damping the rotation of the spool to the spool.

In one example, the damping device may apply the damping effect to the spool and the housing. In one example, the damping device may include a first damping member and a second damping member. The first damping member applies a first resistance force damping the rotation of the spool to the spool. The second damping member applies a second resistance force damping the rotation of the housing to the housing. Due to the first resistance force and the second resistance force, the housing and the spool are relatively rotatable.

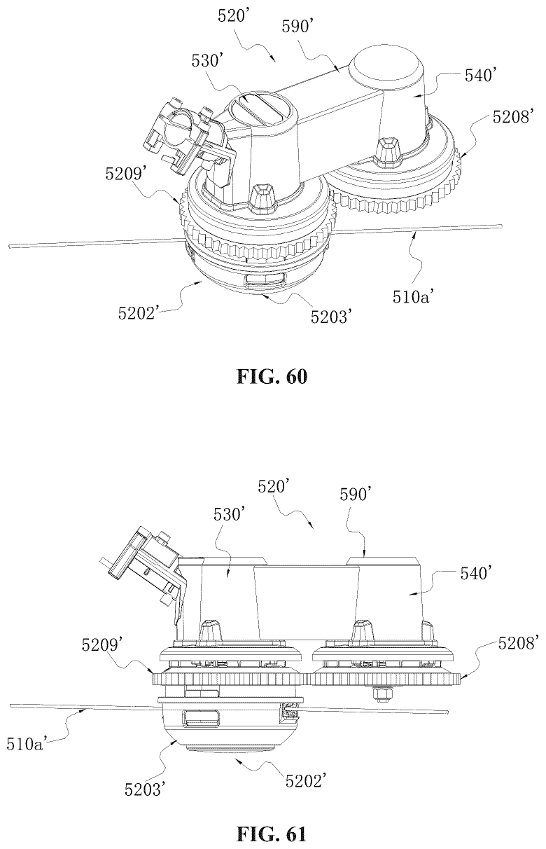

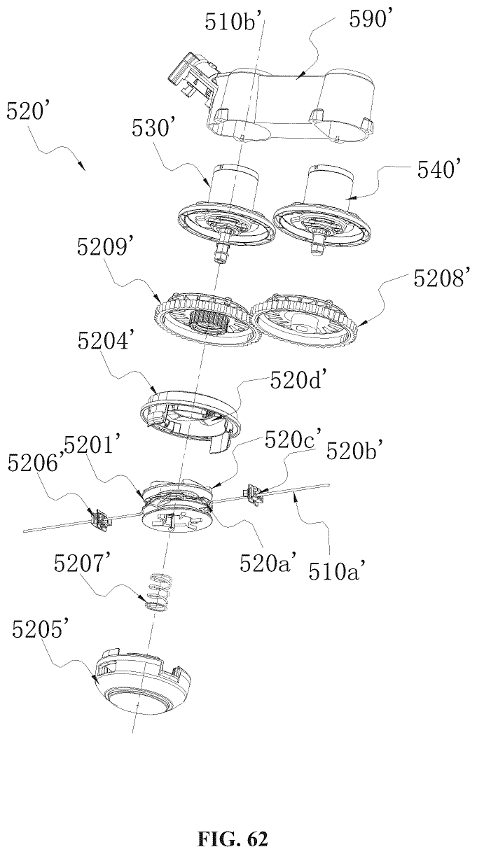

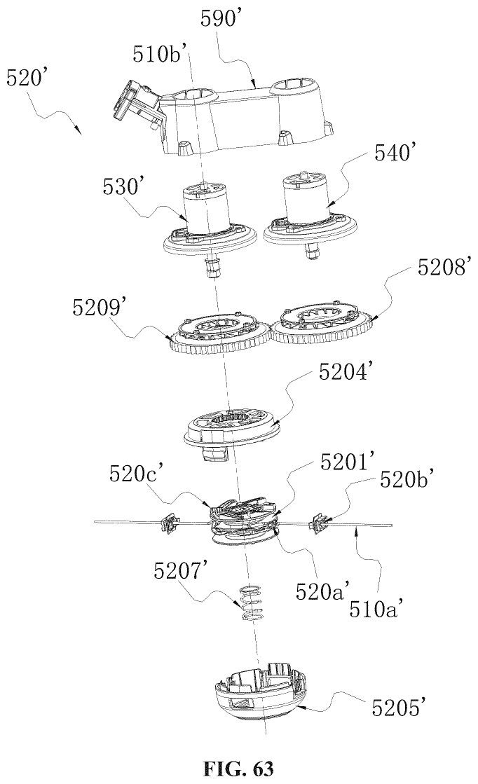

As shown in FIG. 59 to FIG. 63, a grass trimmer 510′ includes a grass trimming head 520′, a first motor 530′, a second motor 540′, a connecting pipe 550′ and a handle 560′.

The grass trimming head 520′ is configured to mount or fix the cutting line 510a′. The handle 560′ is used for being gripped by the user. The grass trimmer 510′ includes a trigger 560a′. The trigger 560a′ is configured to activate the first motor 530′ and the second motor 540′. The trigger 560a′ is arranged on the handle 560′. When gripping the handle 560′, the user can operate the trigger 560a′ to control the first motor 530′ and the second motor 540′. The connecting pipe 550′ is connected to the handle 560′ and the grass trimming head 520′. The grass trimmer 510′ further includes an auxiliary handle 560b′. The auxiliary handle 560b′ is fixed to the connecting pipe 550′. In one example, the auxiliary handle 560b′ is located between the grass trimming head 520′ and the handle 560′. The user can grip the handle 560′ and the auxiliary handle 560b′ by both hands respectively. In one example, the connecting pipe 550′ has a hollow tubular structure, and substantially extends along a straight line.

The grass trimmer 510′ further includes a power supply device for supplying power to the first motor 530′ and the second motor 540′. In one example, the power supply device is a battery pack 570′. Of course, the power supply device may be a cable or an interface that is connected to an AC power supply network or a battery. The cable or the interface may supply the power of the AC power supply network or the battery to the grass trimmer 510′.

The grass trimmer 510′ includes a main housing 580′. The battery pack 570′ is fixed by the main housing 580′. The battery pack 570′ is detachably connected to the main housing 580′. The main housing 580′ is fixed to one end of the connecting pipe 550′. The grass trimmer 510′ includes a circuit board for controlling the first motor 530′ and the second motor 540′. The circuit board is arranged inside the main housing 580′.

The grass trimmer 510′ further includes a motor housing 590′. The first motor 530′ and the second motor 540′ is accommodated by the motor housing 590′. The motor housing 590′ is fixed to another end of the connecting pipe 550′. The connecting pipe 550′ is connected to the main housing 580′ and the motor housing 590′. The motor housing 590′ and the main housing 580′ are fixed to two ends of the connecting pipe 550′ respectively.

The grass trimming head 520′ includes a spool 5201′ and a housing assembly 5202′. The spool 5201′ is configured for the cutting line 510a′ winding. At least a portion of the spool 5201′ is arranged inside the housing assembly 5202′, and the spool 5201′ is rotatable with respect to the housing assembly 5202′ about a central axis 510b′. The first motor 530′ is configured to drive the spool 5201′ to rotate, and the second motor 540′ is configured to drive the housing assembly 5202′ to rotate. A rotational axis of the first motor 530′ is parallel to a rotational axis of the second motor 540′.

The grass trimmer 510′ further includes a driving gear 5208′ and a driven gear 5209′. The second motor 540′ is configured to drive the driving gear 5208′ to rotate. The driving gear 5208′ is engaged with the driven gear 5209′ to drive the driven gear 5209′ to rotate. The driven gear 5209′ is coupled to the housing assembly 5202′. The driven gear 5209′ and the housing assembly 5202′ are synchronously rotated. In one example, the driving gear 5208′ includes a plurality of blades. The driving gear 5208′ is used as a fan to generate airflow for cooling the second motor 540′. Similarly, the driven gear 5209′ includes a plurality of blades. The driven gear 5209′ is used as a fan to generate airflow for cooling the first motor 530′.

In one example, the driven gear and the housing assembly are configured to be a whole. That is, no driven gear is provided, and the housing assembly is formed with a gear engaged with the driving gear.

In one example, the housing assembly includes a plurality of blades, and is formed with a fan.

The grass trimmer 510′ has an auto-winding mode and a cutting mode. The cutting mode is a mode that the grass trimmer 510′ is operated by the user to perform the vegetation cutting operation. The auto-winding mode is a mode that the cutting line 510a′ is automatically wound around the spool 5201′ to complete the string winding without the user manually rotating the spool 5201′ or the housing assembly 5202′.

In the cutting mode, a rotational speed of the spool 5201′ driven by the first motor 530′ is the same as a rotational speed of the housing assembly 5202′ driven by the second motor 540′. A rotation direction of the spool 5201′ is the same as a rotation direction of the housing assembly 5202′. Under the driving of the first motor 530′ and the second motor 540′, the spool 5201′ and the housing assembly 5202′ are synchronously rotated.

In the auto-winding mode, the spool 5201′ is rotated with respect to the housing assembly 5202′, so that the cutting line 510a′ is automatically wound around the spool 5201′. The housing assembly 5202′ is formed with an outer aperture 520b′. When the cutting line 510a′ wound around the spool 5201′ is used up, the user inserts the cutting line 510a′ through the outer aperture 520b′ of the housing assembly 5202′ and fixes the cutting line 510a′ to the spool 5201′. In the auto-winding mode, under the driving of the first motor 530′ and the second motor 540′, the spool 5201′ and the housing assembly 5202′ are relatively rotated, and the cutting line 510a′ is automatically wound around the spool 5201′.

In one example, a rotational speed of the spool 5201′ with respect to the housing assembly 5202′ in the auto-winding mode is less than a rotational speed of the spool 5201′ in the cutting mode. The rotational speed of the spool 5201′ with respect to the housing assembly 5202′ is a winding speed of the cutting line 510a′. The winding speed of the cutting line 510a′ is relatively low, which contributes to the safety of the user's operation. The rotational speed of the spool 5201′ in the cutting mode is a rotational speed of the grass trimming head 520′. The rotational speed of the grass trimming head 520′ is relatively high, so that the efficiency of grass trimming is high.

In one example, in the cutting mode, the first motor 530′ drives the spool 5201′ to rotate along one direction. In the auto-winding mode, the first motor 530′ drives the spool 5201′ to rotate along a direction opposite to the one direction.

In another example, in the cutting mode, the first motor drives the spool to rotate along one direction. In the auto-winding mode, the second motor drives the housing assembly to rotate along the same one direction, and the spool is still, so that the spool is rotated with respect to the housing assembly.

In another example, in the cutting mode, the first motor drives the spool to rotate along one direction. In the auto-winding mode, the first motor drives the spool to rotate along the same one direction, and the second motor drives the housing assembly to rotate along the same one direction. A rotational speed of the housing assembly driven by the second motor is greater than a rotational speed of the spool driven by the first motor, so that the spool is rotated with respect to the housing assembly.

The housing assembly 5202′ is formed with the outer aperture 520b′, and the cutting line 510a′ can be inserted into the housing assembly 5202′ from the outside of the housing assembly 5202′ through the outer aperture 520b′. The spool 5201′ is provided with the inner aperture 520a′ for the cutting line 510a′ trimming in. The housing assembly 5202′ includes a housing 5203′ and an eyelet member 5206′. The spool 5201′ is accommodated by the housing 5203′. The eyelet member 5206′ is formed with the outer aperture 520b′. The housing 5203′ includes an upper housing 5204′ and a lower housing 5205′. The spool 5201′ is located between the upper housing 5204′ and the lower housing 5205′.

In one example, the housing assembly includes the housing, and the housing is formed with the outer aperture. That is, no eyelet member is provided.

The grass trimmer 510′ further includes a controller, and the controller is configured to control the first motor 530′ and the second motor 540′ so that the spool 5201′ and the housing assembly 5202′ can be stopped at a position at which the inner aperture 520a′ is aligned with the outer aperture 520b′. In one example, each of the first motor 530′ and the second motor 540′ is a brushless motor. The control detects rotor positions of the first motor 530′ and the second motor 540′ and controls the first motor 530′ and the second motor 540′ so as to align the outer aperture 520b′ with the inner aperture 520a′. The controller is arranged on the circuit board. In other words, the controller is composed of electrical components on the circuit board.

In one example, the grass trimmer 510′ further includes a Hall sensor detecting a position of the spool 5201′ or the housing assembly 5202′, and an inductive controller controlling the first motor 530′ and the second motor 540′ to stop the spool 5201′ and the housing 5203′ at a position at which the inner aperture 520a′ is aligned with the outer aperture 520b′. Based on the position of the spool 5201′ and the position of the housing 5203′ detected by the Hall sensor, the inductive controller controls the first motor 530′ and the second motor 540′ to align the outer aperture 520b′ with the inner aperture 520a′.

When the user needs to wind the cutting line 510a′ around the spool 5201′, the user can directly insert the cutting line 510a′ into the inner aperture 520a′ through the outer aperture 520b′. Then the user starts the auto-winding mode, the spool 5201′ and the housing assembly 5202′ are relatively rotated under the driving of the first motor 530′ and the second motor 540′, and the cutting line 510a′ is automatically wound around the spool 5201′.

The grass trimmer 510′ cuts the vegetation through the rotation of the cutting line 510a′ protruding out of the grass trimming head 520′. When the grass trimmer 510′ is in the cutting mode for a long time, the cutting line 510a′ is in contact with the grass and is worn, causing the cutting line 510′ being shortened. At this point, the user needs to increase a length of the cutting line 510a′ protruding out of the housing assembly 5202′.

The grass trimmer 510′ also has an auto feeding mode. The rotation direction of the spool 5201′ with respect to the housing assembly 5202′ in the auto feeding mode is opposite to the rotation direction of the spool 5201′ with respect to the housing assembly 5202′ in the auto-winding mode. The spool 5201′ release portion of the cutting line 510a′ wound around the spool 5201′, to increase the length of the cutting line 510a′ protruding out of the housing assembly 5202′. The grass trimmer 510′ further includes a controller for controlling the spool 5201′ to rotate a preset angle with respect to the housing assembly 5202′ in the auto feeding mode.

In one example, the grass trimming head 520′ may also release a certain length of cutting line 510a′ by a knocking manner. That is, the grass trimmer 510′ has a knock feeding mode. The spool 5201′ is provided with a first engaging tooth 520c′. The housing assembly 5202′ is formed with a first matching tooth 520d′ matched with the first engaging tooth 520c′. The first engaging tooth 520c′ and the first matching tooth 520d′ are matched to release a desired length of cutting line 510a′. The grass trimming head 520′ further includes a spring 5207′. The spring 5207′ applies an acting force between the lower housing 5205′ and the spool 5201′, and is arranged between the lower housing 5205′ and the spool 5201′.

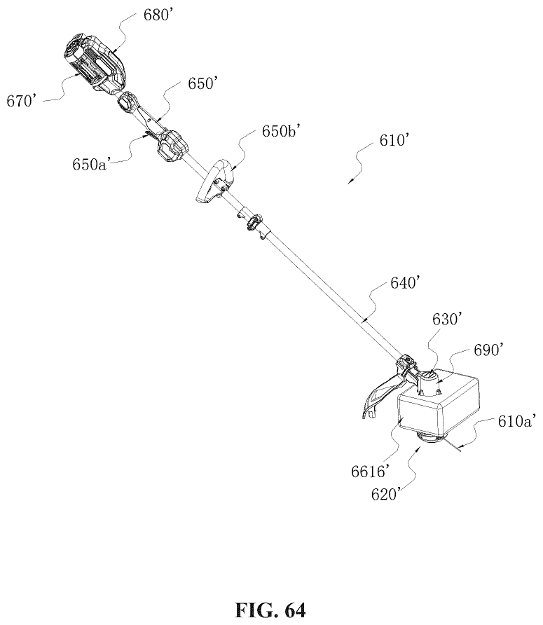

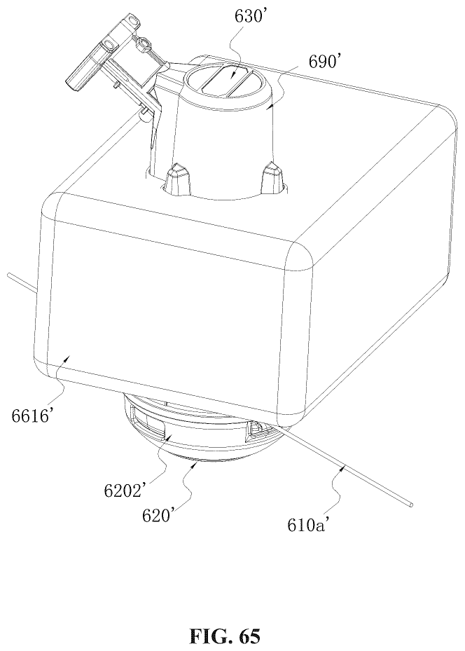

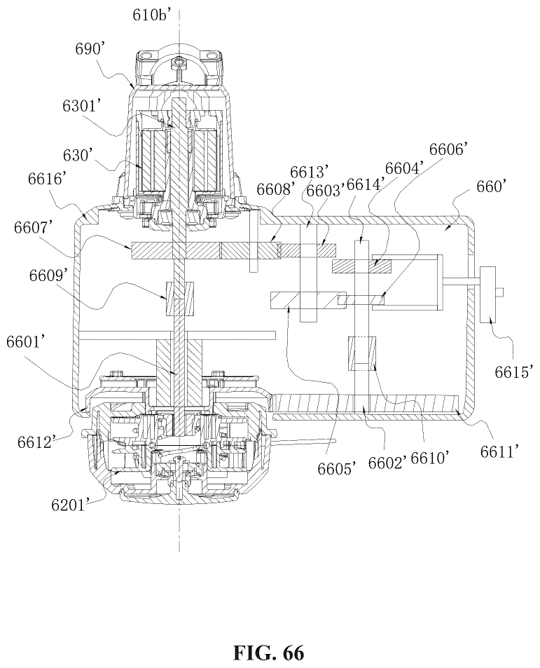

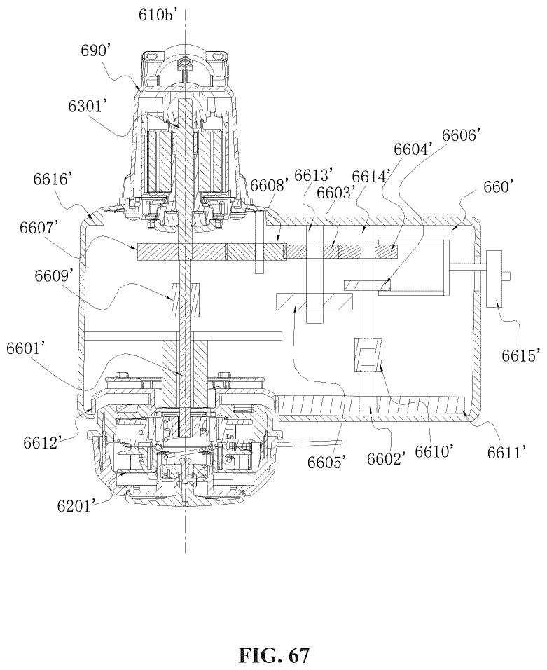

As shown in FIG. 64 to FIG. 67, a grass trimmer 610′ includes a grass trimming head 620′, a motor 630′, a connecting pipe 640′, a handle 650′ and a transmission mechanism 660′.

The grass trimming head 620′ is configured to mount or fix the cutting line 610a′. The motor 630′ is configured to drive the grass trimming head 620′ to rotate.

The handle 650′ is configured for being gripped by the user. The grass trimmer 610′ includes a trigger 650a′ for activating the motor 630′. The trigger 650a′ is arranged on the handle 650′. When gripping the handle 650′, the user can operate the trigger 650a′ to control the motor 630′. The connecting pipe 640′ is connected to the handle 650′ and the grass trimming head 620′. The grass trimmer 610′ further includes an auxiliary handle 650b′. The auxiliary handle 650b′ is fixed to the connecting pipe 640′. In one example, the auxiliary handle 650b′ is located between the grass trimming head 620′ and the handle 650′. The user can grip the handle 560′ and the auxiliary handle 650b′ by both hands respectively. In one example, the connecting pipe 640′ has a hollow tubular structure, and substantially extends along a straight line.

The transmission mechanism is connected to the grass trimming head 620′ and the motor 630′ so as to realize the motor 630′ driving the grass trimming head 620′ to rotate.

The grass trimmer 610′ further includes a power supply device for supplying power to the motor 630′. In one example, the power supply device is a battery pack 670′. Of course, the power supply device may be a cable or an interface that is connected to an AC power supply network or a battery. The cable or the interface may supply the power of the AC power supply network or the battery to the grass trimmer 610′.

The grass trimmer 610′ includes a main housing 680′. The battery pack 670′ is fixed by the main housing 680′. The battery pack 670′ is detachably connected to the main housing 680′. The main housing 680′ is fixed to one end of the connecting pipe 640′. The grass trimmer 610′ includes a circuit board for controlling the motor 630′. The circuit board is arranged inside the main housing 680′.

The grass trimmer 610′ further includes a motor housing 690′. The motor 630′ is accommodated by the motor housing 690′. The motor housing 690′ is fixed to another end of the connecting pipe 640′. The connecting pipe 640′ is connected to the main housing 680′ and the motor housing 690′. The motor housing 690′ and the main housing 680′ are fixed to two ends of the connecting pipe 640′ respectively. The motor 630′ and the grass trimming head 620′ are located on a same end of the connecting pipe 640′. Such grass trimmer 610′ is generally referred to as a pre-motor 630′ grass trimmer 610′.

In on example, the motor 630′ and the grass trimming head 620′ are located on two ends of the connecting pipe 640′. Such grass trimmer 610′ is generally referred to as a near-motor 630′ grass trimmer 610′.

The grass trimming head 620′ includes a spool 6201′ and a housing assembly 6202′. The spool 6201′ is configured for the cutting line 610a′ winding. At least a portion of the spool 6201′ is arranged inside the housing assembly 6202′ and rotatable with respect to the housing assembly 6202′ about a central axis 610b′.

The grass trimmer 610′ has an auto-winding mode and a cutting mode. The cutting mode is a mode that the grass trimmer 610′ is operated by the user to perform the vegetation cutting operation. The auto-winding mode is a mode that the cutting line 610a′ is automatically wound around the spool 6201′ to complete the string winding without the user manually rotating the spool 6201′ or the housing assembly 6202′.

In the cutting mode, the motor 630′ drives the grass trimming head 620′ to rotate about the central axis 610b′. In one example, the motor 630′ drives the spool 6201′ and the housing assembly 6202′ to synchronously rotate.

In the auto-winding mode, the motor 630′ drives the spool 6201′ and the housing assembly 6202′ to relatively rotate to automatically wind the cutting line 610a′ around the spool 6201′. The housing assembly 602′ is formed with an outer aperture. When the cutting line 610a′ wound around the spool 6201′ is used up, the user inserts the cutting line 610a′ through the outer aperture of the housing assembly 6202′ and fixes the cutting line 610a′ to the spool 6201′. In the auto-winding mode, the spool 6201′ and the housing assembly 6202′ are relatively rotated, and the cutting line 610a′ is automatically wound around the spool 6201′.

The transmission mechanism 660′ includes a first output shaft 6601′ and a second output shaft 6602′. The motor 630′ drives the first output shaft 6601′ and the second output shaft 6602′ to rotate. The motor shaft 6301′ simultaneously drives the first output shaft 6601′ and the second output shaft 6602′ to rotate. The first output shaft 6601′ drives the spool 6201′ to rotate, and the second output shaft 6602′ drives the housing assembly 6202′ to rotate.

The transmission mechanism 660′ has a first running state and a second running state. When the transmission mechanism 660′ is in the first running state, a rotational speed of the spool 6201′ driven by the first output shaft 6601′ is the same as a rotational speed of the housing assembly 6202′ driven by the second output shaft 6602′, and rotation directions of the spool 6201′ and the housing assembly 6202′ are the same. The spool 6201′ and the housing assembly 6202′ are synchronously rotated, at this moment, the grass trimmer 610′ is in the cutting mode.

When the transmission mechanism 660′ is in the second running state, the motor 630′ drives the spool 6201′ and the housing assembly 6202′ to relatively rotate so as to automatically wind the cutting line 610a′ around the spool 6201′, and at this moment, the grass trimmer 610′ is in the auto-winding mode. In one example, when the transmission mechanism 660′ is in the second running state, the rotational speed of the spool 6201′ driven by the first output shaft 6601′ is different from the rotational speed of the housing assembly 6202′ driven by the second output shaft 6602′.

In one example, a rotational speed of the spool 6201′ with respect to the housing assembly 6202′ in the auto-winding mode is less than a rotational speed of the spool 6201′ in the cutting mode. The rotational speed of the spool 6201′ with respect to the housing assembly 6202′ is a winding speed of the cutting line 610a′. The winding speed of the cutting line 610a′ is relatively low, which contributes to the safety of the user's operation. The rotational speed of the spool 6201′ in the cutting mode is a rotational speed of the grass trimming head 620′. The rotational speed of the grass trimming head 620′ is relatively high, so that the efficiency of grass trimming is high.

In one example, the rotational speed of the spool 6201′ in the auto-winding mode is less than the rotational speed of the spool 6201′ in the cutting mode. In the auto-winding mode, the rotational speeds of the spool 6201′ and the housing assembly 6202′ are relatively low, which avoids the damages caused by the housing where the spool 6201′ and the housing assembly 6202′ are accidentally touched by the user.

In the cutting mode, the first output shaft 6601′ drives the spool 6201′ to rotate in one direction. In the auto-winding mode, the first output shaft 6601′ drives the spool 6201′ to rotate in a direction opposite to the one direction.

In one example, in the cutting mode, the motor 630′ is rotated in a forward direction. In the auto-winding mode, the motor 630′ is rotated in a reverse direction. The rotational speed of the motor 630′ rotated in the forward direction is greater than the rotational speed of the motor 630′ rotated in the reverse direction.

In one example, in the cutting mode, the first output shaft 6601′ drives the spool 6201′ to rotate in one direction. In the auto-winding mode, the first output shaft 6601′ drives the spool 6201′ to rotate in the same one direction, and the second output shaft 6602′ drives the housing assembly 6202′ to rotate in the same one direction; the rotation speed of the housing assembly 6202′ driven by the second output shaft 6602′ is greater than the rotational speed of the spool 6201′ driven by the first output shaft 6601′, so that the housing assembly 6202′ and the spool 6201′ are relatively rotates to automatically wind the cutting line 610a′ around the spool 6201′.

The grass trimmer 610′ is provided with a function switching member 6615′. The function switching member 6615′ is movable between a first position and a second position. When the function switching member 6615′ is at the first position, the transmission mechanism 660′ is in the first running state. When the function switching member 6615′ is at the second position, the transmission mechanism 660′ is in the second running state.

The transmission mechanism 660′ further includes a first transmission gear 6603′, a second transmission gear 6604′, a third transmission gear 6605′ and a fourth transmission gear 6606′. The third transmission gear 6605′ and the first transmission gear 6603′ are coaxially rotated, and the fourth transmission gear 6606′ and the second transmission gear 6604′ are coaxially rotated.

The transmission mechanism 660′ further includes a gear housing 6616′, a driving gear 6607′, a driven gear 6608′, a first shaft coupling 6609′, a second shaft coupling 6610′, a first drive gear 6611′, a second drive gear 6612′, a first shaft 6613′ and a second shaft 6614′.

The first transmission gear 6603′, the second transmission gear 6604′, the third transmission gear 6605′, and the fourth transmission gear 6606′ are accommodated by the gear housing 6616′. The driving gear 6607′ is fixed to the motor shaft 6301′. The driving gear 6607′ is engaged with the driven gear 6608′ to drive the driven gear 6608′ to rotate. The driven gear 6608′ is engaged with the first transmission gear 6603′ to drive the first transmission gear 6603′ and the third transmission gear 6605′ to rotate. The first transmission gear 6603′ and the third transmission gear 6605′ are fixed to the first shaft 6613′. The second transmission gear 6604′ and the fourth transmission gear 6606′ are fixed to the second shaft 6614′. The second shaft 6614′ is connected to the second output shaft 6602′ through the second shaft coupling 6610′. The second 6614′ is slidable with respect to the second output shaft 6602′. By the arrangement of the first shaft coupling 6609′, the second shaft 6614′ and the second output shaft 6602′ may remain in a synchronous rotation. The first drive gear 6611′ is fixed to the second output shaft 6602′. The shaft 6301′ is connected to the first output shaft 6601′ through the first shaft coupling 6609′. The motor shaft 6301′ and the first output shaft 6601′ are synchronously rotated.

In one example, no first shaft coupling is provided, and the first output shaft and the motor shaft are configured to be a whole. In other words, the motor shaft is used as the first output shaft. A rotor of the motor drives the first output shaft to rotate.

When the function switching member 6615′ is at the first position, the transmission mechanism 660′ is in the first running state. At this moment, the motor 630′ drives the first drive transmission gear 6603′ and the third transmission gear 6605′ to rotate; the first transmission gear 6603′ and the second transmission gear 6604′ are engaged; and the third transmission gear 6605′ and the fourth transmission gear 6606′ are unengaged, so as to drive the second shaft 6614′ to rotate. The second shaft 6614′ drives the second output shaft 6602′ to rotate. The second output shaft 6602′ drives the first drive gear 6611′ to rotate. The first drive gear 6611′ is engaged with the second drive gear 6612′ to drive the second drive gear 6612′ to rotate. The first output shaft 6601′ drives the spool 6201′ to rotate. The spool 6201′ and the housing assembly 6202′ can remain in a synchronous rotation.

The second drive gear 6612′ is coupled to the housing assembly 6202′. The second driving gear 6612′ and the housing assembly 6202′ are synchronously rotated. The housing assembly 6202′ is slidable with respect to the second drive gear 6612′ along a rotational axis, which ensures that the first drive gear 6611′ and the second drive gear 6612′ keep engaged when the user knocks the grass trimming head 620′ to release the cutting line. In one example, the second drive gear 6612′ is provided with a plurality of fan blades. The second drive gear 6612′ is used as a fan.

In one example, the housing assembly is provided with a plurality of fan blades.

When the auto-winding mode needs to be performed by the user, the function switching member 6615′ is moved to the second position. The third transmission gear 6605′ is engaged with the fourth transmission gear 6606′, and the first transmission gear 6603′ is unengaged with the second transmission gear 6604′, so that the motor 630′ drives the second shaft 6614′. Since a transmission ratio of the third transmission gear 6605′ to the fourth transmission gear 6606′ is different from a transmission ratio of the first transmission gear 6603′ to the second transmission gear 6604′, the rotational speed of the housing assembly 6202′ when the function switching member 6615′ is at the second position is different from the rotational speed of the housing assembly 6202′ when the function switching member 6615′ is at the first position. Since the rotational speed of the spool 6201′ when the function switching member 6615′ is at the first position is the same as the rotational speed of the spool 6201′ when the function switching member 6615′ is at the second position, the rotational speeds of the spool 6201′ and the housing assembly 6202′ are different when the function switching member 6615′ is at the second position. The spool 6201′ and the housing assembly 6202′ are relatively rotated to automatically wind the cutting line 610a′ around the spool 6201′, realizing the automatic winding.

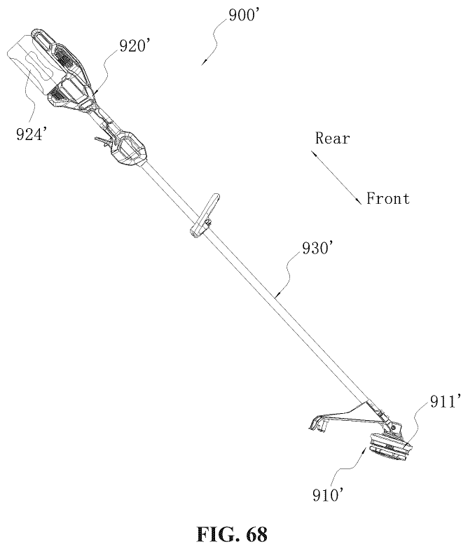

A long-rod type power tool 900′ shown in FIG. 68 is a grass trimmer, which is used for a user to operate to trim grass on a lawn, so as to achieve a purpose of repairing the lawn. It can be understood that the long-rod type power tool may be other long-rod type tools, the long-rod type power tool may be a long-rod type garden tool, may also be a long-rod type sanding tool, and may also be a long-rod type cutting tool. More specifically, the long-rod type power tool may be a long-rod hedge trimmer, a long-rod chain saw, a long-rod sander, a long-rod lawn edger, a long-rod brush cutter, and the like. In fact, technical solutions disclosed in this example can be adopted as long as the long-rod type power tool has a connecting rod assembly 930′.

As shown in FIG. 68, in this example, the long-rod type power tool 900′ is an electric power tool. It can be understood that, in other examples, the long-rod type power tool 900′ may also use fuel as an energy source, and the long-rod type power tool 900′ is an engine-type tool. In this example, the long-rod type power tool 900′ is a DC tool. It can be understood that, in other examples, the long-rod type power tool 900′ may also be an AC tool.

As shown in FIGS. 68 to 70, the long-rod type power tool 900′ includes a front end device 910′, a rear end device 920′ and a connecting rod assembly 930′. The front end device 910′ includes an output assembly 911′ and a front housing 912′ for supporting the output assembly 911′. The rear end device 920′ includes a motor 921′ and a rear housing 922′ for supporting the motor 921′. The connecting rod assembly 930′ connects the front end device 910′ and the rear end device 920′.

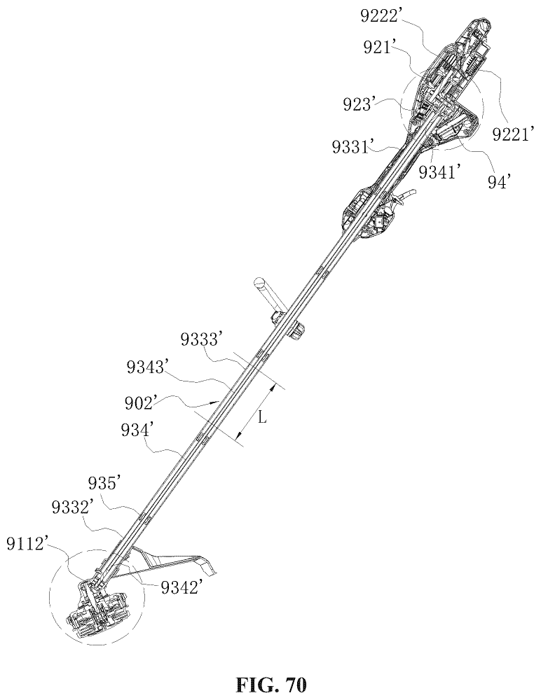

As shown in FIGS. 70 to 72, the rear end device 920′ is arranged at a rear end 931′ of the connecting rod assembly 930′. The motor 921′ is used to drive the output assembly 911′ to move, the rear housing 922′ is formed with a first accommodating cavity 9222′, and the motor 921′ is arranged in the first accommodating cavity 9222′. The rear end device 920′ may further include a first transmission assembly 923′ for outputting the power of the motor 921′, and the first transmission assembly 923′ is arranged in the first accommodating cavity 9222′. The rear housing 922′ is also formed with a coupling portion 9221′, and the coupling portion 9221′ is configured to couple a power source device 924′ for providing energy to the motor 921′. In this example, the motor 921′ is an electric motor 921′, and the power source device 924′ includes a battery pack that can be detachably mounted to the coupling portion 9221′.

The front end device 910′ is arranged at a front end 932′ of the connecting rod assembly 930′, and the output assembly 911′ is used for outputting power. In this example, the long-rod type power tool 900′ is the grass trimmer, and the output assembly 911′ includes a grass trimming head 9111′ and a second transmission assembly 9112′. The front housing 912′ supports the second transmission assembly 9112′, the front housing 912′ is formed with a second accommodating cavity 9121′, and the second transmission assembly 9112′ is arranged in the second accommodating cavity 9121′. The grass trimming head 9111′ is installed with a trimming line 9113′, and the grass trimming head 9111′ drives the trimming line 9113′ to rotate at a high speed to cut the grass on the lawn when the grass trimming head 9111′ rotates. It can be understood that, in other examples, the output assembly 911′ may also be an output device capable of implementing other functions. For example, when a long-rod type power tool is the long-rod chain saw, an output assembly includes a chain, a guide plate and a chain wheel, and a front housing supports the chain wheel and the guide plate.

The connecting rod assembly 930′ includes a connecting rod 933′ and a transmission shaft 934′. The connecting rod 933′ connects the front housing 912′ and the rear housing 922′, and the connecting rod 933′ further includes a first connecting end 9331′ connected with the rear housing 922′ and a second connecting end 9332′ connected with the front housing 912′. The transmission shaft 934′ is configured to transmit power between the motor 921′ and output assembly 911′. The transmission shaft 934′ connects the motor 921′ and the output assembly 911′, and the power output by the motor 921′ is transmitted to the output assembly 911′ through the transmission shaft 934′ to drive the output assembly 911′ to move. The transmission shaft 934′ includes a first transmission end 9341′ and a second transmission end 9342′, the first transmission end 9341′ is connected to the motor 921′, and the second transmission end 9342′ is connected to the output assembly 911′. More specifically, the first transmission end 9341′ is connected with the first transmission assembly 923′ to realize the connection between the first transmission end 9341′ and the motor 921′, and the first transmission assembly 923′ transmits power between the motor 921′ and the transmission shaft 934′. The second transmission end 9342′ is connected with the second transmission assembly 9112′ to realize the connection between the second transmission end 9342′ and the output assembly 911′, and the second transmission assembly 9112′ transmits power between the transmission shaft 934′ and the output assembly 911′.

The connection in this application may be a direct connection or an indirect connection. The direct connection means that two parts are connected together without an intermediate piece, and the indirect connection means that the two parts are respectively connected with at least one intermediate piece and the two parts are connected through the at least one intermediate piece.

In this example, the transmission shaft 934′ is at least partially disposed in the connecting rod 933′. An extension direction of the transmission shaft 934′ is substantially the same as an extension direction of the connecting rod 933′. The connecting rod 933′ extends in a front-rear direction, and the transmission shaft 934′ extends in the front-rear direction and is arranged in the connecting rod 933′. In this example, the connecting rod 933′ extends along a first straight line 901′. In other examples, the connecting rod may not extend along a straight line, the connecting rod may extend along a curve, or a combination of a straight line and a curve, and correspondingly, the transmission shaft 934′ may also not extend along a straight line.

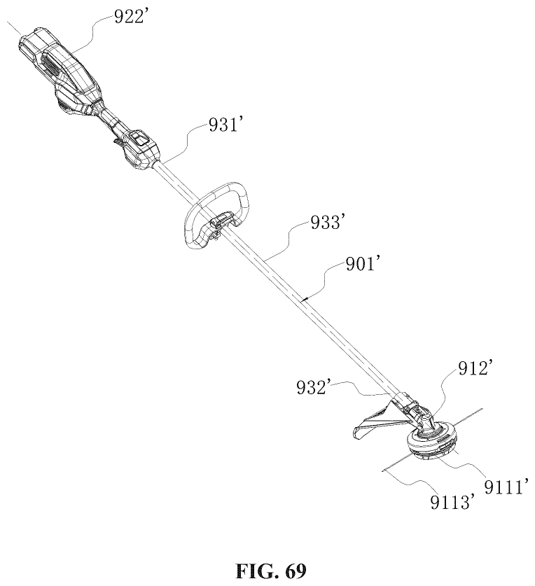

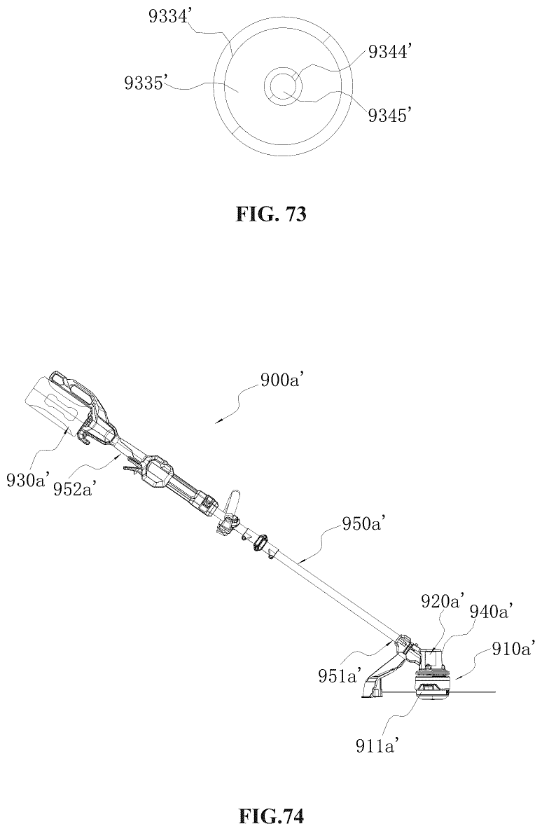

As shown in FIGS. 68 to 73, the transmission shaft 934′ includes a hollow shaft portion 9343′, the hollow shaft portion 9343′ includes a first inner sidewall 9344′, and the first inner sidewall 9344′ surrounds to form a first inner hole 9345′. A part of the connecting rod 933′ for accommodating the hollow shaft portion 9343′ is defined as an accommodating rod 9333′, the accommodating rod 9333′ includes a second inner sidewall 9334′, the second inner sidewall 9334′ defines a second inner hole 9335′, and the hollow shaft portion 9343′ is arranged in the second inner hole 9335′. A weight per unit length of a whole formed by the accommodating rod 9333′ and the hollow shaft portion 9343′ is greater than or equal to 300 g/m and less than or equal to 500 g/m. The weight per unit length of the whole formed by the accommodating rod 9333′ and the hollow shaft portion 9343′ will be explained in detail below. As shown in FIG. 69, in the extension direction of the connecting rod 933′, take any section of the accommodating rod 9333′, and take a section of the hollow shaft portion 9343′ corresponding to the any section of the accommodating rod 9333′, and a ratio of a total weight of a whole 902′ formed by the any section of accommodating rod 9333′ and the section of the hollow shaft portion 9343′ to a length L of the any section of the accommodating rod 9333′ is defined as the weight per unit length of the whole formed by the accommodating rod 9333′ and the hollow shaft portion 9343′.

In some examples, the weight per unit length of a whole formed by the accommodating rod 9333′ and the hollow shaft portion 9343′ is greater than or equal to 330 g/m and less than or equal to 450 g/m. In some examples, the weight per unit length of a whole formed by the accommodating rod 9333′ and the hollow shaft portion 9343′ is greater than or equal to 350 g/m and less than or equal to 420 g/m.

In this way, the weight of the connecting rod assembly 930′ and the length of the connecting rod assembly 930′ can be better matched. When the length of the connecting rod assembly 930′ is fixed, the weight of the connecting rod assembly 930′ can be reduced, the user can operate more effortlessly, a power consumption of the long-rod type power tool 900′ can be reduced, and a battery life of the long-rod type power tool 900′ can be prolonged. Alternatively, when the weight of the connecting rod assembly 930′ is fixed, the length of the connecting rod assembly 930′ can be increased, so that the long-rod type power tool 900′ can work in a larger and farther working area. Alternatively, the weight of the connecting rod assembly 930′ and the length of the connecting rod assembly 930′ are matched, so that the long-rod type power tool 900′ can perform more labor-saving operation within an optimal working area.

More specifically, a weight per unit length of the accommodating rod 9333′ is greater than or equal to 180 g/m and less than or equal to 300 g/m. A ratio of the hardness of the accommodating rod 9333′ to the weight per unit length of the accommodating rod 9333′ is greater than or equal to 150 (HRC·m)/g less than or equal to 280 (HRC·m)/g. That is to say, a ratio of the Rockwell hardness (HRC) of the accommodating rod to its weight per unit length (g/m) is greater than or equal to 150 m/g and less than or equal to 280 m/g. Here, the ratio is calculated as the HRC hardness value divided by the value of the weight per unit length (g/m); therefore, the unit corresponds to the reciprocal of the weight per unit length, namely m/g. In some examples, the weight per unit length of the accommodating rod 9333′ is greater than or equal to 210 g/m and less than or equal to 270 g/m, and the ratio of the hardness of the accommodating rod 9333′ to the weight per unit length of the accommodating rod 9333′ is greater than or equal to 170 (HRC·m)/g less than or equal to 250 (HRC·m)/g. In this way, when the hardness of the accommodating rod 9333′ is sufficient to support the long-rod type power tool 900′, a weight of the accommodating rod 9333′ can be reduced as much as possible, thereby reducing a weight of the long-rod type power tool 900′. Compared with long-rod type power tools with heavier weight in the prior arts, the weight of the long-rod type power tool 900′ of the present application is reduced.

A ratio of the weight per unit length of the accommodating rod 9333′ to an outer diameter of the accommodating rod 9333′ is greater than or equal to 9000 g/m² and less than or equal to 10000 g/m². In this way, under the condition that the outer diameter of the accommodating rod 9333′ is suitable for the user to hold, the weight of the accommodating rod 9333′ is as low as possible, so that the weight of the long-rod type power tool 900′ is low. Furthermore, because the weight of the accommodating rod 9333′ is low, it is convenient to adjust a center of gravity of the long-rod type power tool 900′ by setting the weight of the front end device 910′ and the rear end device 920′, so that the center of gravity of the long-rod type power tool 900′ can be set reasonably to meet the requirements of ergonomics.

In this example, the accommodating rod 9333′ includes carbon fiber material. In fact, it will be appreciated that the material of the accommodating rod 9333′ may also comprise other materials. A density of the accommodating rod 9333′ is greater than or equal to 1.4 g/cm³ and less than or equal to 1.8 g/cm³. The weight of the accommodating rod 9333′ is greater than or equal to 300 g and less than or equal to 400 g, so that the weight of the accommodating rod 9333′ can be greatly reduced relative to the weight of the long-rod type power tool 900′. In some examples, the density of the accommodating rod 9333′ is greater than or equal to 1.5 g/cm³ and less than or equal to 1.7 g/cm³, and the weight of the accommodating rod 9333′ is greater than or equal to 320 g and less than or equal to 380 g.

Both the first transmission end 9341′ and the second transmission end 9342′ of the transmission shaft 934′ are arranged in the connecting rod 933′. The first inner hole 9345′ penetrates the transmission shaft 934′ along the first straight line 901′, so that the whole of the transmission shaft 934′ is hollow, and the whole of the transmission shaft 934′ constitutes the hollow shaft portion 9343′. A weight per unit length of the hollow shaft portion 9343′ is greater than or equal to 100 g/m and less than or equal to 200 g/m. In this way, the weight of the hollow shaft portion 9343′ can be reduced, and the weight of the connecting rod 933′ is also set to be smaller, so that the weight of the connecting rod assembly 930′ is reduced. In this example, a ratio of the weight of the connecting rod assembly 930′ to the weight of the long-rod type power tool 900′ is greater than or equal to 0.1 and less than or equal to 0.2. It should be noted that the weight of the connecting rod assembly 930′ is the sum of the weight of the connecting rod 933′ and the weight of the transmission shaft 934′. In this example, after the weight of the long-rod type power tool 900′ is reduced, the manufacturing cost of the long-rod type power tool is reduced, and the user will not feel fatigued even after working for a long time, thereby improving the user's work efficiency. In some examples, the weight per unit length of the hollow shaft portion 9343′ is greater than or equal to 180 g/m and less than or equal to 220 g/m, and the ratio of the weight of the connecting rod assembly 930′ to the weight of the long-rod type power tool 900′ without the power source device 924′ is greater than or equal to 0.12 and less than or equal to 0.18. The weight of the long-rod type power tool 900′ without the power source device 924′ refers to the weight of the long-rod power tool 900′ when the power source device 924′ is not installed, that is, the weight of the main body of the long-rod power tool 900′ shown in FIG. 69. If the power source device is a fuel device, the weight of the long-rod type power tool 900′ without the power source device refers to the tool weight when there is no fuel in a fuel tank of a fuel device. In this example, the long-rod type power tool 900′ is a grass trimmer, and a ratio of a total weight of the connecting rod assembly 930′ and the front end device 910′ to the weight of the grass trimmer without the power source device 924′ is greater than or equal to 0.3 and less than or equal to 0.42. In some examples, the ratio of the total weight of the connecting rod assembly 930′ and the front end device 910′ to the weight of the grass trimmer without the power source device 924′ is greater than or equal to 0.35 and less than or equal to 0.4.

In this example, a ratio of the total weight of the connecting rod 933′ and the transmission shaft 934′ to a length of the connecting rod 933′ is greater than or equal to 300 g/m and less than or equal to 480 g/m. In some examples, the ratio of the total weight of the connecting rod 933′ and the transmission shaft 934′ to a length of the connecting rod 933′ is greater than or equal to 350 g/m and less than or equal to 450 g/m. In this way, under the condition that the length of the long-rod type power tool 900′ meets the user's requirement, the total weight of the connecting rod 933′ and the transmission shaft 934′ can be as small as possible, so that the weight of the long-rod type power tool 900′ can be reduced. For the grass trimmer, because the grass trimmer sometimes needs to trim the grass at roots of bushes, the grass trimmer needs to be extended to a farther working area for work, and the length of the connecting rod 933′ of the grass trimmer needs to be set long enough. If the connecting rod 933′ is sufficiently long, the weight of the connecting rod assembly 930′ will increase. In the present application, the weight of the connecting rod assembly 930′ is reduced by setting the materials and structures of the connecting rod 933′ and the transmission shaft 934′. In this way, the grass trimmer can also improve the work efficiency of the user under the condition that the user's needs are met.

In this example, the hollow shaft portion 9343′ is made of a first material, and the connecting rod 933′ is made of another material different from the first material. Specifically, the connecting rod 933′ includes the carbon fiber material, and a ratio of the density of the hollow shaft portion 9343′ to the density of the connecting rod 933′ is greater than or equal to 4 and less than or equal to 7. In this way, the weight of the connecting rod 933′ is greatly reduced relative to the weight of the hollow shaft portion 9343′, and the weight of the hollow shaft portion 9343′ is also greatly reduced relative to the weight of a solid shaft in the prior arts, thereby reducing the weight of the whole of the connecting rod assembly 930′. In some examples, the ratio of the density of the hollow shaft portion 9343′ to the density of the connecting rod 933′ is greater than or equal to 4.5 and less than or equal to 5.5.

The first inner hole 9345′ is a circular hole, so that the machining cost of the transmission shaft 934′ is reduced and the stability of the transmission shaft 934′ is better. A ratio of an inner diameter of the first inner hole 9345′ to an outer diameter of the hollow shaft portion 9343′ is greater than or equal to 2.5 and less than or equal to 3.5. Specifically, the inner diameter of the first inner hole 9345′ is greater than or equal to 18 mm and less than or equal to 25 mm, and the outer diameter of the hollow shaft portion 9343′ is greater than or equal to 5 mm and less than or equal to 10 mm. In this way, the size of the hollow shaft portion 9343′ can meet a strength requirement and the weight of the hollow shaft can be reduced. That is, the strength and weight of the hollow shaft portion 9343′ are well matched by making the inner diameter of the first inner hole 9345′ and the outer diameter of the hollow shaft portion 9343′ reasonably arranged and balanced with each other. In this example, in order to improve the stability of the transmission shaft 934′, a support assembly 935′ is also arranged in the connecting rod 933′, and the support assembly 935′ is arranged between the connecting rod 933′ and the transmission shaft 934′ to support the transmission shaft 934′.

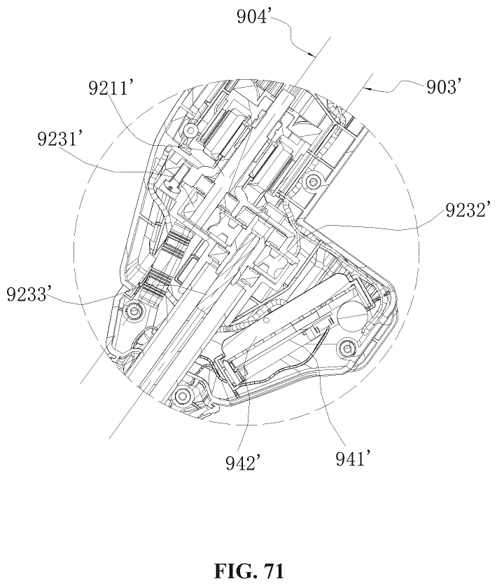

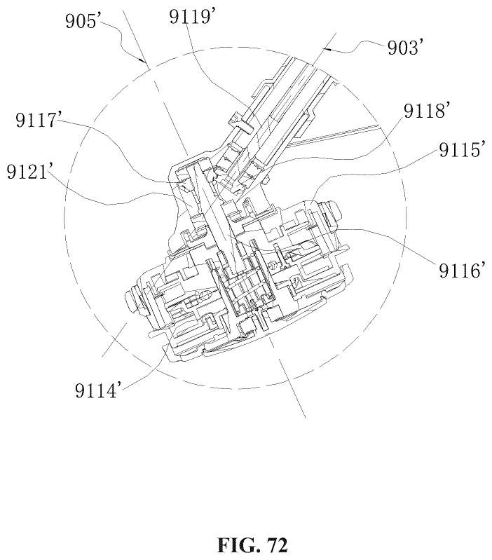

As shown in FIGS. 71 and 72, the motor 921′ includes a stator, a rotor and a motor shaft 9211′, the motor shaft 9211′ outputs power to the first transmission assembly 923′, the first transmission assembly 923′ transmits the power to the transmission shaft 934′, and an axis 903′ of rotation of the transmission shaft 934′ is parallel to an axis 904′ of rotation of the motor shaft 9211′ of the motor 921′. The first transmission assembly 923′ includes a first gear 9231′, a second gear 9232′ and a first connecting member 9233′, the second gear 9232′ meshes with the first gear 9231′, and the first connecting member 9233′ is splined with the second gear 9232′, so that the first connecting member 9233′ and the second gear 9232′ rotate synchronously. Specifically, the first gear 9231′ is connected with the motor shaft 9211′, and the second gear 9232′ is connected with the transmission shaft 934′ through the first connecting member 9233′. When the motor 921′ is started, the first gear 9231′ transmits the power to the second gear 9232′, and the second gear 9232′ drives the transmission shaft 934′ to rotate through the first connecting member 9233′. In this example, the transmission shaft 934′ is made of the first material, and the first connecting member 9233′ is made of a second material different from the first material. In this way, the hardness of the second material can be set higher than that of the first material, and the durability of the second material is also better than that of the first material, so that the first connecting member 9233′ can be more suitable for forming a spline structure. Compared with directly forming the spline structure on the transmission shaft 934′, the first connecting member 9233′ in this example makes the hardness and durability of the transmission shaft 934′ less demanding, thereby reducing the cost of the transmission shaft 934′. In addition, the spline structure is arranged on the first connecting member 9233′ instead of the transmission shaft 934′, so that the first inner hole 9345′ on the transmission shaft 934′ is a circular hole, which can reduce the cost of the transmission shaft 934′ and improve the stability of the transmission shaft 934′. The transmission shaft 934′ and the first connecting member 9233′ form a non-removable connection, thereby facilitating installation. Specifically, the first connecting member 9233′ is connected to the transmission shaft 934′ by welding, and the welding is friction welding. A ratio of the hardness of the first connecting member 9233′ to the hardness of the transmission shaft 934′ is greater than or equal to 1.05 and less than or equal to 1.6.

As shown in FIGS. 71 and 72, the grass trimming head 9111′ includes a spool 9114′, a head housing 9115′ and a drive shaft 9116′, the drive shaft 9116′ is connected with the head housing 9115′, the drive shaft 9116′ drives the head housing 9115′ to rotate, and the head housing 9115′ drives the spool 9114′ to rotate together to make the trimming line 9113′ rotate at a high speed. It can be understood that, in other examples, the drive shaft 9116′ can also be connected to the spool 9114′, and the drive shaft 9116′ drives the spool 9114′ to rotate.

The transmission shaft 934′ outputs power to the second transmission assembly 9112′, the second transmission assembly 9112′ transmits the power to the drive shaft 9116′, and the axis 903′ of rotation of the transmission shaft 934′ and an axis 905′ of rotation of the drive shaft 9116′ intersect obliquely. The second transmission assembly 9112′ includes a third gear 9117′, a fourth gear 9118′, and a second connecting member 9119′, the fourth gear 9118′ meshes with the third gear 9117′, and the second connecting member 9119′ is splined with the fourth gear 9118′, so that the second connecting member 9119′ and the fourth gear 9118′ rotate synchronously. Specifically, the third gear 9117′ is connected to the drive shaft 9116′ of the output assembly 911′, and the fourth gear 9118′ is connected to the transmission shaft 934′ through the second connecting member 9119′. When the transmission shaft 934′ rotates, the transmission shaft 934′ transmits power to the fourth gear 9118′ through the second connecting member 9119′, the fourth gear 9118′ drives the third gear 9117′ to rotate, and the third gear 9117′ drives the drive shaft 9116′ to rotate, thereby making the grass trimming head 9111′ rotate.

In this example, the transmission shaft 934′ is made of the first material, and the first connecting member 9233′ is made of a third material different from the first material. In this way, the hardness of the third material can be set higher than that of the first material, and the durability of the third material is also better than that of the first material, so that the second connecting member 9119′ can be more suitable for forming a spline structure. Compared with directly forming the spline structure on the transmission shaft 934′, the second connecting member 9119′ in this example makes the hardness and durability of the transmission shaft 934′ less demanding, thereby reducing the cost of the transmission shaft 934′. In addition, the spline structure is arranged on the second connecting member 9119′ instead of the transmission shaft 934′, so that the first inner hole 9345′ on the transmission shaft 934′ is a circular hole, which can reduce the cost of the transmission shaft 934′ and improve the stability of the transmission shaft 934′. The transmission shaft 934′ and the second connecting member 9119′ form a non-removable connection, thereby facilitating installation. Specifically, the second connecting member 9119′ is connected to the transmission shaft 934′ by welding, and the welding is friction welding. A ratio of the hardness of the second connecting member 9119′ to the hardness of the transmission shaft 934′ is greater than or equal to 1.05 and less than or equal to 1.6. In this implementation, the third material is the same as the second material. In other examples, the third material is different from the second material.

As shown in FIGS. 70 and 71, the long-rod type power tool 900′ further includes a circuit board assembly 94′, the circuit board assembly 94′ includes a circuit board 941′ and a mounting box 942′ for mounting the circuit board 941′, the mounting box 942′ is made of metal material, which is beneficial to the circuit board to dissipate heat.

In this example, the long-rod type power tool 900′ further includes a cable at least partially disposed in the connecting rod 933′, the cable passes through the connecting rod 933′, one end of the cable is disposed in the rear housing 922′, and the other end is disposed in the front housing 912′. The cable forms an electrical connection with the circuit board assembly 94′ to control an electrical device located at the front end 932′ of the connecting rod assembly 930′. The cable is also electrically connected to the battery pack to supply power to the electrical device. The electrical device may be a light-emitting element disposed at the front end 932′ of the connecting rod assembly 930′.

The preceding examples illustrate only the basic principles and features of the present disclosure. The present disclosure is not limited to the preceding examples. Various modifications and variations made without departing from the spirit and scope of the present disclosure fall within the scope of the present disclosure. The scope of the present disclosure is defined by the appended claims and their equivalents.

A power tool 900a′ of an example shown in FIG. 74 is specifically a long-rod type power tool, specifically a grass trimmer. It can be understood that the power tool can also be a hand-held power tool, for example, a drill, a hedge trimmer, a sander, and the like. Alternatively, the power tool may also be a table-type tool, such as a table saw, a miter saw, or the like. Alternatively, the power tool may also be a walk-behind power tool, such as a walk-behind lawn mower, a walk-behind snow thrower. Alternatively, the power tool may also be a ride-on power tool, such as a ride-on lawn mower, a ride-on vehicle, a utility vehicle, and the like. Alternatively, the power tool may also be a robot tool, such as a lawn mower robot, a snow thrower robot, or the like.

In some examples, the power tool may be an electric tool, and the power tool may be an electric drill, an electric light, an electric vehicle, or the like. Alternatively, the power tool may also be an engine-type power tool, such as an engine grass trimmer, an engine lawn mower, and the like.

In some examples, the power tool may also be a garden tool, such as a hedge trimmer, a blower, a lawn mower, a chain saw, or the like. Alternatively, the power tool may also be a decorating tool, such as a screwdriver, a nail gun, a circular saw, a sander, and the like.

In some examples, the power tool may also be a vegetation care tool, such as a grass trimmer, a lawn mower, a hedge trimmer, a chain saw, or the like. Alternatively, the power tool may also be a cleaning tool, such as a blower, a snow thrower, a washing machine, and the like. Alternatively, the power tool may also be a drill-type tool, such as a drill, a screwdriver, a wrench, an electric hammer, and the like. Alternatively, the power tool may also be a saw-type tool, such as a reciprocating saw, a jigsaw, a circular saw, and the like. Alternatively, the power tool may also be a table-type tool, such as a table saw, a miter saw, a metal cutter, a router, and the like. Alternatively, the power tool may also be a grinding tool, such as an angle grinder, a sander, and the like. Alternatively, the power tool may also be other power tools, such as lamps, fans, and the like.

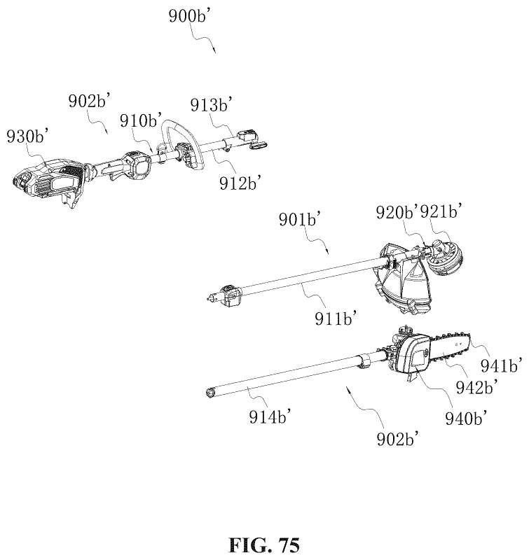

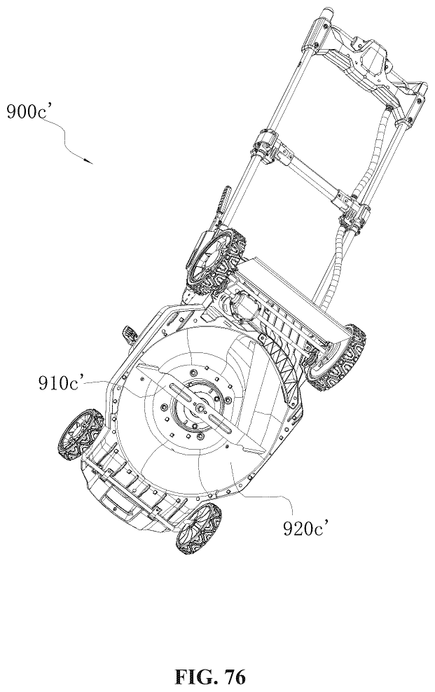

It can be understood that as long as a power equipment with a motor can adopt technical solutions disclosed in this example, the power equipment using the technical solutions disclosed in this example all belong to the scope of protection of the present application. For example, the power equipment may be a power head 902b′ as shown in the FIG. 75, which includes a motor, and the power head 902b′ is used to adapt some output assemblies to realize the function of a tool.

As shown in FIG. 74, the power tool 900a′ includes an output assembly 910a′, a motor 920a′, a power source device 930a′, and a support member 940a′. In this example, the power tool 900a′ is the grass trimmer, and the power tool 900a′ further includes a connecting rod assembly 950a′, which connects the output assembly 910a′ at a front end 951a′ and the power source device 930a′ at a rear end 952a′.

The output assembly 910a′ is arranged at the front end 951a′ of the connecting rod assembly 950a′ for outputting power. In this example, the output assembly 910a′ includes a grass trimming head 911a′, which can drive a trimming line to cut grass when the grass trimming head 911a′ rotates at a high speed. The motor 920a′ is arranged at the front end 951a′ of the connecting rod assembly 950a′, and the motor 920a′ is used to drive the output assembly 910a′. In this example, the motor 920a′ is an electric motor 920a′, and the electric motor 920a′ includes a rotating shaft for outputting power, and the rotating shaft is connected with the grass trimming head 911a′ to drive the grass trimming head 911a′ to rotate. The power source device 930a′ is configured to provide power to the motor 920a′. In this example, the motor 920a′ is the electric motor 920a′, and the power source device 930a′ is an electric power supply device capable of powering the electric motor 920a′, and the electric power supply device may be a battery pack. Or in other examples, the electric power supply device is an AC cable that can be connected to a commercial power. In other examples, the motor 920a′ is an engine and the power source device 930a′ is a fuel capable of powering the engine. The support member 940a′ is used to support at least one of the output assemblies 910a′, the motor 920a′ or the power source device 930a′. In this example, the support member 940a′ is a housing that supports the motor 920a′.

It should be noted that a support in this application may be a direct support or an indirect support. The direct support means that there is no other intermediate member between two parts so that one part directly supports the other part. The indirect support means that an intermediate member is arranged between two parts, and the intermediate member is supported by one part and the other part is supported by the intermediate member, so that the part indirectly supports the other part.

As mentioned above, in this example, the support member 940a′ is a housing, and the housing is arranged at the front end 951a′ of the connecting rod assembly 950a′. The housing is provided with an accommodation cavity in which the motor 920a′ is disposed so that the support member 940a′ supports the motor 920a′. The support member 940a′ includes a carbon fiber material, and a ratio of the density of the support member 940a′ to a tensile strength of the support member 940a′ is greater than or equal to 4.5 kg/(m³·MPa) and less than or equal to 15 kg/(m³·MPa). In this way, under the condition that the tensile strength of the support member 940a′ meets the requirements of supporting the motor 920a′, the density of the support member 940a′ can be reduced as much as possible, which can help to reduce the mass of the support member 940a′. For the grass trimmer, the hardness of the support member 940a′ is relatively large, which can stably support and protect the motor 920a′ and ensure the service life of the grass trimmer. At the same time, the density of the support member 940a′ is small, so that a weight of a front end 951a′ device located at the front end 951a′ of the connecting rod assembly 950a′ is reduced, so that when the user holds the grass trimmer to work, the user's hand bears less force, and it is easier to move or raise the grass trimmer. In this way, the user does not feel fatigued even after working for a long time, and the work efficiency is improved. In this example, the ratio of the density of the support member 940a′ to the tensile strength of the support member 940a′ is greater than or equal to 6 kg/(m³·MPa) and less than or equal to 12 kg/(m³·MPa), so that the density of the support member 940a′ is well matched to the tensile strength of the support member 940a′, which avoids the problem that the tensile strength of the support member 940a′ is not enough to effectively protect and support the motor 920a′, and also avoids the problem that the density of the support member 940a′ is too high and the front end 951a′ device at the front end 951a′ of the connecting rod assembly 950a′ is too heavy. Compared with the solution in which a motor 920a′ housing of the grass trimmer in the prior arts is made of aluminum or steel, the housing for accommodating the motor 920a′ of the present application can meet the tensile strength requirement of the motor housing in the prior arts, more importantly, a weight of the housing in present application is reduced by nearly 50% compared to the motor housing of the grass trimmer in the prior arts, which greatly reduces a weight of the front end 951a′ device at the front end 951a′ of the grass trimmer. A center of gravity of the grass trimmer is closer to the rear end 952a′ of the connecting rod assembly 950a′, which is more in line with requirements of ergonomics.

In this example, the support member 940a′ is made of a carbon fiber composite material, which is easy to manufacture and shape, and has relatively high tensile strength, and more importantly, the carbon fiber composite material has relatively low density. Specifically, the support member 940a′ includes a first material and a second material, and a strength of the support member 940a′ is relatively high after the first material and the second material are combined. In this example, a tensile strength of the support member 940a′ is greater than or equal to 100 Mpa and less than or equal to 200 Mpa, so that the support member 940a′ is not easily deformed. The first material is the above-mentioned carbon fiber material, the second material is different from the first material, the second material may be a plastic material, and a reinforced carbon fiber composite material is formed by compounding the carbon fiber material and the plastic material. More specifically, a ratio of a weight of the carbon fiber material in the support member 940a′ to a weight of the second material in the support member 940a′ is greater than or equal to 0.3 and less than or equal to 0.6. In this way, the hardness and the tensile strength of the carbon fiber composite material can meet the requirements for the strength of the support of the motor 920a′, and the density of the support member 940a′ can be reduced as much as possible. For example, in this example, the density of the support member 940a′ is greater than or equal to 0.9 g/cm³ and less than or equal to 2 g/cm³, so that a weight of the support member 940a′ can be greatly reduced, which is beneficial to reduce the weight of the front end device and improve the position of the center of gravity of the power tool 900a′.

In some examples, the tensile strength of the support member 940a′ is greater than or equal to 120 Mpa and less than or equal to 280 Mpa. The ratio of the weight of the carbon fiber material in the support member 940a′ to the weight of the second material in the support member 940a′ is greater than or equal to 0.35 and less than or equal to 0.5. The density of the support member 940a′ is greater than or equal to 1 g/cm³ and less than or equal to 1.5 g/cm³.

In this example, the support member 940a′ is made of the carbon fiber composite material. The support member 940a′ is a non-cylindrical structure. That is, the support members 940a′ are provided with some non-cylindrical structures in order to accommodate the structure of an element being supported, such as some housings. The support member 940a′ in this example is a non-cylindrical body. It should be noted that, if the inner side of the support member 940a′ is a cylindrical surface and the outer side of the support member 940a′ is a non-cylindrical surface, the support member 940a′ is considered to be a non-cylindrical body.

The support member 940a′ is made of the carbon fiber composite material through a special-shaped molding process. In an example, the special-shaped molding process is an injection molding process to form the support member 940a′. That is to say, the support member 940a′ is made of the carbon fiber composite material through the injection molding process. Especially for the housing supporting the motor 920a′, the housing can be produced inexpensively by means of the injection molding process. Compared with the carbon fiber material, the carbon fiber composite material can be manufactured by a variety of low-cost manufacturing processes. Compared with the carbon fiber material, the carbon fiber composite material can be more easily processed into various shapes. It should be noted that the special-shaped molding process refers to that the shape of a mold corresponding to the shape of the support member 940a′ is a special-shaped structure, and the special-shaped structure refers to a non-cylindrical body. For example, a mold that is basically a cylinder is not a special-shaped mold, and the special-shaped molding process in this example adopts the special-shaped mold. The special-shaped molding process may be a plastic molding process, and the support member is made of the carbon fiber composite material through the plastic molding process. That is to say, the process of manufacturing support member 940a′ is the same as that of manufacturing a plastic member. The process of manufacturing the plastic member may be the injection molding process, a suction molding process, a blow molding process, an extrusion molding process, etc.

In this example, the motor 920a′ of the grass trimmer is arranged at the front end 951a′ of the connecting rod assembly 950a′, and the support member 940a′ serves as the housing for supporting the motor 920a′. It will be appreciated that in other examples, a support member may support an output assembly or a power source device, and an accommodation cavity is used to accommodate the output assembly or the power source device. For example, for the long-rod type power tool shown in FIGS. 68 to 73, a support member may support the output assembly 911′. Specifically, as shown in FIGS. 68 and 72, the support member is the front housing 912′ supporting the output assembly 911′, the second transmission assembly 9112′ is arranged in the front housing 912′, and the front housing 912′ supports the second transmission assembly 9112′. In this way, a tensile strength of the front housing 912′ of the long-rod type power tool 900′ can meet the requirements of supporting the output assembly 911′, and at the same time, the weight of the front end device 910′ can be reduced, thereby improving the work efficiency of the user and improving the position of the center of gravity of the long-rod type power tool 900′.

In fact, not only the support member 940a′ can be made of the carbon fiber composite material, in other examples, other elements of the power tool 900a′ can also be made of the carbon fiber composite material. It can be understood that some external structural elements of the power tool that require high tensile strength can be made of carbon fiber composite materials. At least one element of the power tool is made of the carbon fiber composite material, a tensile strength of the at least one element meets the requirements, and a density of the at least one element can also be reduced. Specifically, a ratio of the density of the at least one element to a tensile strength of the at least one element is greater than or equal to 4.5 kg/(m³·MPa) and less than or equal to 15 kg/(m³·MPa), thereby helping to reduce a weight of the power tool. The at least one element is manufactured by the injection molding process, so that a shape of the at least one element can be arbitrarily set as desired.

As shown in FIG. 75, in an example, a long-rod type power tool 900b′ includes a connecting rod assembly 910b′, a first front end device 920b′ and a rear end device 930b′. The connecting rod assembly 910b′ includes a first connecting rod 911b′, a second connecting rod 912b′, and a connecting member 913b′ for connecting the first connecting rod 911b′ to the second connecting rod 912b′. In this example, the first front end device 920b′ and the first connecting rod 911b′ constitute a first output device 901b′. The rear end device 930b′ and the second connecting rod 912b′ constitute a power head 902b′, which, as a power device, can be connected to different output devices to realize different tool functions.

For example, in this example, the first output device 901b′ includes the first connecting rod 911b′ and the first front end device 920b′, and the first front end device 920b′ includes a grass trimming head 921b′. So, the long-rod type power tool 900b′ can be used as a grass trimmer when the first output device 901b′ is connected to the power head 902b′.

It can be understood that the long-rod type power tool 900b′ further includes a second output device 902b′, and the second output device 902b′ includes a third connecting rod and a second front end device 940b′. In this example, the second front end device 940b′ includes a chain 941b′, a guide plate 942b′, and the like. In this way, when the second output device 902b′ is connected to the power head 902b′, the long-rod type power tool 900b′ can be used as a long-rod type chain saw which can trim branches.

Or, in other examples, the long-rod power tool may further include a third output device. When the third output device is connected to the power head 902b′, the long-rod power tool can be used as a long-rod hedge trimmer. The long-rod hedge trimmer can prune some larger shrubs.

Specifically, in this example, the connecting member 913b′ is mounted to the second connecting rod 912b′, and the connecting member 913b′ is used to connect the first connecting rod 911b′ or the third connecting rod to the second connecting rod 912b′. In other examples, the connecting member 913b′ may also be arranged on the first connecting rod 911b′ or the third connecting rod. The connecting member 913b′ is a connecting pipe sleeved on the second connecting rod 912b′, and the connecting pipe is made of a carbon fiber composite material. In this way, a structural stability of the connecting pipe is stronger, and a mass of the connecting pipe is also reduced, which is more favorable for reducing a weight of the connecting rod assembly 910b′.

In this example, a density of the connecting member 913b′ is greater than or equal to 0.9 g/cm³ and less than or equal to 2 g/cm³, and a tensile strength of the connecting member 913b′ is greater than or equal to 100 Mpa and less than or equal to 200 Mpa.

Alternatively, a ratio of the density of the connecting member 913b′ to the tensile strength of the connecting member 913b′ is greater than or equal to 4.5 kg/(m³·MPa) and less than or equal to 15 kg/(m³·MPa). The density of the connecting member 913b′ is greater than or equal to 1 g/cm³ and less than or equal to 1.5 g/cm³, and the tensile strength of the connecting member 913b′ is greater than or equal to 120 Mpa and less than or equal to 180 Mpa.

A power tool 900c′ shown in FIG. 76 is a lawn mower, and the lawn mower is a hand-push power tool. A user stands behind the lawn mower and holds a handle of the lawn mower to push the lawn mower to walk on a ground. The lawn mower includes an output assembly 910c′, a motor, a power source device and a support member 920c′, the output assembly 910c′ includes a blade for mowing grass, and the motor drives the blade to rotate to cut vegetation. The power source device is used to provide power to the motor. In the present example, the support member 920c′ is a deck for supporting the motor or the output assembly 910c′, the motor and the output assembly 910c′ are connected with each other, and a whole formed by the motor and the output assembly 910c′ is mounted on the deck. The support member 920c′ is made of the carbon fiber composite material in the example shown in FIG. 74. The parametric properties of the support member 940a′ made of the carbon fiber composite material in the example of FIG. 74 can also be applied to the support member 920c′ of the present example.

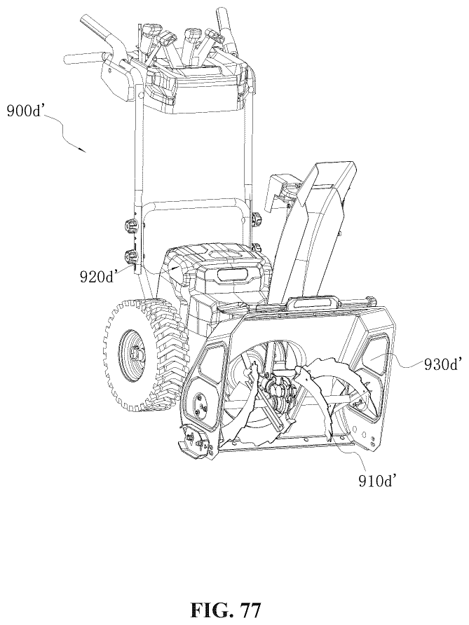

A power tool 900d′ shown in FIG. 77 is a snow thrower, and the snow thrower is a hand-push power tool. A user stands behind the snow thrower and holds a handle of the snow thrower to push the snow thrower to walk on a ground. The snow thrower includes an output assembly 910d′, a motor, a power source device 920d′ and a support member 930d′. The output assembly 910d′ includes an auger for snow-sweeping, and the motor can drive the auger to rotate to cut and collect snow. The power source device 920d′ is used to provide power to the motor. In this example, the support member 930d′ is a deck for supporting the motor or the output assembly 910d′, and the output assembly 910d′ is mounted on the deck. The support member 930d′ is made of the carbon fiber composite material in the example shown in FIG. 74. The parametric properties of the support member 940a′ made of the carbon fiber composite material in the example of FIG. 74 can also be applied to the support member 930d′ of the present example.

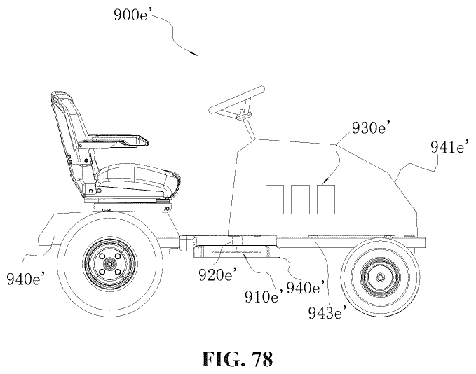

A power tool 900e′ shown in FIG. 78 is a vehicle-type power tool, and the vehicle-type power tool may be a ride-on lawn mower. A user sits on a seat of the vehicle-type power tool to drive the vehicle-type power tool to walk on a ground. The vehicle-type power tool includes an output assembly 910e′, a motor 920e′, a power source device 930e′, and a support member 940e′, the output assembly 910e′ includes a blade for mowing grass, and the motor 920e′ can drive the blade to rotate to cut vegetation. The power source device 930e′ is used to provide power to the motor 920e′. In the present example, the support member 940e′ is a deck for supporting the motor 920e′ or the output assembly 910e′, the motor 920e′ and the output assembly 910e′ are connected with each other, and a whole formed by the motor 920e′ and the output assembly 910e′ is mounted on the deck. The support member 940e′ is made of the carbon fiber composite material in the example shown in FIG. 74. The parametric properties of the support member 940a′ made of the carbon fiber composite material in the example of FIG. 74 can also be applied to the support member 940e′ of the present example. Alternatively, the support member can also be a front end housing 941e′ mounted to a front end of the vehicle-type power tool, or a rear end housing 942e′ mounted to a rear end of the vehicle-type power tool. The front end housing 941e′ or rear end housing 942e′ is made of the carbon fiber composite material. Alternatively, the support member 940e′ can also be a frame of the vehicle-type power tool, at least of the frame is made of the carbon fiber composite material. Alternatively, the support member may be a frame 943e′ for supporting the output assembly 910e′.

The above illustrates and describes basic principles, main features and advantages of the present invention. Those skilled in the art should appreciate that the above embodiments do not limit the present invention in any form. Technical solutions obtained by equivalent substitution or equivalent variations all fall within the scope of the present invention.

What is claimed is:

1. A garden tool, comprising:
a connecting rod assembly;
a first housing disposed at a front end of the connecting rod assembly;
a second housing disposed at a rear end of the connecting rod assembly;
a working mechanism that performs a function of the garden tool and is disposed at the front end of the connecting rod assembly;
a driving device comprising a motor for driving the working mechanism;
an operating device for operation by a user; and
a circuit board disposed in the second housing and electrically connected to the motor;
wherein the operating device comprises:
a first switch;
a first operating element controlling the first switch and for operation by the user to control the motor;
a second switch; and
a second operating element controlling the second switch to control the motor;
wherein the second operating element is disposed on the first housing.

2. The garden tool according to claim 1, further comprising:
a driving circuit for controlling the motor; and
a controller for sending a control signal to the driving circuit;
wherein the first switch is a physical switch, and the second switch is a signal switch.

3. The garden tool according to claim 2, wherein when the signal switch sends a first signal, the controller is in a first control mode based on the received first signal; and when the signal switch sends a second signal different from the first signal, the controller is in a second control mode based on the received second signal.

4. The garden tool according to claim 1, wherein the second housing detachably receives a battery pack.

5. The garden tool according to claim 1, wherein the first operating element has a first initial state and a first preset operating state, and the operating device further comprises a first resetting assembly that makes the first operating element get out of the first preset operating state when the first operating element is not operated by the user.

6. The garden tool according to claim 1, wherein the second operating element has a second initial state and a second preset operating state, and the operating device further comprises a second resetting assembly that makes the second operating element get out of the second preset operating state when the second operating element is not operated by the user.

7. A garden tool, comprising:
a connecting rod assembly;
a first housing disposed at a front end of the connecting rod assembly;
a second housing disposed at a rear end of the connecting rod assembly;
a working mechanism that performs a function of the garden tool and is disposed at the front end of the connecting rod assembly;
a driving device comprising a motor for driving the working mechanism;
an operating device for operation by a user to control the garden tool; and
a circuit board disposed in the second housing and electrically connected to the motor;
wherein the operating device comprises:
a first switch;
a first operating element controlling the first switch and for operation by the user to control the motor;
a second switch; and
a second operating element controlling the second switch to control the motor;
wherein the second operating element is disposed at the front end of the connecting rod assembly so as to be arranged close to the working mechanism.

8. The garden tool according to claim 7, further comprising:
a driving circuit for controlling the motor; and
a controller for sending a control signal to the driving circuit;
wherein the first switch is a physical switch, and the second switch is a signal switch.

9. The garden tool according to claim 8, wherein when the signal switch sends a first signal, the controller is in a first control mode based on the received first signal; and when the signal switch sends a second signal different from the first signal, the controller is in a second control mode based on the received second signal.

10. The garden tool according to claim 7, wherein the second housing detachably receives a battery pack.

11. The garden tool according to claim 7, wherein the first operating element has a first initial state and a first preset operating state, and the operating device further comprises a first resetting assembly that makes the first operating element get out of the first preset operating state when the first operating element is not operated by the user.

12. The garden tool according to claim 7, wherein the second operating element has a second initial state and a second preset operating state, and the operating device further comprises a second resetting assembly that makes the second operating element get out of the second preset operating state when the second operating element is not operated by the user.

13. A garden tool, comprising:
a working assembly that performs a tooling function of the garden tool;
an operation device for operation by a user to control the garden tool;
a connecting pipe connecting the working assembly and the operation device, wherein the working assembly is disposed at a front end of the connecting pipe;
a motor for driving the working assembly;
a circuit board electrically connected to the motor; and
a guide wire disposed in the connecting pipe;
wherein the operation device comprises a first switch electrically connected to the circuit board for controlling the motor, a second switch electrically connected to the circuit board for controlling the motor, and a switch housing for mounting the second switch, and the switch housing is disposed at the front end of the connecting pipe.

14. The garden tool according to claim 13, wherein the operation device further comprises a first operating element for controlling the first switch, and a second operating element for controlling the second switch.

15. The garden tool according to claim 14, wherein the second operating element and the second switch are respectively located on two sides of the connecting pipe.

16. The garden tool according to claim 13, wherein the first operating element and the second operating element are respectively disposed at both ends of the connecting pipe.

17. The garden tool according to claim 13, wherein the operation device further comprises a handle housing, and the first switch is disposed in the handle housing.

18. The garden tool according to claim 13, wherein the second switch is a non-contact switch.

19. The garden tool according to claim 13, wherein the motor is disposed at a rear end of the connecting pipe away from the working assembly.

20. The garden tool according to claim 13, further comprising a rear housing detachably adapted for a battery pack, wherein the circuit board is disposed in the rear housing.
